(19) United States
(12) Patent Application Publication
(10) Pub. No.: US 2005/0004857 A1
(43) Pub. Date: Jan. 6, 2005

(54) Methods for evaluating the financial strength of a holding in comparison to other holdings

(75) Inventors: Richard Devlin Schwarz, Scotch Plains, NJ (US); Brad Eric Pines, Troy, MI (US)

Correspondence Address: WILMER CUTLER PICKERING HALE AND DORR LLP, 60 STATE STREET, BOSTON, MA, 02109, US

(73) Assignee: Portfolio Search, Inc.

(21) Appl. No.: 10/827,021

(22) Filed: Apr. 19, 2004

Related U.S. Application Data
(60) Provisional application No. 60/463,543, filed on Apr. 17, 2003.
(60) Provisional application No. 60/528,271, filed on Dec. 9, 2003.

(51) Int. Cl. G06F 17/60

(52) U.S. Cl. 705/36

(57) ABSTRACT

The present invention is directed to systems and methods for evaluating the financial strength of a holding in comparison to other holdings of a portfolio. In one embodiment, a method of evaluating holdings of a portfolio consists of identifying the holdings that comprise the portfolio and identifying a set of Filters that that are to be used in evaluating the holdings, obtaining financial information for each of the holdings, identifying financial metrics that are to be used in evaluating the holdings and determining the values of the financial metrics for each of the holdings. The Filter values for each holding are then determined and each holding is then ranked for each Filter. Each holding is assigned a positional score for each Filter based upon its ranking for that Filter. An overall fundamental strength score is then generated for each Holding based upon all of the intra-Filter positional scores that it was assigned. In addition to an overall fundamental strength score, the methods and systems described herein can also generate other fundamentals strength scores based upon any combination of the Filters. In another embodiment, a holding is compared against a background portfolio to generate an overall fundamental strength score and additional fundamental strength scores based upon any combination of the Filters may also be generated.

### CROSS-REFERENCE TO RELATED APPLICATIONS

This application claims priority to U.S. Patent Appl. 60/463,543, filed Apr. 17, 2003, and U.S. Patent Appl. 60/528,271 filed Dec. 9, 2003, the entire contents of which are herein incorporated by reference.

### BACKGROUND OF THE INVENTION

The present invention relates to financial analysis methods and systems. More specifically, the present invention relates to an improved method and system for analyzing a Holding in comparison the others Holdings of a portfolio.

Roughly 20% of U.S. households today own stock directly (i.e., not through a mutual fund). Under U.S. Federal law, publicly-traded firms must file quarterly financial reports with the U.S. Securities and Exchange Commission (SEC) and the filings are to be made available to the public on a timely basis. These SEC filings have become a primary source of information for professional money managers (institutional investors) and, to a much lesser degree, for the individual investor. The individual investor, however, often lacks the time, training and resources to read and interpret such filings on a regular basis.

Following the financial excesses and abuses of the 1990s, the investment community (Buy Side and Sell Side) is undergoing a major transition prompted by pressure, rulings and fines from state and federal regulatory and legal bodies. These changes are directed at eliminating conflicts of interest on the part of research analysts and, relatedly, at assisting the small investor by placing him on a more even playing field with institutional investors. For example, in April 2003, ten of the nation's top ten Investment Banking firms (IB), entered a Global Settlement in which they agreed to pay a significant award in restitution to harmed investors and in penalties. As part of the Settlement, the firms agreed to provide an independent second opinion on each stock recommendation that issued by the IB's in-house research departments. The Settlement also earmarked funds for investor education and to assist in paying for independent Investment Research (IR). With a push from the Global Settlement, many small, independent IR firms have come into being in recent years. In theory, these independent IR firms can be used to provide the “second opinions” that are required by the Settlement.

Unfortunately, some of the structural changes that are occurring in the IR-generation and distribution on Wall Street appear to be working to the disadvantage of the small investor. The traditional IR departments of the major firms are suffering from a combination of new regulatory constraints, heightened legal risks from issuing stock recommendations, shrinking trading commissions and under-writing profits no longer subsidizing analyst pay. As a result, the major investment houses, those with the largest research staffs, have sharply cut research budgets, staff and companies covered. By some estimates, the ten largest investment houses have dropped coverage of 20% of the firms (as compared to the firms being covered in the year 2000) and now hundreds of mid-sized, publicly-traded firms are no longer being covered.

To a significant degree, the newer independent IR firms are being staffed by “Sell Side” analysts that had previously worked in the research departments of the larger Investment Banking houses. Unfortunately for the small investor, many of these IR houses are tending to offer research to a select number of money management firms that are willing and able to pay for a premium service. Thus, most individual investors are unable to afford the IR services that are being offered by these young independent IR firms.

There exists a need, therefore, for IR services that provide truly independent IR advice that are affordable and available to the average individual investor.

Traditional stock investment analysis is generally designed to forecast the earnings per share (EPS) of a firm (i.e., a holding). The majority of Wall Street “research”, for example, have been stock recommendation reports that effectively serve as broadcast opinions that are authored by industry-specialized sell-side analysts. These recommendations are based largely on the analyst's prediction of a firm's future EPS and estimated P/E (stock price divided by EPS) stock price objective. The EPS forecast are extrapolations of past earnings trends and/or “management guidance” as to a firm's near-term earnings outlook. For public firms, investment analysts typically compare a firm's present EPS to its year-ago EPS to compute a growth rate. Importantly, the after-tax income figure that is used to derive EPS is typically the amount reported as after-tax “Income from continuing operations” divided by the number of shares outstanding.

Over the last decade, however, the frequency and types of special charges that are taken by firms has increased. Many if not most of these charges are taken below the line item for after-tax “Income from continuing operations” that appears in the firm's Profit & Loss (P&L) Statement—the very line item that many analyst use to compute EPS. For a given quarter, the after-tax amount of a special charge can be quite large in comparison to the firm's after-tax “Income from continuing operations.” Yet, such charges are often overlooked or ignored when a firm's earnings growth rate is determined.

Moreover, traditional stock investment analysis often includes minimal analysis as to how Balance Sheet interactions affected reported earnings, nor does there tend to be a rigorous analysis of the Balance Sheet (BS) positions in their own right. In fact, such EPS projections are at substantial risk. The base earnings level and past trends (on which EPS forecasts may be based) often overstate a firm's real earning power, dividend strength, Cash Flow and/or Equity position. Additionally, the traditional analysis involves little analysis or intra-portfolio comparison of Asset-Liability structure Balance Sheet strength.

There exists a need, therefore, for methods for deriving a firm's measure of economic profit that does not rely on the line items that are reported on a P&L Statement.

Additionally, much of the traditional investment community analysis of risk/reward is based on statistical correlation (positive and negative) that quantifies the relationship (from +1.0 to −1.0) between changes in the value of two variables that are assumed to be independent and randomly distributed. If a high correlation is established, one economic or financial variable may be used to predict another. And risk is measured using standard deviations on the variability of outcomes for a variable assumed to be random. In this way, one economic, capital market or financial variable may be used to identify investments with optimize risk/reward by maximizing the expected return for a given level of variability or by minimizing the variability for a given level of expected return. These statistical approaches, therefore, are not focused on detecting specific excesses or distortions. Such excesses include overstated earnings, Dividends paid financed from sale of debt or equity capital and Total Shareholders Equity that is unsupported by the real economic contribution of the business.

Total Shareholders Equity (TSE) is the amount by which Balance Sheet Asset values exceed Liability value at a point in time. As such, TSE is a measure of a firm's value in the sense that it represents the residual value to which shareholders could lay a claim, at least conceptually. Many argue that TSE is simply an accounting value and, thus, of limited practical importance to the financial analyst (other than the case of an acquisition wherein the price paid in excess of TSE must be carried and amortized by the acquiring firm as Goodwill). To the extent that TSE is considered, it generally is only considered in its total, aggregate form, i.e., the composition or quality of TSE is not generally analyzed. The components that comprise a firm's TSE, however, contain information that is important in interpreting and effectively measuring the special charges that can appear on the P&L Statement.

There exists a need, therefore, for methods for analyzing the components of a firm's TSE.

### SUMMARY OF THE INVENTION

The systems and methods of the present invention, which are referred herein as to OPERRA (Organic Portfolio Evaluation and Risk Rankings) is a professional-level analytics service that can cover thousands of public firms. OPERRA provides an objective evaluation of fundamental strength, can be delivered directly to an individual on demand and in real time at cost. As such, OPERRA can help level the playing field for the small investor.

In contrast to the traditional statistical correlation analysis, the OPERRA approach does not analyze reported earnings, Dividend strength based on reported earnings or measure risk by historical variability. In stead, OPERRA quantifies the internal financial fundamental strength of a firm and compares that fundamental strength to a portfolio of many firms, where the portfolio defines the de facto risk standard of which the Holdings are evaluated against. Depending on the applicable investment universe, the portfolio can be any group of firms (i.e., holdings) such as a list of firms that have been identified, those of a particular Economic Sector, Industry or the S&P 500 index, for example. OPERRA generates fundamental strength score and provides Drill-Down methodologies that can quickly allow an investor to understand the interactions among P&L, Funds/Cash Flow and Balance Sheet variables that drive the scores of a particular firm.

Unlike correlation, OPERRA can be a search tool that both ranks investments by relative attractiveness and shows the “why’ behind the particular level of an awarded fundamental strength score—with a risk standard that can be tailored to the requirements of the particular investor.

OPERRA evaluates fundamental financial strength via a large number Filters to evaluate a firm's track record from a broad perspective and at a deeper level than does conventional analysis. Unlike Buy-Hold-Sell stock recommendations or Bond Ratings, OPERRA does not fit a Firm into pre-set categories. Rather, the scores that are generated for each firm is built-up individually to arrive at a Fundamental Strength Score (or Fundamental Strength Positional Score) based in the collective Filters positions unique to that Firm with respect to the portfolio. Each firm in the portfolio is ranked in regards to each of the Filters. It is from these Filter rankings that OPPERA generates fundamental strength scores for each of the firms of the portfolio.

In one embodiment, a method of evaluating holdings of a portfolio consists of identifying the holdings that comprise the portfolio and identifying a set of Filters that that are to be used in evaluating the holdings, obtaining financial information for each of the holdings, identifying financial metrics that are to be used in evaluating the holdings and determining the values of the financial metrics for each of the holdings. The Filter values for each holding are then determined and each holding is then ranked for each Filter. Each holding is assigned a positional score for each Filter based upon its ranking for that Filter. An overall fundamental strength score is then generated for each Holding based upon all of the intra-Filter positional scores that it was assigned. In addition to an overall fundamental strength score, the methods and systems described herein can also generate other fundamentals strength scores based upon any combination of the Filters.

In another embodiment, a holding is compared against a background portfolio to generate an overall fundamental strength score and additional fundamental strength scores based upon any combination of the Filters may also be generated.

### BRIEF DESCRIPTION OF THE DRAWINGS

Various objects, features, and advantages of the present invention can be more fully appreciated with reference to the following detailed description of the invention when considered in connection with the following drawing, in which like reference numerals identify like elements. The following drawings are for the purpose of illustration only and are not intended to be limiting of the invention, the scope of which is set forth in the claims that follow.

FIG. 1 depicts an exemplary embodiment of the present invention.

FIG. 2 depicts a Vector composition of TSE across a period of time for a particular Holding.

FIG. 3 depicts a Scatter Diagram showing Net Cash vs. TSE.

FIG. 4 depicts a representative example of the wide variance of the filter ratio values for a Filter.

FIG. 5 depicts values, rankings and scores of the Cum. ECOP Filters for a portfolio.

FIG. 6 depicts a Scatter Diagram showing Change in Total SE vs. Cumulative Dividends.

FIG. 7 depicts the values, rankings and scores of the Cash Flow Filters for a portfolio.

FIG. 8 depicts the values, rankings and scores of the Asset Quality-Level Filters for a portfolio.

FIG. 9 depicts the values, rankings and scores of the Asset Quality-Change (Trend) Filters for a portfolio.

FIG. 10 depicts the values, rankings and scores of the Debt Load-Level Filters for a portfolio.

FIG. 11 depicts the values, rankings and scores of the Debt Load-Change Filters for a portfolio.

FIG. 12 depicts the values, rankings and scores of the Organic SE and Total SE-Level Filters for a portfolio.

FIG. 13 depicts the values, rankings and scores of the Organic SE and Total SE-Change Filters for a portfolio.

FIG. 14 depicts the values, rankings and scores of the Relative Market Cap-Level Filters for a portfolio.

FIG. 15 depicts the values, rankings and scores of the Relative Market Cap-Change Filters for a portfolio.

FIG. 16 depicts the values, rankings and scores of the Cum. ECOP/Cum. RICO Filters for a portfolio.

FIG. 17 depicts an Overall FS Positional Score and Perspective FS Positional Scores for a Holding.

FIG. 18 depicts a Master Rankings Table that shows Raw Flag Counts for the Holdings of a portfolio.

FIG. 19 depicts a Master Rankings Table that shows Raw Flag Counts for the Holdings of a portfolio.

FIG. 20 depicts a Master Rankings Table that shows Weighted Flag Counts for the Holdings of a portfolio.

FIG. 21 depicts a Table that a show the Overall FS Positional Scores for the Holdings of a portfolio.

FIG. 22 depicts a Bar Chart that shows the Mix % of Liquidity, Resource and SE Segments of a Holding.

FIG. 23 depicts a Master Rankings Table that shows Weighted Flag Counts for the Holdings of a portfolio.

FIG. 24 depicts a Drill Down To Root Cause Visualization for a Holding.

FIG. 25 depicts another Drill Down To Root Cause Visualization for a Holding.

FIG. 26 depicts a Scatter Diagram that shows Long Term Debt vs. Total Shareholder Equity for the Holdings of a portfolio.

FIG. 27 depicts a Table that shows Holdings ranked by Component % of Total Shareholder Equity.

FIG. 28 depicts an Overall FS Positional Score and Perspective FS Positional Scores for a Holding.

FIG. 29 depicts an “Economic Profit” Bar Chart for GM that tracks Cum. ECOP, Cum RICO and cum. Dividends over an interval of time.

FIG. 30 depicts a “Shareholder Equity and Debt” Bar Chart for GM that tracks OSE, TSE and LTD over an interval of time.

FIG. 31 depicts a “Cash Flow” Bar Chart for GM that tracks Net Cash, Free Cash and Organic Cash over an interval of time.

FIG. 32 depicts a “Risk Factors” Bar Chart for GM that tracks the RED, ORANGE, BLUE and GREEN Flag Counts over an interval of time.

FIG. 33 depicts a Scatter Diagram showing All Other Current Assets vs. Total SE for the Holdings of a portfolio.

FIG. 34 depicts a Table that shows the Overall FS Positional Score Master Rankings.

FIG. 35 depicts a flowchart that illustrates the OPERRA Database Initialization process.

FIG. 36 depicts values, rankings and scores of the Cum. ECOP Filters for a portfolio.

FIG. 37 depicts a Table that shows the Cum. ECOP, Past And Targeted, for the Holdings of a portfolio.

### DEFINITIONS AND ABBREVIATIONS

“Absolute Organic Pay Out (P/O) Ratio”: For a selected time interval, cumulative common-share Dividends paid divided (or declared) by ECOP.

“All Other Current Assets”(AOCA): A set of current asset Balance Sheet line items; one of the nine TSE Vectors.

“All Other Current Liabilities” (AOCL): A set of current liability Balance Sheet line items; one of the nine TSE Vectors.

“All Other Non-Current Assets” (AONCA): A set of non-current asset Balance Sheet line items; one of the nine TSE Vectors.

“All Other Non-Current Liabilities” (AONCL): A set of non-current liability Balance Sheet line items; one of the nine TSE Vectors.

“All Other Current and Non-Current Assets”: A set of current and non-current asset Balance Sheet line items; equals AOCA plus AONCA.

“All Other Current and Non-Current Liabilities”: A set of current and non-current liability Balance Sheet line items; equals AOCL plus AONCL.

“A-L Vector”: see “Vector.”

“Asset Quality”: The relative mix of Organic to non-Organic contribution to an Assets-only Vector; one of the eight Perspectives of the Master Matrix.

“Balance Sheet Derived Cash Flow” (BSD CF): The measurement of Cash Flow by the change in the level of Cash over a time interval as opposed to calculating Cash Flow from addition of non-cash charges to net income.

“Balance Sheet Derived Free Cash Flow” (BSD Free CF): The amount that the level of Free Cash changes from a first period to a later period.

“Balance Sheet Derived Gross Cash Flow (BSD Gross CF): The amount that the level of Gross Cash changes from a first period to a later period.

“Balance Sheet Derived Net Cash Flow” (BSD Net CF): The amount that the level of Net Cash changes from a first period to a later period.

“Balance Sheet Derived Organic Cash Flow” (BSD OCF): The amount that the level of Organic Cash changes from a first period to a later period.

“Bar Charts, Scatter Diagrams and Numerical Tables” (CDT): Visual graphical tools that OPPERA utilizes to convey information.

“Cash Flow” (CF): One of the eight Perspectives of the Master Matrix.

“Class”: One of the three time-related groups by which a Filter Perspective is classified and which defines the Rows of the Master Matrix. The three types of Classes are Level, Flow and Change.

“Debt Load”: The relative mix of LTD to OSE and TSE; one of the eight Perspectives of the Master Matrix.

“Debt to Equity Ratio” (D/E Ratio): LTD divided by TSE.

“Dividend Strength” also referred to as “Dividend Drag”: The relative degree to which Dividend payments are justified by various measures of Organic performance and position which are collectively measured by the ten Flow Class Filters that reside in the Dividend Strength Perspective.

“Drill Down”: For a given Holding, the process by which investor starts with an extreme Flag Count or TOPP Score Ranking (which OPERRA generate in taking Ratio Ranks produced by the Master Matrix and converting these Ranks to Intra-Filter Positional Scores) and arrives at the visualization of Root Causes via the following sequence of steps: Rank>>Time Class>>Perspective>>Cell>>Filter>>Root Cause Display(s). The displays being Bar Charts, Scatter Diagram and/or Numeric Tables wherein and outlier position, pattern disruption or extreme trend is visually apparent.

“Economic Profit” (ECOP): For a multi-year time interval, cumulative after-tax earnings calculated so as to minimize the timing effects of P&L (profit & loss) recognition while including all costs, expenses and charges as well as capital gains and loses. A metric that is used in some of the Filter Ratios; one of the eight Perspectives of the Master Matrix.

“Filter Ratio”: Also referred to as “Filter” or “evaluation metric.” One of 62 Filters whose numerators and denominators are comprised financial metrics having dollar level values or dollar flow values. The filter ratios are designed to be insensitive to the size of a given firm. Based on its Filter Ratio values, a Holding is intra-portfolio ranked and positioned. Collectively, the 62 Filter Ratios reside in a Master Matrix By Holding that is the basis for intra-portfolio ranking and positioning of each Holding that makes up a portfolio.

“Flag”: For a given Holding, a RED, ORANGE, BLUE or GREEN coded visual cue that is generally indicative of a Holding's particularly high or low Intra-Filter Positional Score.

“Flag Count”: By Holding, the total number of Flags by color for each Perspective, each Class and for all viable Filter Ratios.

“Free Cash”: At the end of a time period, the level of Cash and Equivalents less all Debt.

“Fundamental Strength Score”: For a given Holding, the sum of the Intra-Filter Positional Scores for at least a subset of the viable Filter Ratios weighted to a scoring scale that ranges from 1 to 100.

“Gross Cash”: At the end of a time period, the level of Balance Sheet Cash and Equivalents.

“Intra-Filter Positional Score”: A score that is assigned to a Holding based upon the Holding's ranked position of a Filter. Each Holding receives an Intra-Filter Positional Score for each of its viable Filters.

“Inventory”(Inv.): Current Inventory; one of the nine TSE Vectors.

“Long Term Debt” (LTD): Debt that generally has a maturity due date that is greater than 12 months; one of the nine TSE Vectors.

“Market Cap”: See “Valuation”; one of the eight Perspectives of the Master Matrix.

“Master Matrix By Holding”: For a given Holding, a Matrix of four rows by nine columns, i.e., a 4×9 matrix, in which the Cells that collectively house the 62 Filter Ratio values of a Holding are arranged. The three top rows of the Master Matrix each represent a separate Filter Class. The fourth row, which is entitled “Sub-totals By Perspective,” presents a sub-total of the three Cells that lie above it within the same column. Each of the first eight columns represents a different Perspective. The ninth column, which is entitled “Sub-totals By Class,” presents a sub-total of the eight Cells that lie within the same row.

“Net Accounts Receivables” (Net AR): Current Accounts Receivables less Current Account Payable; derived from Balance Sheet line items; one of the nine TSE Vectors.

“Net Book Value of Plant, Property and Equipment” (NBV PP&E): A Balance Sheet line item and one of the nine TSE Vectors.

“Net Cash”: At the end of a time period, the level of Gross Cash less all Debt due in the short term; derived from Balance Sheet line items; one of the nine TSE Vectors.

“Organic”: Those portions of a firm's earnings, dividend coverage and equity capital that are generated from internal operations and thus result in real economic gain for the enterprise. The term is used in contradistinction to those portions of the Balance Sheet that arise from externally-raised capital (e.g., stock issuances), which are not representative of real economic gain.

“Organic Cash”: At the end of a time period, the level of Cash and Equivalents less all Debt and less Unearned Shareholders Equity.

“Organic Dividend Coverage”: For a selected time interval, BSD Organic Cash Flow divided by cumulative common-share Dividends paid (or declared) over that interval.

“Organic Shareholders Equity” (“OSE”): The portion of TSE generated from ECOP less Dividends paid by the firm over the life of the firm. The OSE portion of TSE reflects all of the business activities of the enterprise less cum. Dividends declared over the enterprise's life less net capital raised from sale/redemption of stock. One of the eight Perspectives of the Master Matrix.

“Outlier”: For any OPERRA measure graphically displayed across portfolio Holdings, a Holding's position such that it is visibly apparent that the position of the Holding is well outside the area in which the positions for the majority of the other Holdings of the portfolio are clustered.

“Pay Out (P/O) Ratio” also referred to as “Reported P/O Ratio”: For a given fiscal year, common-share Dividends divided by Net Income (i.e., the reported after-tax “Income from continuing operations”)

“Perspective”: One of eight types of financial characteristics by which all OPERRA Filter Ratios are classified and which define the columns of the Master Matrix By Holding. The eight Perspectives are Economic Profit, Dividend Strength, Cash Flow, Asset Quality, Debt Load, OSE, TSE and Market Cap.

“Relative Market Cap” (RMC): One of eight Perspectives. For Level, one of several metrics divided by the Firm's market value at the end of the time interval, i.e., an implicit capitalization rate. For Trend, change in implicit capitalization rate form the beginning of the interval to the end of the interval.

“Reported Income Cumulative from Continuing Operations” (RICO): For a multi-year time interval, cumulative after-tax income before extraordinary items and discontinued operations less preferred dividend requirements. Generally reported as after-tax Income from continuing operations on a P&L line item.

“Shareholders Equity”: See Total Shareholders Equity.

“Short Term Debt” (STD): Debt that generally has a maturity due date that is less than 12 months.

“Strength Score”: For a given Holding, the sum of the Intra-Filter Positional Scores for at least a subset of the viable Filter Ratios weighted to a scoring scale that ranges from 1 to 100. The subset of viable Filter Ratios can be arranged in accordance with Perspective of Class, for example.

“Total Assets” (TA): Total Assets; a metric that is used in certain Filter Ratios.

“Total Current Assets” (TCA): Comprised of a Balance Sheet line item(s) and a metric that is used in certain Filter Ratios.

“Total Current Liabilities” (TCL): Comprised of a Balance Sheet line item(s) and a metric that is used in certain Filter Ratios.

“Total Liabilities” (TL): Comprised of a Balance Sheet line item(s).

“Total Shareholders Equity (TSE): Total Assets less Total Liabilities at the end of the accounting period. More commonly called Shareholders Equity, Equity or Book Value. The accounting value of the claim that shareholders have on the enterprise calculated as the value of Total Assets less all Liabilities (defined to exclude TSE). OPERRA divides TSE into two components: Unearned Shareholders Equity (USE) and Organic Shareholders Equity (OSE). One of the eight Perspectives of the Master Matrix.

“Unearned Shareholders Equity” (USE): The portion of TSE that is primarily generated from cumulative capital that is raised from the sales (less repurchases) of common shares over the life of the enterprise (firm).

“Valuation”: At a point in time, Holding's share price multiplied by number of fully-diluted shares outstanding. Also called Market Capitalization or Market Cap.

“Vector”: One of nine Balance Sheet line item groups which collectively include all Assets & Liabilities and which, when summed up together, total TSE as of the end of any time period.

“Vectors”: Designated Asset and/or Liability line items from the Balance Sheet. There are nine such designations that collectively cover all Balance Sheet accounts/amounts except TSE. No two Vectors contain the same Balance Sheet line item. Each Vector is comprised of either Current or Non Current line items (but not both) except Net Cash and Net Accounts Receivables Vectors, which include both Asset and Liability items. Vector values are computed with the sign (positive or negative) of Asset line-item as reported (on the Balance sheet) and the sign of sign and Liability line-items reversed (positive to negative or negative to positive). Also called “A-L Vector”.

“Viable Filter Ratios”: For a given Holding, those Filter Ratios for which the financial data needed to calculate both the numerator and denominator that (a) were contained in the Holding's financial statements (b) were in a filing format that is compatible with the OPERRA Vector definitions and (c) resulting in a ratio which could be mathematically calculated. The intra-filter positions of the Holdings for a particular Filter Ratio are determined based upon the number of Holdings that had a viable Filter Ratio for that Filter Ratio.

“Visualization”: The distinctive OPERRA measurements and displays which allow the user to quickly comprehend relative strength, patterns and outliers positions across all portfolio Holdings without performing any calculations.

“Working Capital” (WC): Generally defined as Current Assets minus Current Liabilities.

### DETAILED DESCRIPTION

OPERRA is a objective, rigorous and fast methodology for evaluating a Holding within a portfolio over a selected interval that comprises several reporting periods by measuring the track record of fundamental strength of that Holding against the other Holdings that are included in the portfolio. This is accomplished by subjecting all Holdings to 62 evaluation metrics, herein called Filters or filter ratios. OPEPRA can also run a Custom Portfolio evaluation or “one-off” evaluation. As such, the methods discussed herein will be relevant to both Equity and Fixed-Income investors.

For a custom portfolio evaluation, a user requests that an entire set of companies (i.e., a portfolio for which the user has designated all the Holdings) be evaluated against each other. In the one-off case, the user requests that OPERRA evaluate a single company against a pre-selected portfolio of companies, i.e., a “background portfolio” (BgP). The background portfolio, for example, can consist of the companies that make up the S&P 500.

A number of the OPERRA Filters are novel being based on “organic” metrics which do not take reported figures at face value. Instead, the OPERRA organic metrics that relate to a firm's earnings, dividend coverage, Asset-Liability position and equity reflect the real economic gain (or loss) that has been achieved by the firm. For example, they differentiate between capital positions that are internally driven versus those that are externally generated. The OPERRA Filters measure different aspects of fundamental strength and are formulated to evaluate figures (i.e., amounts) that are drawn from the line items that are commonly reported on a firm's P&L, Balance Sheet and Funds Flow (or Cash Flow) statements. The OPERRA Filters, accordingly, are internal measurements of a firm's financial strength and collectively provide a comprehensive financial picture of each of the firms that constitute the portfolio that is being analyzed.

By evaluating the firms (i.e., Holdings) within a portfolio, OPERRA can therefore be used as a financial screening tool for identifying investment candidates from a large universe of firms or, alternatively, identifying the Holdings within a client portfolio that have average fundamental financial strength or risk.

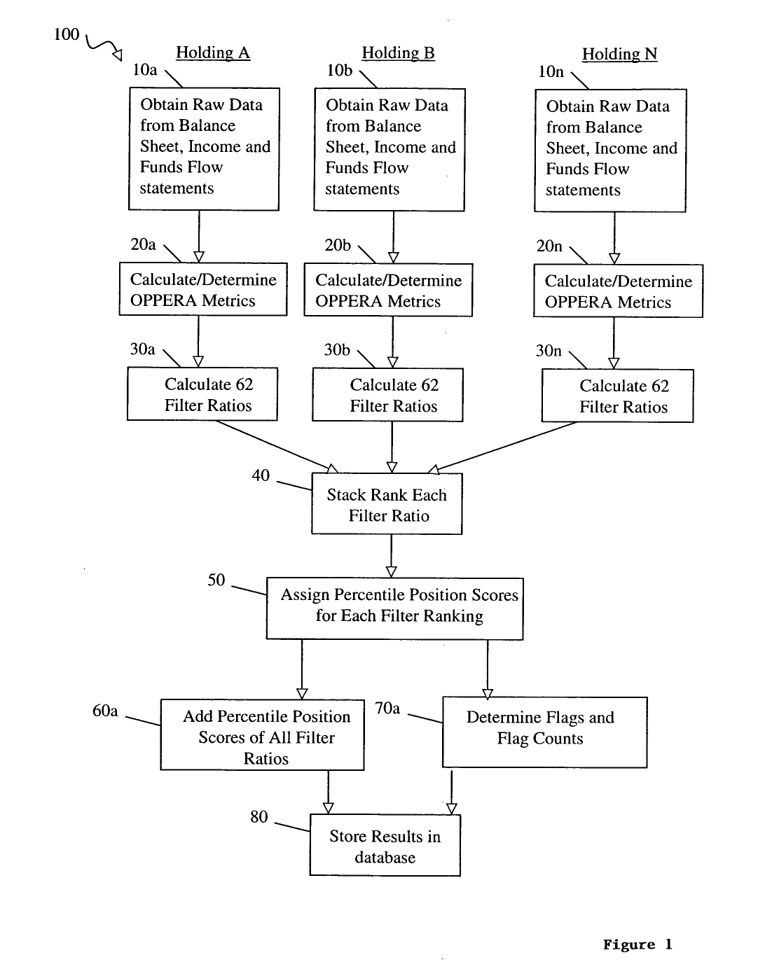

FIG. 1 shows a general overview of a method 100 for evaluating the financial strength of a Holding in accordance with the teachings of the present invention. Method 100 evaluates the internal financial measurements of the Holdings that are contained within a portfolio. The method 100 evaluates the Holdings over a selected time interval by comparing each Holding of the portfolio against every other Holding of the portfolio. The nature of the portfolio that can be analyzed via method 100 is not limited. The data capture, data structure, logic, line item definitions, financial measures, displays and ranking methods that are employed by method 100 (i.e., the OPERRA method described herein) are designed to provide a methodology that is portfolio-wide for any type of portfolio. The portfolio need not be industry specific, for example. The method 100 can treat any group of firms, e.g., companies, as a portfolio. Thus, the portfolio that is to be evaluated can be an actual portfolio (i.e., reflect those firms that someone has an equity interest in), a pro-forma portfolio, an industry group, a Market Index portfolio (such the Dow 30, S&P 500 or Russell 2000) or a combination of these.

The portfolio of FIG. 1 consists of 14 Holdings, Holdings A-N. Financial information for each Holding of the portfolio is first obtained from the firms' Balance Sheet, Income (P&L) and Fund Flow (or Cash Flow) statements, steps 10a-10n. Once the financial information has been obtained, financial metrics for each Holding is then determined and/or calculated, steps 20a-20n. Some of the financial metrics (i.e., values or amounts) that are used in method 100 will come directly from the firms' Balance Sheet, Income (P&L) and Fund Flow (or Cash Flow) statements. Determining the values of these metrics thus only require that a particular line item(s) of a statement be reviewed. Many of the financial metrics that are used in method 100, however, are directed at “organic” measures that are not directly reported by the Holdings. The values of these organic metrics, therefore, need to be determined based upon the selected line item figures that are reported by the Holdings. As is discussed in greater detail below, these organic measures include cumulative Economic Profit (Cum. ECOP), Organic Shareholders Equity (OSE), and Organic Cash Flow, for example.

Having determined and derived the financial metrics for each Holding, the values of each of the 62 Filters is then calculated for each of the Holdings of the portfolio, steps 30a-30n. The Filters measure the fundamental financial track record of a Firm (i.e., Holding) across a selected time interval. The Holdings are then stack ranked for each Filter, step 40. In step 40, the Holding that has the best value (i.e., highest or lowest number, depending on the nature of the particular Filter) for the first Filter would be ranked first, the Holding having the second best value for that filter would be ranked second and so on until all the Holdings have been ranked for the first Filter. The Holdings are then ranked for the second Filter, etc., until all of the Holdings have been ranked for all of the Filters. Holding A, for example, may have ranked first for Filters 5, 9, 10 and 53, ranked second for Filters 1 and 12, . . . and ranked 62^{nd} for Filters 2 and 27. Depending upon the particular Filter, higher or lower values may give rise to higher positional rankings.

For each of the Holdings, method 100 then assigns an Intra-Filter Positional Score for each of the Holding's Filter value rankings, step 50. In other words, method 100 ranks all Holdings by relative strength to generate an intra-filter position on a Filter-by-Filter basis for each Holding. For example, the Holding that ranked first for the first Filter would receive an Intra-Filter Positional Score of 1.00 (100%) for that Filter, the Holding that second for the first Filter would receive an Intra-Filter Positional Score of 0.92 (92%) . . . and the Holding that ranked last for the first Filter would receive an Intra-Filter Positional Score of zero (0%) for that Filter. Thus, a Holding's Intra-Filter Positional Score indicates how the Holding did on a particular Filter in comparison to the other Holdings in the portfolio.

After the Intra-Filter Positional Score have been assigned, for each Holding, all of its Intra-Filter Positional Scores (for each of its viable Filters) are then added-up and averaged to generate an Overall Fundamental Strength Score for each Holding, steps 60a-60n. In aggregating the Intra-Filter Positional Scores, all the Filters may be weighted evenly or some Filters may be weighted more heavily than other Filters. Thus, Firm A's Overall Fundamental Strength Score is calculated by summing-up all of the individual Intra-Filter Positional Scores (wherein the Intra-Filter Positional Scores are first multiplied by an assigned Filter weight if the Filters are to be weighted differently) that Firm A was assigned for each of the Filters and then this sum is averaged by dividing this sum by the number of Intra-Filter Positional Scores that Holding A had received.

To provide an easy reference that illustrates how a Holding's Overall Fundamental Strength Score compares with the Fundamental Strength Scores of the other Holdings (of the portfolio), the Holdings' Fundamental Strength Scores can be ranked and assigned an Overall Fundamental Strength Positional Scores in the same manner that the Holdings' intra-Filter positions were treated.

Risk is simply defined as the inverse of strength with respect to individual Filters and to Strength Scores. The lower the intra-Filter Positional Score and Fundamental Strength Scores (or Fundamental Strength Positional Scores) of a Firm, the higher its Risk relative to the portfolio. From the Fundamental Strength Score (or Fundamental Strength Positional Scores), the user may Drill-Down to specific Filters to identify and understand the root causes of a Firm's fundamental strength or risk.

Red, Orange, Blue and Green Flags are assigned to each Holding based upon their intra-Filter rankings (or Positional Scores) and a Flag Count (by Flag type) is generated for each Holding, steps 70a-70n. The different flags can be used to indicate when a Holding had a substantially low, a moderately low, a moderately high or a substantially high intra-Filter ranking. The Flag Count presents how many Flags (if any) that a particular Holding was assigned and identifies the nature of the Flags, i.e., whether they were Red, Orange, Blue or Green.

The Filter values, Intra-Filter Positional Scores, Fundamental Strength Score and Flag Counts for each Holding are stored in a database, step 80. Method 100 generally analyzes the Holdings of a portfolio in regards to a time interval that spans several reporting periods. The Filter values, Positional Scores, Fundamental Strength Score and Flag Counts discussed above can be determined for a given reporting period. By storing this data in a database, this data can easily be retrieved later when a more current analysis is to be performed. For example, if the analysis is to cover the four sequential reporting periods and is to be re-done with each new reporting period, by saving the previous results in the database, the intra-Filter rankings of the Holdings of a portfolio (assuming the portfolio did not change) would not need to be rerun when the analysis to cover the new reporting is initiated.

By analyzing more than one reporting period, trends and inflection points that occur across a span of time can also be identified. A rising Positional Score (for a given Filter) or Fundamental Strength Score, for example, indicates a Holding's strength has improved relative to the portfolio, while a declining score indicates risk is climbing relative to the portfolio.

As the method in FIG. 1 demonstrates, users can use the invention to evaluate and compare the Holdings of a portfolio without accessing financial data, performing calculations or interpreting any statistics.

The analysis methodology will now be discussed in more detail.

Obtaining a Holding's Financial Information

Federal law dictates that public companies (i.e., corporations whose shares are publicly traded on the U.S. stock markets) must file certain financial reports with the U.S. Securities and Exchange Commission (SEC) on a quarterly basis and that these filings are to be available to the public on a timely basis. These filings are a primary source of financial information for professional money managers (institutional investors) and, to a lesser degree, for the individual (retail) investor. The OPERRA methodology employs line-item definitions and quarterly time periods designed to fit with the required reporting schedules, formats and line item of the most relevant and common SEC filings, i.e., the 10Q which are filed at the three, six ands nine month intervals) and the 10K which are filed annually. Thus, use of the OPERRA methodology by professional money managers (the “Buy Side”) can dovetail with his institution's in-place investment processes and procedures for data gathering. Furthermore, OPERRA is designed to compliment the more traditional approaches to investment analysis in allowing the investor to quickly view his Holdings from a non-traditional perspective. This includes visualization of (a) comparative financial structure across portfolio Holdings, (b) ranking of all Holdings by a variety of OPERRA measures and (c) the identification, by Holding, of specific performance/position areas showing exceptional strength or risk within the portfolio.

There are companies in business today that collect and assemble the public financial information from the regulator filings for all or many of the public companies worldwide that report quarterly, semi-annually or annually with a regulatory authority (e.g., SEC). These companies then provide the collected financial information covering many companies in a convenient format (e.g., digital data) to their customers. The data collection steps of OPERRA can easily be automated by engaging a company that provides such a service.

In some embodiments, the OPERRA methodology is utilized to evaluate Holdings of a portfolio, wherein at least some of the Holdings of the portfolio are non-U.S. firms.

The OPPERA methodology need not be reliant upon financial information that is public. In one embodiment, OPERRA analyze the financial strengths of provided companies comprising a portfolio based upon proprietary financial information that is developed and provided by outside vendors.

Financial Metrics:

OPPERA gathers public financial information pertaining to the Holdings in which it is to analyze. The public financial information is obtained from the Balance Sheet, P&L and Fund Flow statements that are provided in a Holding's quarterly and annual reports. From the financial information, OPPERA identifies and determines a series of financial metrics for each of the Holdings of the portfolio. The OPPERA filter ratios that are used to analyze a Holding in relationship to the Holdings of a portfolio are comprised of these financial metrics, i.e., the financial metrics are utilized in the numerators and denominators of the filter ratios.

Some of the financial metrics that are utilized by OPPERA are common to the metrics that are used in traditional earning analysis. OPERRA, for example, determines some of the Holding's filter ratio measurements based upon a Holding's Cum. RICO, Total Assets (TA), cumulative Dividends, Working Capital and Total Liabilities (TL), for example.

Some of the financial metrics that are utilized by OPPERA, however, are novel and unique metrics that have been developed in accordance with the present invention. The novel and unique financial metrics include an Economic Profit metric, metrics relating to Total Shareholders Equity and selected Cash Level and Cash Flow metrics, which are described in more detail below.

The OPPERA Economic Profit (Cum. ECOP) Metric:

For a selected time interval that is to be evaluated, OPERRA derives an Economic Profit (Cum. ECOP) metric for each of the Holdings of a portfolio. The OPERRA Cum. ECOP metric is generally not used to evaluate a Holding's performance over a single quarter (or single reporting period) but is instead used to evaluate a Holding's cumulative earnings over a time interval that extends over several quarters (or longer). OPERRA treats all charges and gains as having economic significance, i.e., being part of a Firm's track record, and, therefore, considers all charges and gains in relevant for evaluating a Holding's relative performance over a given time interval.

Accordingly, the Cum. ECOP metric takes into consideration all charges and gains regardless of weather such charges taken above or below the Cum. RICO line. The Cum. ECOP, which is an after-tax figure, is generally calculated as the dollar level of Organic Shareholder Equity (OSE) at the end of the selected time interval less dollar level of OSE at the start of the interval plus cumulative common-share Dividends paid over the interval.

This Cum. ECOP Definition/Formula is thus Designed to Reflect:

The minimization of the timing effects of P&L recognition, i.e. the parking and un-parking of revenue and expenses on the Balance Sheet.
Maximum loading of all costs, expenses and charges whether or not labeled “operating” or carried below “continuing operations” in the P&L. Thus, Cum. ECOP reflects P&L line items including those:
   Charges labeled “special,” “non-recurring,” “one time,” etc;
   Charges deriving from of cash outlays and those deriving from changes in Balance Sheet accounts;
   Charges derived establishment Balance Accounts wherein there a coincident cash transfer; and
   Charges derived establishment Balance Accounts wherein there was no coincident cash transfers, such as may be the case for a “severance” charge.
   All capital gains and losses as well as any asset write-downs and/or impairment charges.
   Gains and losses on acquisitions, divestitures and/or intra-interval mergers.

In a preferred approach, Cum. ECOP also takes into consideration charges that are taken retroactively and charges that are taken against the P&L or directly to TSE. The Cum. ECOP metric, therefore, quantifies a Holdings' earning power without relying on the values that were reported in the Holding's P&L Cum. RICO line item. The Cum. ECOP metric, moreover, overcomes many of the shortcomings prevalent in today's conventional earnings analysis by taking into consideration the special and non-recurring charges.

The preferred approach is to derive Cum. ECOP from the Balance Sheet and Funds Flow (if a firm reports Dividends on a Dividends Declared basis) or Cash Flow (if a firm reports Dividends on a Dividends Paid basis) accounts. Methods for determining a Firm's Cum. ECOP for a given time interval is discussed in more detail below.

Before OPPERA can use the preferred approach to determining Cum. ECOP, it must first analyze a Firm's Shareholder Equity (labeled as Total Shareholder Equity or “TSE”). TSE is comprised of two basic components: “Unearned Shareholders Equity” (“USE”) and “Organic Shareholders Equity” (“OSE”). The USE portion of TSE represents the cum. Net capital raised from sale and repurchase of common shares over the enterprise's life (which is cumulatively reported). The OSE portion of TSE reflects all of the business activities of the enterprise less cum. Dividend declared over the enterprise's life. As discussed below, there are several approaches to calculating Cum. ECOP. In the preferred approach, OPERRA derives Cum. ECOP as the change in the dollar level of Organic Shareholder Equity (OSE) plus cum. Common-share Dividends declared (or paid) over the interval.

For a given reporting period (such as a quarter), Retained Earnings (“RE”) increases by Net After Tax Income for the period less Dividend declared for the period. Over the last decade, corporate reportings have shown an increase in the frequency and types of special and non-recurring charges. Many, perhaps most, of such charges being taken below the line for so-called after-tax “Income from continuing operations.” Such charges may include “severance,” “restructuring,” “pension liability adjustments,” etc. In some cases, the quarterly Balance Sheet figure for RE reflects only the after-tax “Income from continuing operations (less Dividends)”. This allows for RE “leakage” in that Nominal RE does not the effects of special or so-called nonrecurring charges (incurred during the period). Nonetheless, such special charges are reflected in TSE via other line item such as “Accumulated other comprehensive loss.”

To address this leakage, OPERRA calculates Real RE, which is the OSE. OSE is derived by subtracting from Nominal RE, amounts for Balance sheet line items covering these special and nonrecurring charges and/gains. OSE can alternatively be determined at the end of a given period calculated as TSE less the par value of common stock issued and paid-in capital.

For a given time interval, OPERRA calculates the change in Real RE, which is simply Real RE at the end of the last quarter of the time interval less OSE at the start of the interval (OSE at end of the quarter preceding the first quarter of the time interval). Cum. ECOP is then calculated as the change in OSE plus cum. Dividends declared during the time interval. Thus, Cum. ECOP is an after-tax earnings figure that effectively reflects economic events including those responsible for special charges taken over the interval.

The following example demonstrates how Cum. ECOP could be determined for a particular firm in relationship to an identified time interval. The example has the following assumptions:
(a) The evaluated time period is a thirty-sixth month time interval (i.e., 12 quarters or 3 years) that starts with Q1/00. Since a Holding's Balance Sheet data at a given start period is reflected by the financial data that was reported at the end of a preceding reporting period, to evaluate a Holding over a given time interval, OPERRA also reviews the Holding's financial data that was reported immediately preceding the time interval (i.e., the interval-start Balance Sheet figures for this example were reported at the end of Q4/99).
(b) TSE increases by $4.0M from $23.0 to $27.0 during the time interval. I Nominal RE increased by $12.0M from $13.0M to $25.0M during the time interval.
(d) For each quarter, Income from continuing operations was $2.0M and Dividends declared $1.0M. Thus, over the interval, the Cum. RICO was $24.0M and the cum. Dividends declared $12.0M (which agrees with the fact that Nominal RE increased by $12.0M since Nominal RE=Cum. RICO−cum. Dividends declared).
(e) P&L special charges during time interval totaled $10.0M, which were all taken below the Cum. RICO line as pension adjustments and were reflected as an increase in “Accumulated other comprehensive loss.” Thus, over the interval, Accumulate loss changed by $(10.0)M from $(1.0)M to $(11.0)M.

The Example can be Summarized as Follows:

Breakout of Shareholder Equity Accounts

| | Q4/99⁽¹⁾ | Q1/00 | Q4/02 | Change |
|---|---|---|---|---|
| Paid-In Capital | $11.0 M | $13.0 M⁽²⁾ | $13.0 M | +$2.0 M |
| Nominal RE | 13.0 | 14.0 | 25.0 | +12.0 |
| Accumulated loss | (1.0) | (3.0) | (11.0) | (10.0)⁽³⁾ |
| Real RE (OSE) | 12.0 | 11.0 | 14.0 | +2.0 |
| TSE | $23.0 M | $24.0 M | $27.0 | +$4.0 M |

NOTES:
⁽¹⁾Balance Sheet figures reported for Q4/99 are those that prevailed at the end of that quarter and, thus, represent the figures that prevailed at the start of Q1/00, i.e., the start of the time interval of Q1/00 thru Q4/02 that is being evaluated.
⁽²⁾During the time interval, the firm raised a net total of $2.0 M from the sale of stock in Q1/00.
⁽³⁾Reflects all special charges taken in time interval.

As is shown above, based upon these figures and assumptions, OPERRA calculates the interval-end Real RE (i.e., OSE) to be $14.0M, which represents a $2.0M increase over the interval-start Real RE.

To derive Cum. ECOP for the interval, OPERRA calculates the Pro Forma Real RE which is the Real RE which would have (mathematically) prevailed at the end of the interval had no Dividends been declared. In this example, the interval-end Pro Forma Real RE is thus $26.0M, as shown below.

| | Q4/02 End |
|---|---|
| Real RE (OSE) | $14.0 M |
| Cum. Dividends | +12.0 |
| Pro Forma Real RE | $26.0 M |

Cum. ECOP equals the interval-end Pro Forma Real RE less interval-start Real RE. Thus, in this example Cum. ECOP is $14.0M ($26.0M−$12.0M).

If TSE is not broken out at the start of the first quarter of the interval but is subsequently reported starting in a later quarter, OPERRA can compute the interval-start Nominal RE and Real RE figures. For example, to arrive at the interval-start Nominal RE and OSE figures, OPPERA “backs-out” the cum. Earnings of the reported quarter and the earlier (unreported) quarters and “adds back” the cum. Dividend that were declared. Alternatively, if TSE accounts are not broken out for any quarter of the interval, Cum. ECOP can be calculated as the change in TSE plus cum. Dividends declared less net equity capital that was raised (e.g., from sales and redemption of shares) over the interval. In this example, Cum. ECOP of $14.0M is calculated as follows:

| | |
|---|---|
| Change In TSE | +$4.0 M |
| Cum. Dividends | 12.0 |
| Net Equity Raised | (2.0) |
| Cum. ECOP | $14.0 M |

OPPERA therefore can determine a Firm's Cum. ECOP (over a given time interval) based upon the figures that are reported in the firm's Balance Sheet and Fund Flow Statement (which shows Dividends declared) without analyzing any figures that come from the firm's P&L Statement. Moreover, unlike most traditional analysis, in determining Cum. ECOP, OPPERA takes into account special charges that the firm may have taken during the time interval that is being evaluated.

OPERRA's Total Shareholders Equity (TSE) Metrics:

The OPERRA TSE metrics arise from the basic Balance Sheet relationship that Total Assets (TA)=Total Liabilities (TL), wherein TL includes Total Shareholders Equity (TSE). However, since TSE is less a strict Liability and is more of an ownership claim OPPERA, accordingly, modifies this basic equation to become TA=TL (ex. TSE)+TSE. From this basic equation, OPERRA derives the following series of equations:
TSE+TA=TL (Eq. 1)
TSE=TA−TL (Eq. 2)
TSE=Current Assets+Non-Current Assets−Current Liabilities−Non-Current Liabilities (Eq. 3)
TSE=(Current Assets−Current Liabilities)+(Non-Current Assets−Non-Current Liabilities) (Eq. 4)
TSE=[(Gross Cash+Accounts Receivable (AR)+Inventory (Inv.)+AOCA)−(STD−Accounts Payable (AP)−AOCL)]+[(NBV PP&P+AONCA)−(LTD+AONCL)] (Eq. 5)
TSE=[(Gross Cash−STD)+(AR−AP)+Inv.+AOCA−AOCL]+[NBV PP&P−LTD+AONCA−AONCL] (Eq. 6)
TSE=[Net Cash+Net AR+Inv.+AOCA−AOCL]+[NBV PP&P−LTD+AONCA−AONCL] (Eq. 7)
wherein Net Cash=Gross Cash−STD and Net AR=AR−AP.

“Working Capital” (WC) is commonly defined as Current Assets minus Current Liabilities. Thus, based upon the above derivations, it can bee seen that WC is equal to Net Cash plus Net AR plus Inv. plus AOCA minus AOCL, which are the terms that comprise the first portion of the right-hand side of equation 7. “Net Non-Current Assets” is defined as Non-Current Assets minus Non-Current Liabilities. Based upon the above derivations, it also can bee seen that Net Non-Current Assets is equal to NBV PP&P minus LTD plus AONCA minus AONCL, which are the terms that comprise the second portion of the right-hand side of equation 7. Accordingly, TSE is equal to WC plus Net Non-Current Assets.

As demonstrated by Equation 7, it can thus be seen that TSE is comprised of nine separate components. OPPERA treats these nine separate components of TSE (which when combined are equal to TSE) as OPERRA Vectors. The nine OPPERA Vectors can be used to analyze a Holding's Asset-Liability structure over a given time interval by Holding, to compare a Holding's Asset-Liability structure against the Holdings of a portfolio Holdings and to quantify the Balance Sheet forces that are driving TSE for a Holding across a given time interval. As represented in Equation 7, the nine OPPERA Vectors are thus:
Net Cash (Vector 1)
Net Accounts Receivables (Net AR) (Vector 2)
Inventory (Vector 3)
All Other Current Assets (AOCA) (Vector 4)
All Other Current Liabilities (AOCL) (Vector 5)
Net Book Value of Plant, Property and Equipment (NBV PP&E) (Vector 6)
Long-Term Debt (LTD) (Vector 7)
All Other Non-Current Assets (AONCA) (Vector 8)
All Other Non-Current Liabilities (AONCL) (Vector 9)
wherein “Net Cash” is Cash & Equivalents less Current Debt (which is to also include the current portion of Long Term Debt) and “Net Accounts Receivables” is Current Accounts Receivables less Current Accounts Payables.

The first five Vectors (Vectors 1-5) are “Current” Vectors and, accordingly, the values of these Vectors are determined solely based upon a Holding's Current Asset and/or Current Liability line items (i.e., as obtained from the Holding's public financial information statements). In both the Net Cash and Net Accounts Receivables Vectors, the Vector values are arrived at by off-setting a Current Liability line item from a Current Asset line item of comparable maturity. The last four Vectors (Vectors 6-9) are “Non-Current” Vectors and, accordingly, the values of these Vectors are determined solely based upon a Holding's Non-Current Asset and/or Non-Current Liability line items.

The OPERRA Vector methodology conforms to fundamental accounting equations so that the nine Vectors of a given Holding total that Holding's TSE for a given reporting period. Given this basic equation, all Asset and Liability line items values are incorporated into one of the nine Asset-Liability (A-L) Vectors for each Holding and for each quarter within the multi-year time interval that is being evaluated. Asset line items are entered into appropriate Vectors with the same sign that is shown in the Balance Sheet, while Liability line items are entered into appropriate Vectors with a sign that is opposite of which is shown on the Balance Sheet (i.e., a liability that is shown as a negative value in the Balance Sheet is entered as positive number in the Vector and a liability that is shown as a positive value in the Balance Sheet is entered as negative number in the Vector). While a Vector can include more than one line item (value), depending upon the nature of the Vector (i.e., Assets vs. Liabilities and Current vs. Non-Current, with the exception of Vectors 1 and 2, each Vector only includes line items that are from the same side of the Balance Sheet (i.e., the Assets side or the Liabilities side) and either includes only Current or Non-Current line items (but not both). The value of a Vector is simply the sum of the line item values that constitute that particular Vector.

The OPERRA methodology relies on OSE, not the commonly-used TSE, as the key measure of the firms real economic contribution or drain over the time interval selected for analysis. The Vectors illustrate where a Firm's TSE support lies at a particular time slice and across a time interval (e.g., several reporting periods). Hence, in calculating, tracking and displaying the Firm's nine Vector values within each reporting period and across time, OPERRA can give a dynamic profile of the changes in the Assets and Liability mix that support a Firm's TSE.

For each Firm in a portfolio, OPERRA generates a display matrix with columns being the quarterly time series (covering the time interval) and with nine rows that correspond to the Vectors and a last row that corresponds with TSE (i.e., the summation of the Vectors). The first part of the matrix shows the dollar values of each Vector while the second part of the matrix shows the Vector's percentage contribution to the TSE. The “percentage contribution” portion of the Vector matrix provides a convenient format for rapidly identifying the changes in the Asset-Liability structure (as evidenced by the Vectors) that have contributed or undermined a Holding's TSE throughout the selected time interval. An example of a Vector display matrix for a Firm A is discussed and presented below.

Vector Display Matrix Example:

For simplicity, the time interval that is being considered in this example extends over three quarters (OPPERA typically evaluates a time interval that extends at least four quarters).

Vector Display Matrix For Firm A

| | Dollars (in M) | | | Percent | | |
|---|---|---|---|---|---|---|
| Vectors | Q2 | Q3 | Q4 | Q2 | Q3 | Q4 |
| 1) Net Cash | $10 | $8 | $(5) | 38% | 22% | (12)% |
| 2) Net AR | 10 | 15 | 20 | 39 | 42 | 48 |
| 3) Inventory | 5 | 5 | 5 | 19 | 14 | 12 |
| 4) AOCA | 5 | 8 | 5 | 19 | 22 | 12 |
| 5) AOCL | (8) | (7) | (5) | (30) | (19) | (12) |
| Current | 22 | 29 | 20 | 85 | 81 | 48 |
| Vectors | | | | | | |
| 6 NBV PP&E | $12 | $13 | $14 | 46% | 36% | 33% |
| 7) LTD | (10) | (15) | (10) | (38) | (42) | (24) |
| 8) AONCA | 3 | 10 | 19 | 11 | 28 | 45 |
| 9) AONCL | (1) | (1) | (1) | (4) | (3) | (2) |
| Non-Current | 4 | 7 | 22 | 15 | 19 | 52 |
| Vectors | | | | | | |
| TSE | $26 M | $36 M | $42 M | 100% | 100% | 100% |

Notes:
“Net Cash” (Gross Cash less Short Term Debt) is positive Vector if Gross Cash exceeds Short Term in which case this Vector is a positive contributor to TSE. If Gross Cash is less than Short Term Debt, this Vector is a negative contributor to TSE.
“NBV PP&E” is always positive Vector since it is comprised of an Asset line item, i.e., Plant & Equipment, which is never a negative amount.
“LTD” (Long Term Debt) is a negative Vector as it contains Liability line items that the Balance Sheet shows as positive amounts so that in revering the sign this Vector reflects its negative contribution to TSE.

The Vector percentage contribution to TSE is determined by simply dividing the value of a Vector by the TSE amount for that given reporting period. Thus, in the second quarter of this example, the Net Cash value was $10M and the TSE value was $26M and, thus, the Net Cash percentage contribution for this quarter was therefore about 38% (i.e., 10 divided by 26). [For simplicity, the values provided above have been rounded up or down.]

During the three quarters, TSE climbed from $26M to $42M, a healthy percent increase by most conventional analysis. The OPERRA “dollar” portion of Vector matrix, however, shows that despite a drop in Net Cash of $5M (e.g., as ST Debt exceeded Gross Cash by this amount), the TSE increase was largely due to a doubling of Net ARs (to $20M) and a very large ($16M) increase in AONCA. Moreover, the “percentage contribution” portion of the Vector matrix shows that:
(1) External TSE support shifted to AONCA (a change from 11% to 45%) as Net Cash support collapsed (a change from 38% to −12%); and
(2) that at the end of the time interval, TSE was almost entirely resting on Net AR (which increased from 39% to 48%) and AONCA (which increased from 11% to 45%), i.e., these two Vectors accounted for 93% of the TSE.
   These changes in TSE-support should alert the investor to check what drove both the drop is Net Cash (e.g., which can be a signal of a unexpected external pressures) and the explosive increase in AONCA (e.g., which may be laden with Intangibles that have the risk of later downward revisions).

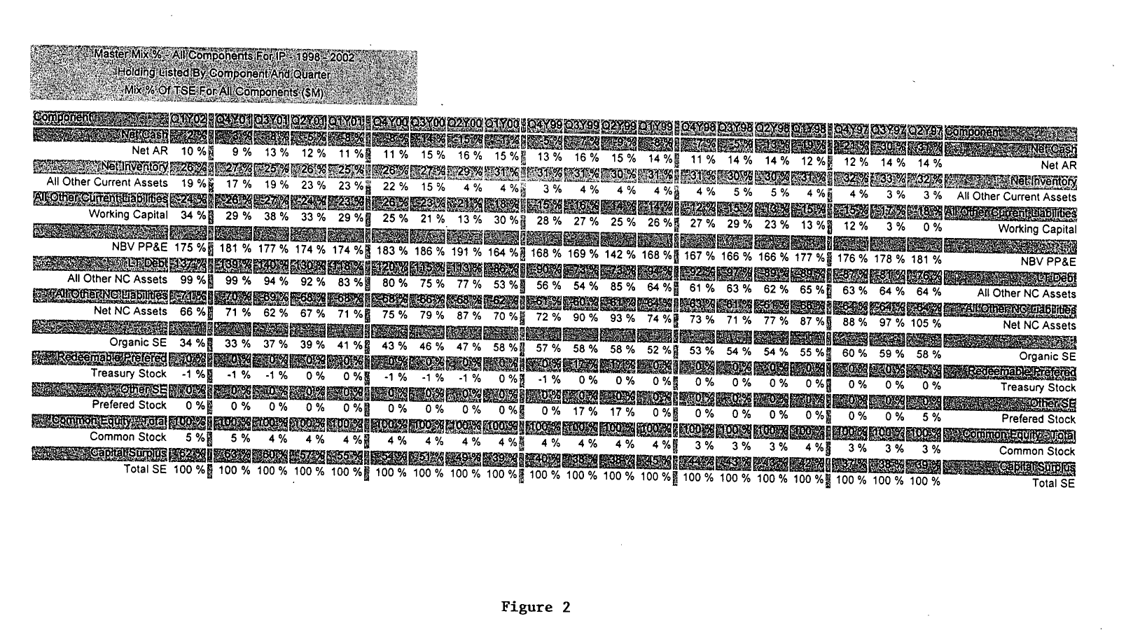

OPERRA quantifies the internal composition and quality of TSE by tracking mix shifts and level changes for both USE and OSE. This relationship is shown in FIG. 2. In FIG. 2, the numbers that appear in reporting period columns are the numbers that have been determined for that reporting period.

Thus, as previously discussed, for the quarterly time periods that comprise a selected time interval, calculating changes in the level of each Vector allows OPERRA to quantify the extent to which each A-L Vector drove TSE. As of the end of any accounting period, Vectors are expressed as a percent of TSE to show the A-L mix and mix shifts underlying the TSE level. Therefore, in tracking or analyzing change from a baseline annual reporting period of the interval (for comparable quarters) in the level and mix of these Vectors across time, OPERRA quantifies the level, quality and dynamics of TSE. In other words, the Vector display matrix can have another percentage section that shows how much a Vector has changed (in percentages) in one quarter (e.g., Q1) of a fiscal year from a comparable quarter (i.e., Q1) of a baseline fiscal year.

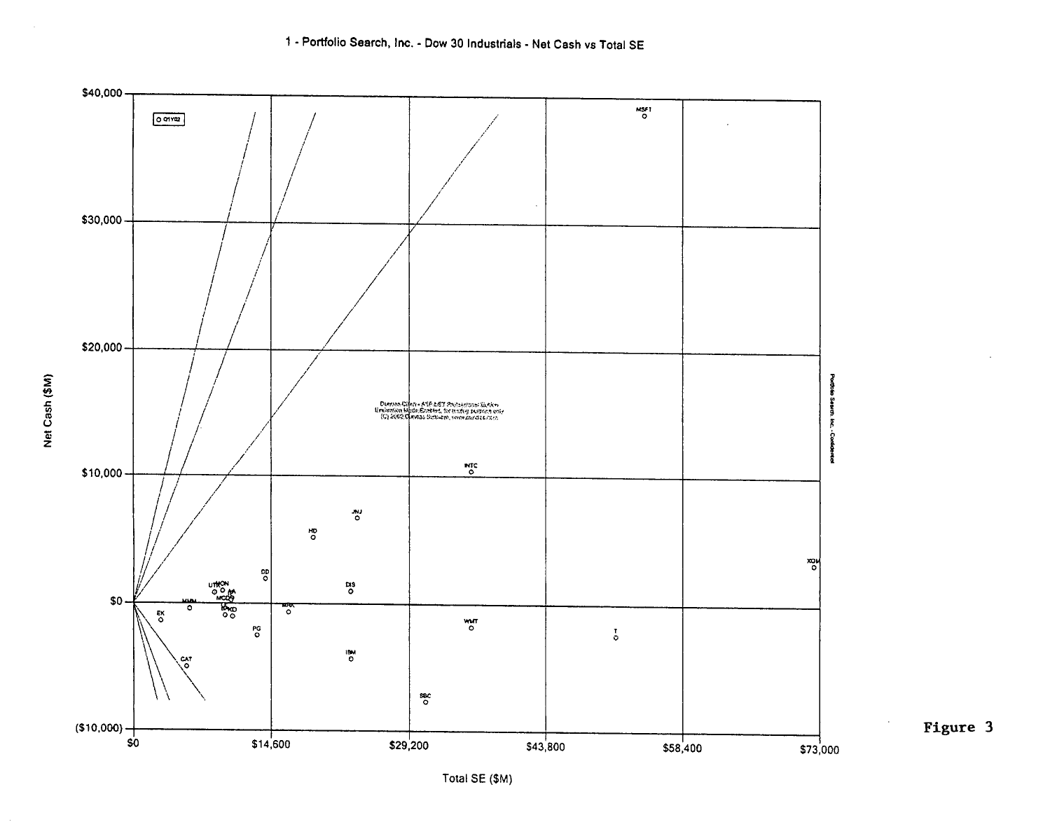

In addition to presenting intra-Holding Vector display matrixes, OPERRA also graphically displays for a given time interval each Vector on a Holding-by-Holding basis to compare the portfolio-wide Asset-Liability structure of the Holdings. In other words, to compare financial structures across portfolio Holdings at a given point in time, OPERRA generates a Scatter Diagram for each Vector. The Scatter Diagram for a particular Vector contains a point for each Holding, where the TSE for a Holding is plotted on the x-axis and the Vector value of the Holding is plotted on the y-axis. An example of a Net Cash Vector Scatter Diagram of a sample portfolio is shown in FIG. 3. The other Vectors (Vectors 2-9) can similarly be presented in appropriate Scatter Diagrams. As FIG. 3 demonstrates, the Vector Scatter Diagrams thus provide a quick, visual representation of the financial structures (on a Vector-by-Vector basis) of each of the Holdings of the portfolio and, importantly, can assist in identifying those Holdings that may have more-favorable or less-favorable (i.e., outliers) financial Vector-to-TSE structures.

OPPERA's Cash Level and Cash Flow Metrics:

OPPERA utilizes Cash Level metrics and Cash Flow metrics, which are discussed below. OPERRA measures Cash Levels across time as a proxy for Cash Flow as the former can be derived solely from the Balance Sheet line items and which, thereby, avoids relying on the validity of reported earnings to calculate Cash Flow. The Cash Level metrics are values as of the end of a time period (e.g., reporting period). From the figures that are reported in a Holding's Balance Sheet statements, OPERRA derives the four following metrics relating to a Holding's Cash Level:
“Gross Cash,” which represents all Cash and Cash Equivalents;
“Net Cash,” which is defined as Gross Cash less Short-Term Debt (STD);
“Free Cash,” which is defined as Net Cash less all Debt (STD and LTD); and,
“Organic Cash,” which is defined as Free Cash less Unearned Shareholders Equity (USE) and which is also equal to Gross Cash less all Debt (STD and LTD) and less USE.
   As previously discussed, Net Cash is also one of the TSE Vectors.

A firm's Cash Flow is traditionally calculated by adding to its reported net income figure (for a given fiscal quarter or year) non-cash charges such as depreciation, amortization and goodwill. Given the poor quality of reported income of many public firms, OPERRA methodology avoids both the use of reported earnings and short time frames in measuring financial Performance and Position. Accordingly, OPERRA derives its Cash Flow figures from changes in the levels of selected cash-related Balance Sheet accounts over a multi-year time interval (from first end-of-quarter period level to the last). These OPERRA measures of Cash Flow are preceded by “BSD” (Balance Sheet Derived) to emphasis that the OPERRA Cash Flow metrics are not derived from figures that are reported on a P&L Statement.

From the above four measures of cash levels, OPERRA derives the four following metrics which relate to a Holding's Cash Flow:
“BSD Gross Cash Flow,” wherein BSD Gross CF is defined as Gross Cash(t) minus Gross Cash(t−n);
“BSD Net Cash Flow,” wherein BSD Net CF is defined as Net Cash(t) minus Net Cash(t−n);
“BSD Free Cash Flow,” wherein BSD Free CF is defined as Free Cash (t) minus Free Cash (t−n); and
“BSD Organic Cash Flow,” wherein BSD OCF is defined as (BSD Free CF−USE)(t) minus (BSD Free CF−USE)(t−n)
   and wherein “t” is the time slice that occurs at the end of the time interval that is being evaluated and “t−n” is the time slice that occurs at the end of the first quarterly time period of the time interval that is being evaluated.

OPERRA, therefore, utilizes many unique financial metrics. Some of these unique financial metrics include:
Cum. ECOP;
OSE (i.e. Real Retained Earnings), which reflects the net earnings retained in the business after both Dividends and special/nonrecurring charges and/or gains (reflected in accounts such as “less Accumulated Loss” are accounted for;
Organic Cash Aspects:
   The Gross Cash which would be on hand (at the end of time interval) had the firm had no change in the level of Total (short and long term) Debt and had netted zero cash from the sale and redemption of stock;
   OPPERA measures Cash Levels across time as a proxy for Cash Flow as the former can be derived solely from Balance Sheet accounts which thereby avoids relying on the validity of reported earnings to calculated Cash Flow.
      Filters

OPPERA utilizes 62 different filter ratios (i.e., Filters) to evaluate the financial strength of each Holding, over a period of time, in comparison to the comparable financial strengths of all of the Holdings that make-up a portfolio. The filter ratios are based upon financial metrics. Some filter ratios, for example, are designed to illustrate the quantitative relationships that exist between one financial metric and another. The financial metrics that comprise the OPERRA filter ratios consist of the OPERRA metrics and vectors that were discussed above, as well as financial metrics that are used in a conventional financial analysis.

The OPERRA Filters are designed so that a firm's relative strength for a given filter ratio is not affected by the size of the firm. The metrics that reside in the numerators and denominator of the Filters are generally formatted as dollar amounts. The numerator metric is typically the financial variable that is of particular interest to that filter ratio and may be a value at a point in time or a flow that extends over a time interval. The denominator metric is typically a weighting factor that is chosen to compensate for the firm's size or is chosen to compensate for the particular that resides in the numerator. For example, a filter ratio consists of Free Cash/LTD has Net Cash numerator metrics that is “offset” by the LTD denominator metric. The OPERRA filters ratios are, accordingly, are generally not influenced by the sheer absolute size/amount of certain metrics (e.g., Net Cash, Total Assets, Earnings, Dividends, Cash Flow or increases in Shareholder Equity). In other words, the filter ratios are generally designed so that large firms are not artificially rewarded (i.e., receive higher filter ratio valuations) because of their size (or, conversely, a firm should not be penalized simply because it is small).

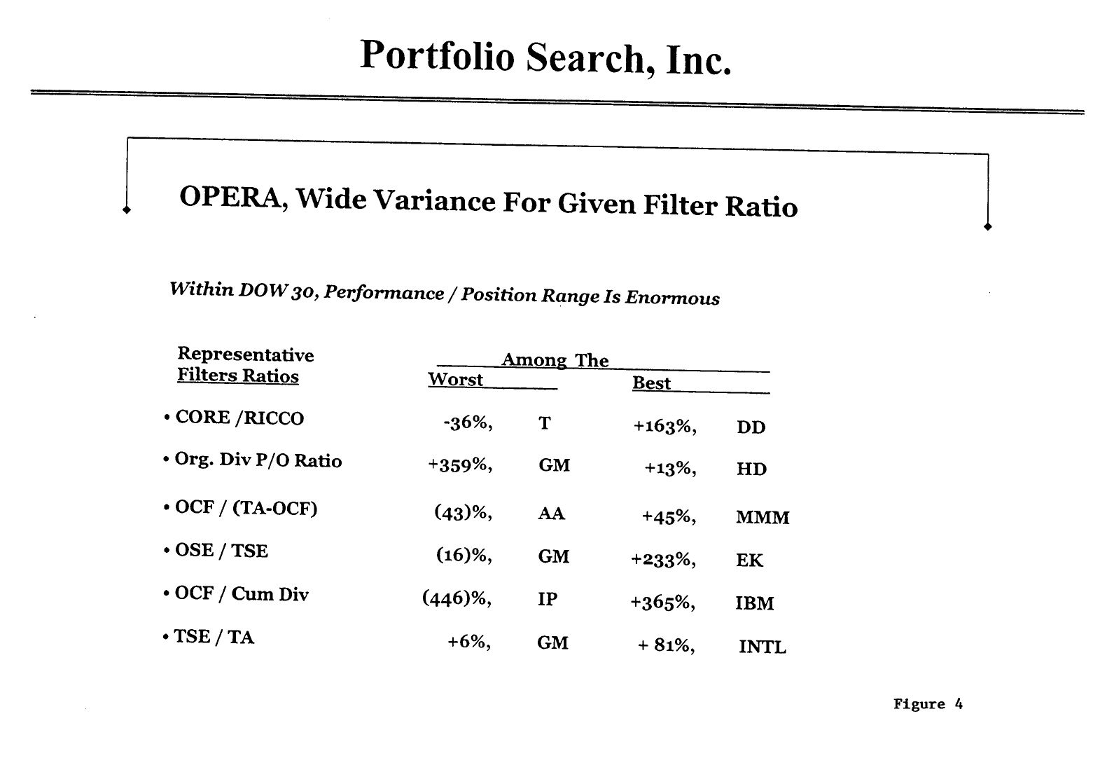

OPERRA analyzes and ranks all of the Holdings of a portfolio by comparing the filter ratio values of each Holding on a Filter-by-Filter basis. The OPERRA Filters that incorporate the novel Organic metrics and Vectors, in addition to certain traditional metrics, are highly discriminatory in that they show dramatic differences in relative weakness/strength across the Holdings that comprise the portfolio. FIG. 4, for example, demonstrates the wide range in filter ratio values that were obtained for six filter ratios of a portfolio that comprised six firms (of the Dow 30).

For some filter ratios, higher filter ratio values (for a given Holding) will be indicative of a Holding's higher relative economic strength which, due to their inverse relationship, is also indicative of lower investment risk. In such cases, Holdings having higher ratios will be ranked higher than those Holdings that have lower (or negative) ratios. For other filter ratios, however, higher filter ratio values (for a given Holding) will be indicative of a Holding's higher investment risk and, thus, also be indicative of lower relative economic strength. For these types of filter ratios, Holdings that have lower (including negative values) will be ranked higher than those Holdings that have higher ratios.

Each of the OPERRA filter ratios has a time-domain aspect and an attribute aspect. Depending upon the nature of the filter ratio, each filter ratio is grouped into one of three different time-domains “Classes.” The three Classes are “Level,” “Flow,” and “Change”: “Level” filter ratios evaluate a ratio that exists a particular slice of time; “Flow” filter ratios evaluate a cumulative change that has occurred during an interval of time; while “Change” filter ratios evaluate how much the value of a Level-type filter ratio has changed at later period of time in relationship to an earlier period of time.

Depending upon the nature of the filter ratio, each filter ratio is also grouped into one of eight different attribute “Perspectives.” The different filter ratio attribute “Perspectives” are: Economic Profit, Dividend Strength, Cash Flow, Asset Quality, Debt Load, Organic Shareholders Value (OSE), Total Shareholders Value (TSE) and Market Capitalization.

For each Holding that is included in the portfolio, OPERRA generates a Master Matrix (i.e., a Master Matrix By Holding). The Master Matrix is a 9×4 database matrix that consists of three Class rows, one for each type of Class, a fourth Sub-Total row, eight Perspective columns, one for each type of Perspective, and a ninth Sub-Total column. The 62 OPERRA Filters are disposed within 13 different active cells of the Master Matrix. The active cells that contain the 62 Filters are indicated with an “x” in Table 1 below:

TABLE 1
Active Cells of the Master Martix

| | OPERRA Perspectives: | | | | | | | | |
|---|---|---|---|---|---|---|---|---|---|
| | Economic | Dividend | Cash | Asset | Debt | | | Market | Sub |
| Classes: | Profit | Strength | Flow | Quality | Load | OSE | TSE | Cap | Total |
| Level | — | — | — | x | x | x | x | x | |
| Flow | x | x | x | — | — | — | — | — | |
| Change | — | — | — | x | x | x | x | x | |
| SubTotal | | | | | | | | | |

The 62 filter ratios are disposed within the 13 cells as is shown in Table 2:

TABLE 2
Deposition of the 62 Filters within the Active Cells

| | OPERRA Perspectives: | | | | | | | | |
|---|---|---|---|---|---|---|---|---|---|
| | Economic | Dividend | Cash | Asset | Debt | | | Market | Sub |
| Classes: | Profit | Strength | Flow | Quality | Load | OSE | TSE | Cap | Total |
| Level | — | — | — | 6 | 5 | 2 | 3 | 5 | 21 |
| Flow | 5 | 10 | 6 | — | — | — | — | — | 21 |
| Change | — | — | — | 6 | 5 | 2 | 3 | 4 | 20 |
| SubTotal | 5 | 10 | 6 | 12 | 10 | 4 | 6 | 9 | |

Once the metrics that comprise the different filter ratios have been determined based upon the Holdings' financial information that OPERRA obtained, the values of the 62 filter ratios are then determined for each Holding that is included in the portfolio.

The 62 OPERRA Filters are discussed in detail below.

The OPPERA Filters in More Detail:

The 62 filter ratios, as arranged by their “perspective” types, are discussed in more detail below.

The Economic Profit (ECOP) Filter Ratios:

OPERRA's Economic Profit (ECOP) Filters do not compare absolute dollar amount or growth rates of one Holding to another. A enterprise having higher earnings growth or more absolute profit dollars will not necessary get a higher percentile position (from earnings-related Filters) than an enterprise that has less profit dollars or a lower growth rate. Rather, more favorable percentile positions for such Filters will reflect a higher ratio of enterprises real earning power (as measured by Cum. ECOP for the time interval) to reported earnings (as measured by Cum. RICO for the same time interval). In this sense, OPERRA determines relative earnings strength on the basis that a Firm's quality of earnings.

Within the Master Matrix, the five ECOP filter ratios are contained within the cell that is defined by Time Class “Flow” and Perspective “Economic Profit.” The first ECOP filter ratio is:
Cum. ECOP/Cum. RICO (Filter 1)

For a chosen interval, each Holding's Cum. ECOP is calculated as a ratio of its Cum. RICO. The higher the ratio for a given Holding (i.e., enterprise), the closer the reported earnings is to reflecting all economic events that transpired over the time interval. Holdings have higher ratios will accordingly be assigned higher positional percentages that reflect their higher relative economic strengths. The Holding having the largest “Cum. ECOP to Cum. RICO” ratio, for example, will be assigned a positional percentile ranking of “100,” the Holding with the smallest “Cum. ECOP to Cum. RICO” ratio will be assigned a positional percentile ranking of “0,” and the remaining Holdings of the Portfolio will be assigned positional percentage ranks according to their increasing “Cum. ECOP to Cum. RICO” ratios. For this Filter (Filter 1), there is an exception to the rank method for those Holdings having a zero or negative Cum. RICO, as a negative denominator distorts the ratio calculation. Accordingly, Holdings having a zero or negative Cum. RICO are not ranked for this particular Filter and a message to this effect may be shown on an OPERRA Display(s).

The following example demonstrates how the ECOP Filters account for the special charges that a Holding may have been taken during a time interval that is being evaluated.

Assume two firms each having after-tax earnings of $15.0M before $10.0M in various charges portions of such charges could or could not be taken against Continuing Operations depending accounting rules are interpreted. Firm A determines that $7.0M of the $10.0M in such charges was related to Continuing Operations and, accordingly, reported Cum. RICO of $8.0M with $3.0M in nonrecurring charges taken below the P&L line item for Income from continuing operations (i.e., Cum RICO) (see Table 3 below). Firm B, however, determined that only $2.5M of the $10.0M in such charges related to Continuing Operations and, accordingly, reported Cum. RICO of $12.5M with $7.5M in nonrecurring charges taken below the Cum. RICO line. Traditional analysis would consider (other factors being equal) Firm B's performance to be superior since its “Income from continuing operations” (i.e. Cum. RICO) was higher than Firm A's. (Hence, the inducement for corporate management to categorize charges as special or non-recurring and show them below the line for Cum. RICO.)

This example can be represented as:

TABLE 3

Firm:

| | A | B |
|---|---|---|
| Cum. After-Tax Earnings⁽¹⁾ | $15.0 M | $15.0 M |
| Cum. Other Charges | (7.0) | (2.5) |
| To Continuing Ops⁽²⁾ | | |
| Cum. RICO | 8.0 | 12.5 |
| Cum. Non-Recurring Charges⁽²⁾ | (3.0) | (7.5) |
| Cum. ECOP | $5.0 M | $5.0 M |
| Cum. ECOP/Cum. RICO Filter | 63% | 40% |

Notes:
⁽¹⁾Before various non-recurring, one-time charges totaling $10.0 M over the interval.
⁽²⁾These two line items total $10.0 M for each firm.

OPERRA Differentiates Earnings Levels Within P&L:

Looking solely at Cum. RICO does not discriminate between firms with relatively high and low levels of special charges relative to Cum. RICO. Such charges, however, do reflect real economic events that are part of the firm's track record. Thus, in contrast to conventional analysis, OPERRA's ECOP Filters accounts for the so-called special charges that a firm takes. For example, Firm A scores higher on the basis of higher quality of reported earnings in that 63% of its Cum. RICO was backed by Cum. ECOP, as compared to only than 40% for Firm B.

The ECOP Filters thus provide self-correcting measurements in that OPERRA's calculation of firm's relative strength will not benefit by management shoveling cost into special charges (to be taken below the line to boost “Income from continuing operations”). In fact, a firm's relative measure of strength is penalized in proportion to the amount of such charges relative to Cum. RICO.

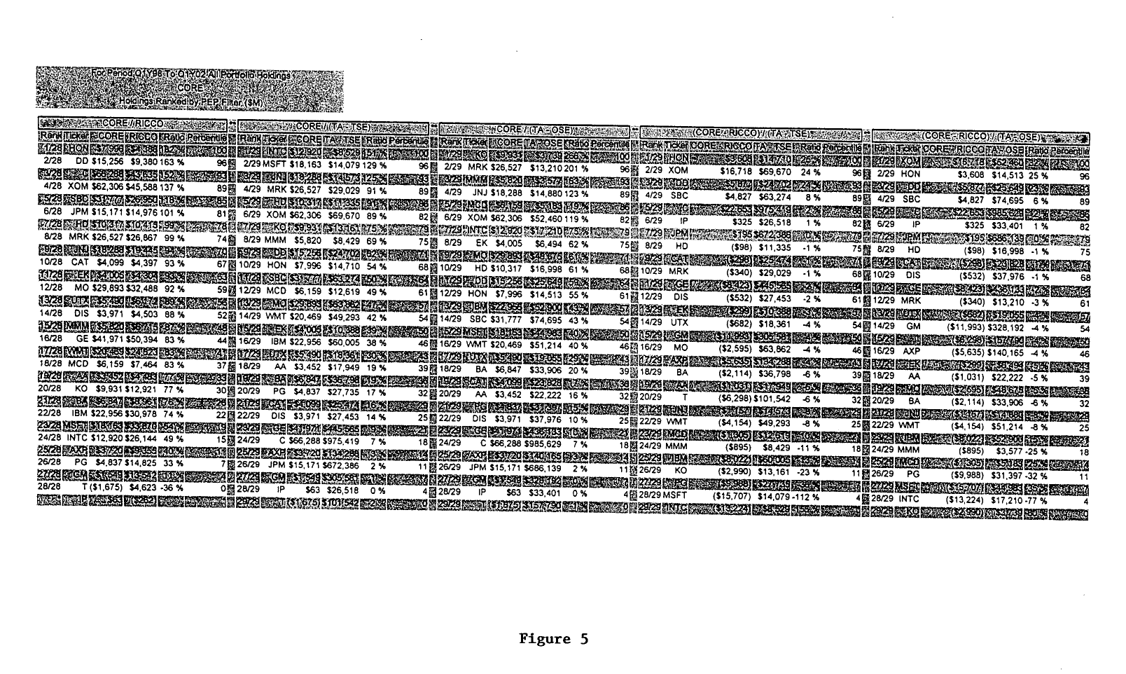

The other four ECOP Filters are:
Cum. ECOP/(TA−TSE) (Filter 2)
Cum. ECOP/(TA−OSE) (Filter 3)
(Cum. ECOP−Cum. RICO)/(TA−TSE) (Filter 4)
(Cum. ECOP−Cum. RICO)/(TA−OSE) (Filter 5)
Examples of these calculated filter ratios (Filters 1-5) for 28 Holdings of a portfolio are shown in FIG. 5. For each of these ECOP Filters, Holdings having higher ratios will be ranked higher than those Holdings that have lower (or negative) ratios.
The Organic “Dividend Strength” Filter Ratios:

The commonly-used Dividend Pay Out Ratio is typically the amount of the common-share Dividends that were paid out divided by the reported after-tax “Income from continuing operations” for a given fiscal year. Unfortunately, this ratio understates the portion of actual earnings paid out to the extent that a Holding's reported earnings (which OPERRA measures using Cum. RICO) exceed its real earning power (which OPERRA measures using Cum. ECOP). To address the deficiency, OPERRA derives and evaluates two types “Organic P/O Ratios, both of which reside in the cell defined by Time Class “Flow”/Perspective “Dividend Strength” (DS). The first DS filter ratio (Filter 6) has flow figures for both numerator and denominator and the second DS filter “ratio” (Filter 7) (its actually an absolute percentage point difference) quantifies the difference between the Organic P/O and the Reported P/O.
Cum. Dividends/Cum. ECOP (“Absolute Organic P/O Ratio”) (Filter 6)
For a given Holding over the selected time interval, the Absolute Organic P/O Ratio is the amount of cumulative common-share Dividends paid divided by Cum. ECOP. The Holding with lowest ratio gets the highest ranking, i.e., the lower pay out ratios are indicative of less Dividend risk. From this ranking, each portfolio Holding is assigned its Position Percentile for this Filter.
Reported P/O Ratio minus Organic P/O Ratio (“Relative Organic P/O Ratio”) (Filter 7)
For a given Holding over the selected time interval, the Relative Organic P/O Ratio measures the absolute percentage point difference between the Organic and Reported P/O Ratios. Here, the highest rank is awarded to the Holding with its Organic P/O Ratio the most absolute percentage points below the Reported P/O Ratio (as compared to the difference for all other Holdings in the portfolio). Conversely, the lowest rank is awarded the Holding with its Organic P/O Ratio the most absolute percentage points above the Reported P/O Ratio.

Neither the Absolute nor the Relative Organic P/O Ratios directly measure the extent to which the Holding's Dividend payment were justified on the basis Cash Flow or stress placed on the Balance Sheet. OPERRA makes such measurements by taking each Holding through an additional eight filter ratios (Filters 8-15) which also reside in the Cell defined by Time Class Flow and Perspective.
BSD Net CF/Cum. Dividends (Filter 8)
BSD Free CF/Cum. Dividends (Filter 9)
Both show whether or not Free CF was sufficient to support the cum. Dividends that were paid (or declared, if the Holding reports dividends on a Dividend Declared basis) over the interval. Holdings having higher ratios will be ranked higher than those Holdings that have lower (or negative) ratios.
Cum. Dividends/TSE (Filter 10)
Cum. Dividends/OSE (Filter 11)
Both Filters (Filters 10 and 11) show the extent to which the Dividends paid were supported by the Holding's equity level (i.e., TSE) and equity quality (i.e., OSE). In other words, Filters 10 and 11 assess whether the Dividends declared or paid by a Holding was justified based upon the Holding's equity level and quality. Holdings having higher ratios will be ranked higher, via an appropriate position percentile, than those Holdings that have lower (or negative) ratios.
D ratio, TSE/TA (Filter 12)
d ratio, OSE/TA (Filter 13)
d ratio, OSE/TSE (Filter 14)
These three Dividend filter ratios (Filters 12-14) quantify how much stronger the Balance Sheet would have been with respect to relative OSE and TSE levels had no Dividends been paid over the time interval. In other words, these Dividend filter ratios quantify the Balance Sheet “penalty” that a Holding incurred in paying Dividends. In a sense, this a measure of the “opportunity cost” in quantifying the degree to which the firm's Balance Sheet, especially its equity base, would have been stronger (at the end of the time interval being analyzed) had the firm refrained from paying Dividends (over the time interval under analysis) and instead had retained the cash.

Each of these three Dividend filter ratios is for the end-of-interval time slice. The d ratio being the difference between the as-reported Ratio value (given actual Dividend payments) and a pro forma Ratio value. The latter, pro forma ratio computed on the assumption that no Dividends had been paid and that all of the curtailed associated capital outflow was retained in the firm.

Ratios other than these three could be used to measure financial stress from Dividend payments. The key idea to quantify how much better a given Balance Sheet ratio would have been (had no Dividends been paid) and rank Holdings accordingly. For these Dividend filter ratios, Holdings having higher ratios will be ranked higher than those Holdings that have lower (or negative) ratios.

None of the nine above Dividend filter ratios presented above quantifies whether or not a firm's Dividend payments were justified on the basis of the firm's internally-generated Cash Flow, BSD OCF. Addressing this issue is the tenth and final filter ratio. For a selected time interval, this filter ratio is OCF divided by cumulative Dividends paid:
BSD OCF/Cum. Dividend Paid. (Filter 15)
This filter ratio (Filter 15) is the acid test of whether a firm's past common-share Dividend payments were “organically” justified. Holdings having higher ratios will be ranked higher than those Holdings that have lower (or negative) ratios.

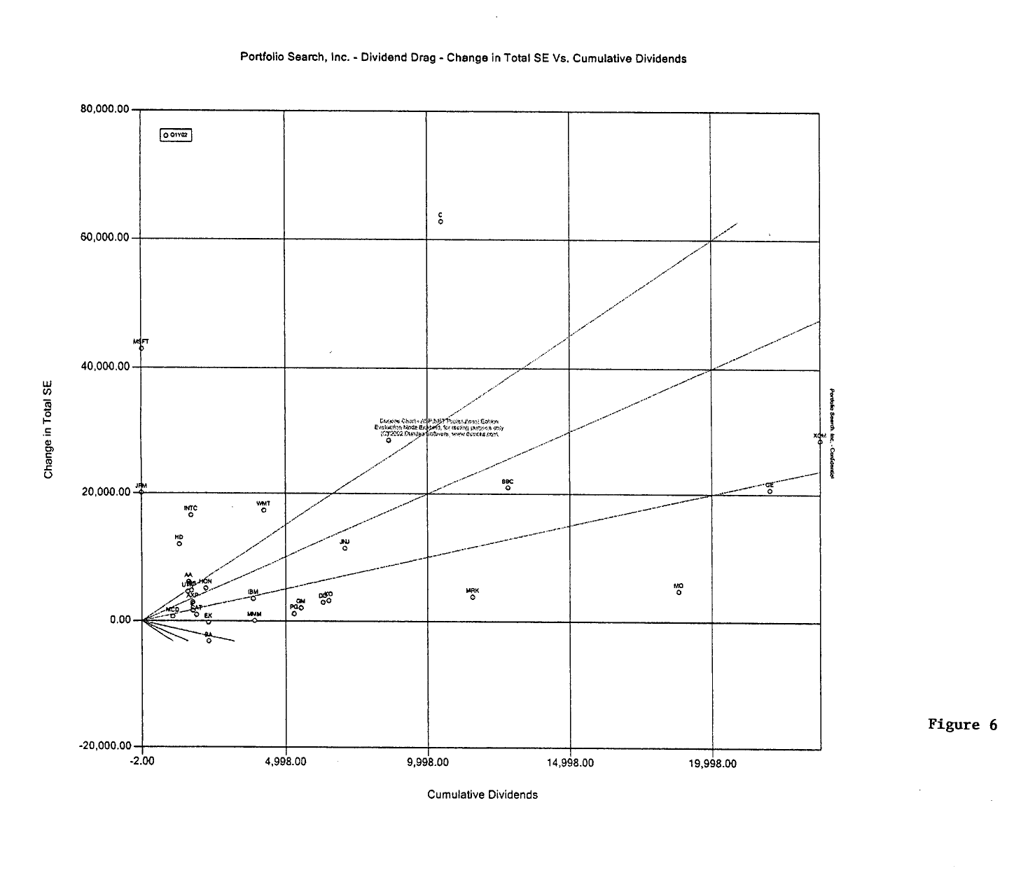

For each of the ten “Dividend Strength” filters ratios (all of which are contained within the “Flow” time class), OPERRA generates a dedicated Scatter diagram. Each diagram covers a selected time slice covering all Holdings where each portfolio Holding is represented by a single coordinate point. In the Scatter diagram corresponding to a particular filter ratio, the denominator of the filter ratio is plotted on one axis whether the numerator of the filter ratio is plotted on another. FIG. 6, for example, illustrates a Scatter diagram that plots the Cum. Dividends/TSE filter ratio (Filter 10) for each Holding of the portfolio.

All Dividend Filters are discarded for a Holding that has paid no Dividends over the time interval that is being evaluated, i.e., the Dividend Filters are not considered to be viable for these Holdings.

The Balance Sheet Derived “Cash Flow” Filter Ratios:

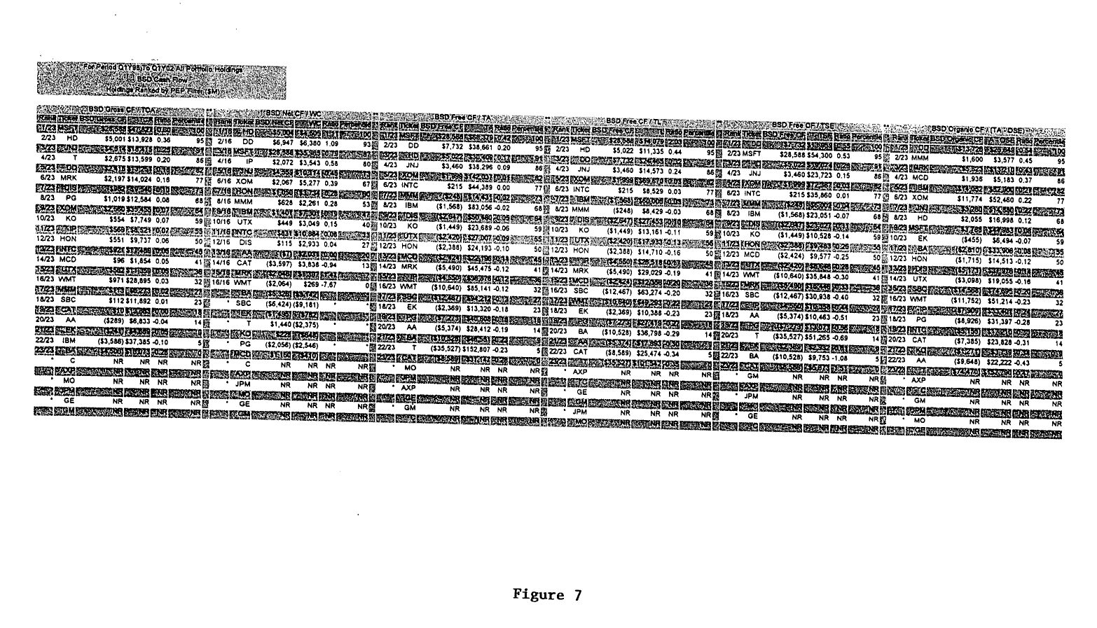

Within the OPERRA Master Matrix, the cell for the Time Class “Flow” and Perspective Balance Sheet Derived (BSD) “Cash Flow” covers a given time interval and contains the following six Filters:
BSD Gross CF/TCA(t) (Filter 16)
BSD Net CF/WC(t) (Filter 17)
BSD Free CF/TA(t) (Filter 18)
BSD Free CF/TL(t) (Filter 19)
BSD Free CF/TSE(t) (Filter 20)
BSD OCF/(TL+USE)(t) (Filter 21)
wherein “(t)” is the time slice at the end of the time interval.
   Examples of these calculated filter ratios for 28 Holdings of a portfolio are shown in FIG. 7. For each of these Cash Flow filter ratios, Holdings having higher ratios will be ranked higher than those Holdings that have lower (or negative) ratios.
   The “Asset Quality” (AQ) Filter Ratios:

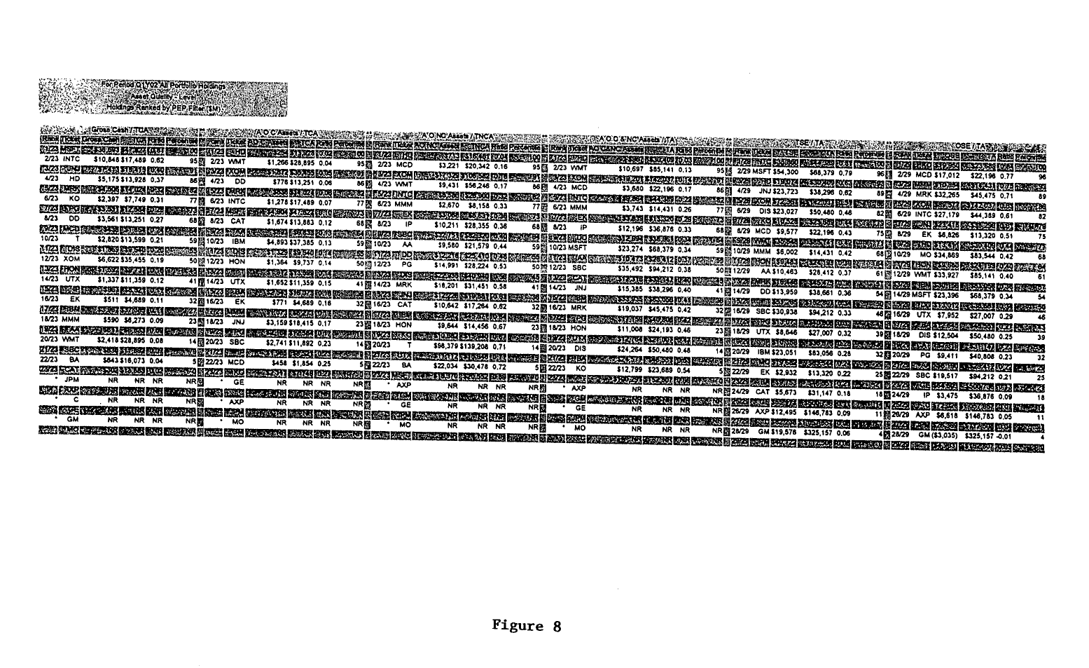

The following six AQ filter ratios reside within the cell of the Master Matrix that is define by Time Class “Level” and Perspective “Asset Quality”:
Gross Cash/TCA (Filter 22)
AOCA/TCA (Filter 23)
AONCA/TNCA (Filter 24)
[AOCA+AONCA]/TA (Filter 25)
TSE/TA (Filter 26)
OSE/TA (Filter 27)
wherein all numerators and denominators of the above six filter ratios (Filters 22-27) are Balance Sheet figures of level for the time slice at the end of the time interval selected for analysis. Examples of these calculated filter ratios for 28 Holdings of a portfolio are shown in FIG. 8. For Filters 22, 26 and 27, Holdings having higher ratios will be ranked higher than those Holdings that have lower (or negative) ratios while, for Filters 23, 24 and 25, Holdings having lower ratios will be ranked higher than those Holdings that have higher ratios.

The following six AQ filter ratios reside within the cell of the Master Matrix that is define by Time Class “Change” and Perspective “Asset Quality”:
d ratio, Gross Cash/TCA (Filter 28)
d ratio, AOCA/TCA (Filter 29)
d ratio, AONCA/TNCA (Filter 30)
d ratio, [AOCA+AONCA]/TA (Filter 31)
d ratio, TSE/TA (Filter 32)
d ratio, OSE/TA ( Filter 33)

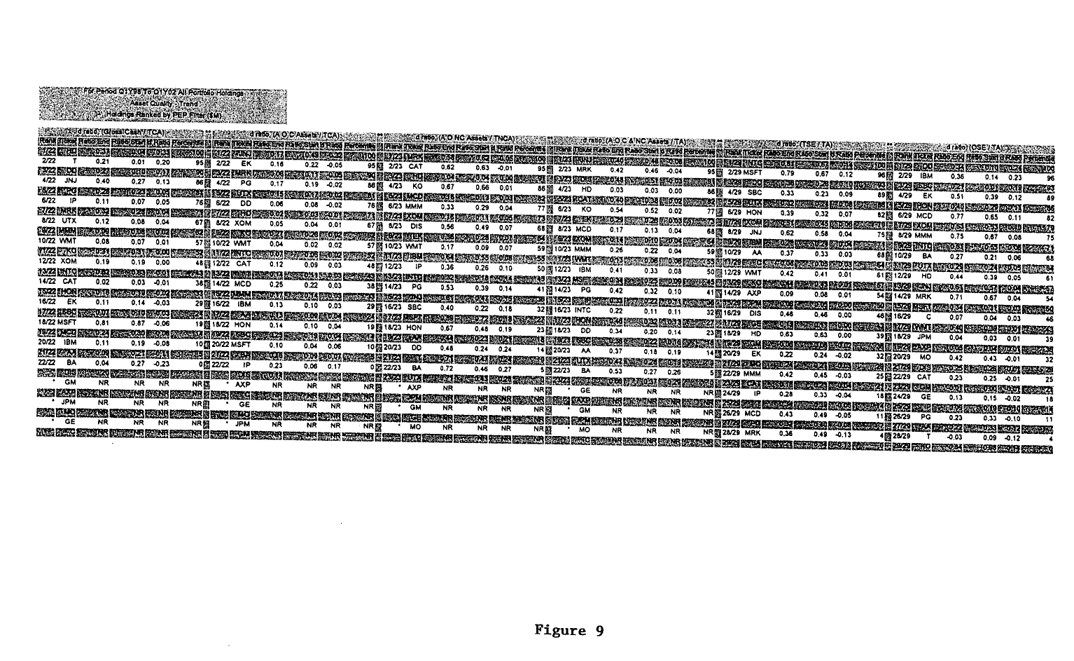

Examples of these calculated filter ratios for 28 Holdings of a portfolio are shown in FIG. 9. The above six Filters (Filters 28-33) determine the change in a ratio value from an end period in comparison to a beginning period, i.e., [Ratio]_{end} minus [Ratio]_{beginning}. Filter 28, for example, is calculated by determining
[Gross Cash/TCA]_{end}−[Gross Cash/TCA]_{beginning}
For Filters 28, 32 and 33, Holdings having larger net changes will be ranked higher than those Holdings that have lower (or negative) changes while, for Filters 29, 30 and 31, Holdings having lower net changes (including negative changes) will be ranked higher than those Holdings that have higher net changes.
The “Debt Load” (DL) Filter Ratios:

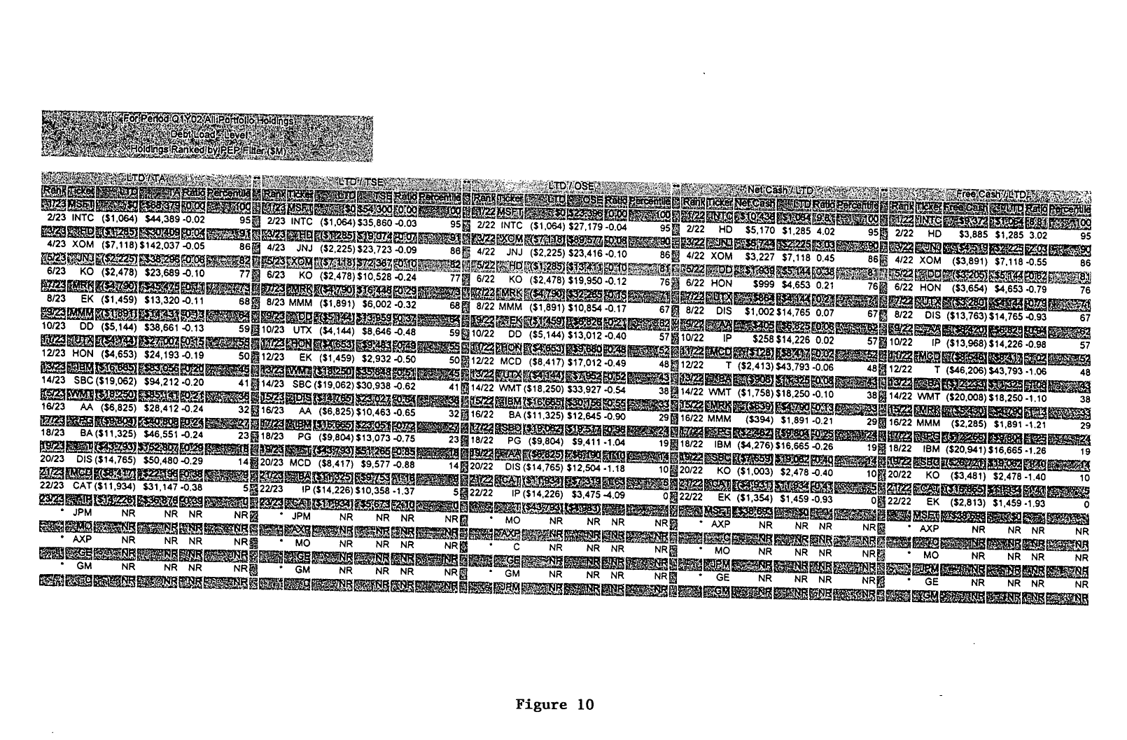

The following five Long Term Debt (LTD) DL filter ratios reside within the cell of the Master Matrix that is defined by the Time Class “Level” and Perspective “Debt Load”:
LTD/TA (Filter 34)
LTD/TSE (Filter 35)
LTD/OSE (Filter 36)
Net Cash/LTD (Filter 37)
Free Cash/LTD (Filter 38)
wherein all numerators and denominators are Balance Sheet figures of level for the time slice at the end of the selected time interval selected for the analysis. Examples of these calculated filter ratios for 28 Holdings of a portfolio are shown in FIG. 10. LTD is generally a negative vector (i.e., for purposes of the Filters, the value of LTD for a given Holding is assumed to be a negative value). However, whenever LTD is used in the denominator of a Filter (e.g., Filters 37, 38, 42 and 43), the negative aspect of LTD is ignored and the absolute value of the Holding's LTD is used instead. Thus, the LTD values of Filters 34, 35, 36 are negative numbers while the LTD values of Filters 37 and 38 are positive numbers. Using this approach, for each of these DL Filters (Filters 34-38), Holdings having higher ratios will be ranked higher than those Holdings that have lower (or negative) ratios.

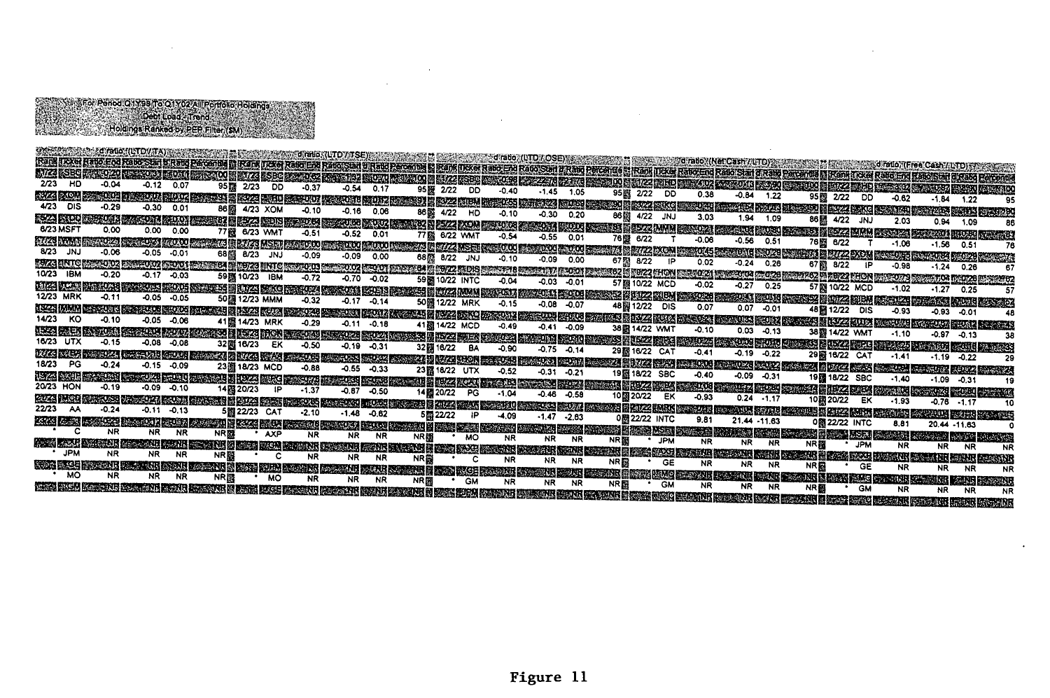

The following additional five LTD DL filter ratios reside within the cell of the Master Matrix that is define by Time Class “Change” and Perspective “DL”:
d ratio, LTD/TA (Filter 39)
d ratio, LTD/TSE (Filter 40)
d ratio, LTD/OSE (Filter 41)
d ratio, Net Cash/LTD (Filter 42)
d ratio, Free Cash/LTD (Filter 43)
These Filters (Filters 39-43) determine the change in a ratio value from an end period in comparison to a beginning period, i.e., [Ratio]_{end} minus [Ratio]_{beginning}. Filter 39, for example, is calculated by determining
[LTD/TA]_{end}−[LTD/TA]_{beginning}
Examples of these calculated filter ratios for 28 Holdings of a portfolio are shown in FIG. 11. For each of these Filters, Holdings having higher d ratios (i.e., net changes) will be ranked higher than those Holdings that have lower (or negative) d ratios.
The “OSE” (Organic Shareholders Equity) Filter Ratios:

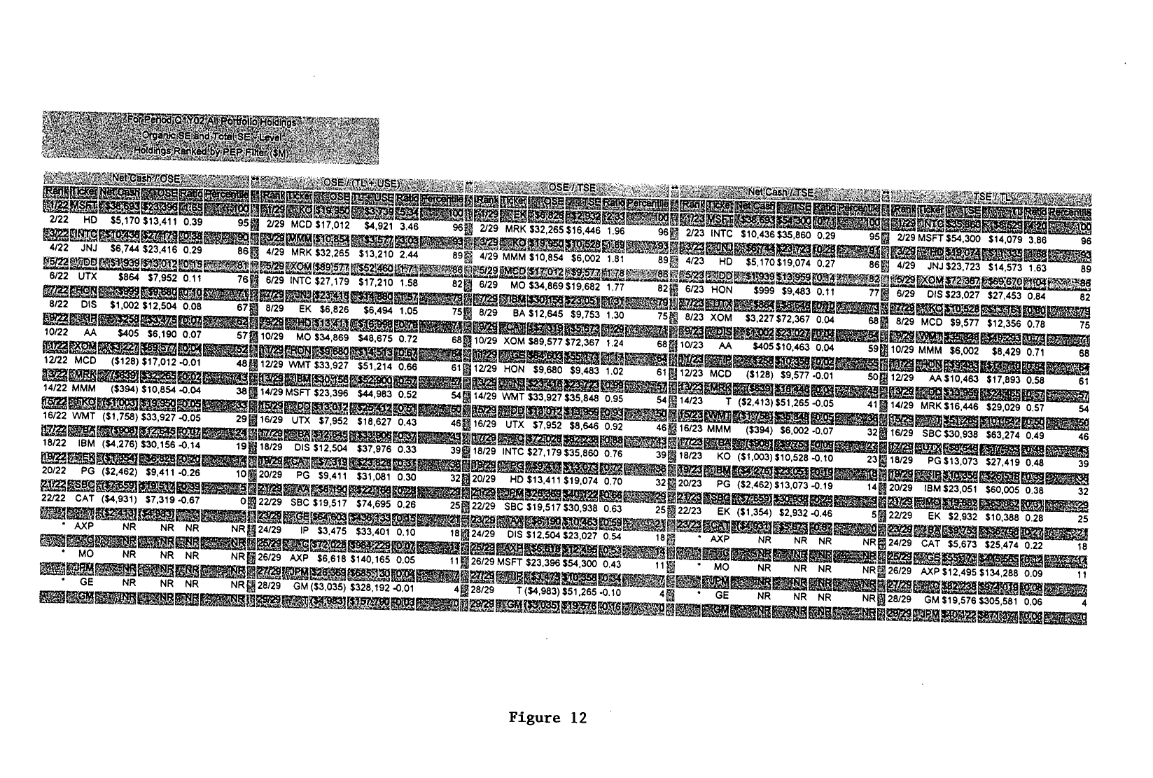

The following two OSE filter ratios reside within the cell of the Master Matrix defined by Time Class “Level” and Perspective “OSE”:
Net Cash/OSE (Filter 44)
OSE/((TL+(TSE−OSE)) (Filter 45)
wherein all numerators and denominators are Balance Sheet figures of level for the time slice at the end of the time interval for which the analysis is being conducted. Examples of these calculated filter ratios for 28 Holdings of a portfolio are shown in the first two columns of FIG. 12. For both of these OSE Filters, Holdings having higher ratios will be ranked higher than those Holdings that have lower (or negative) ratios.

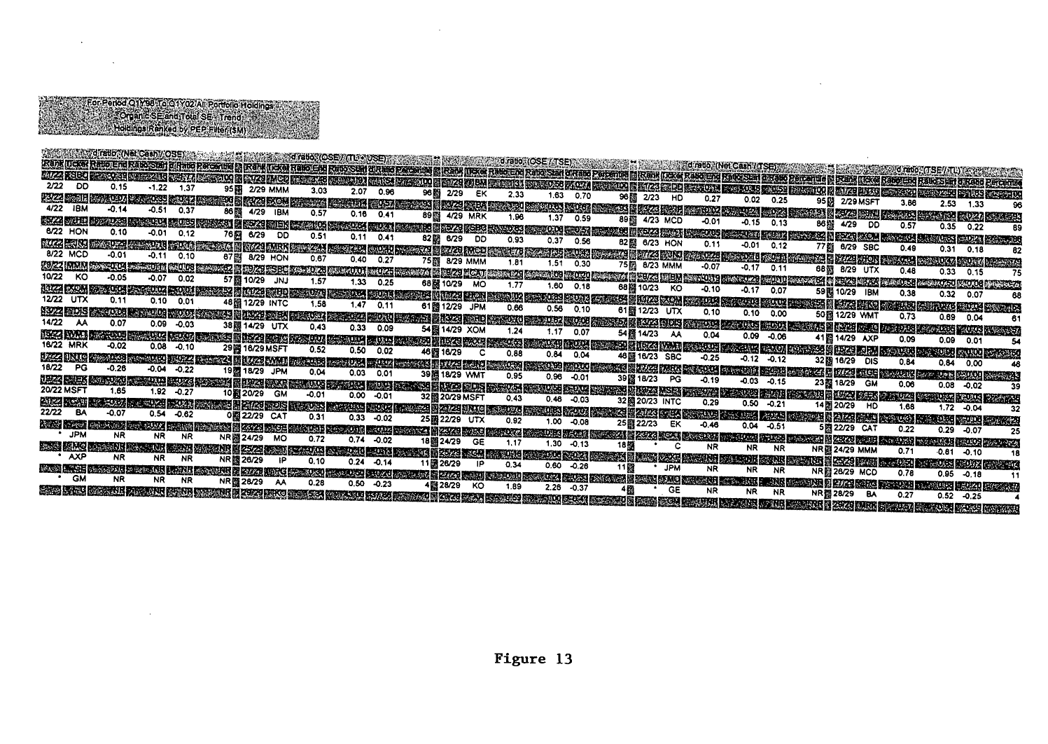

The following three OSE filter ratios reside within the cell of the Master Matrix defined by Time Class “Change” and Perspective “OSE”:
d ratio, Net Cash/OSE (Filter 46)
d ratio, OSE/((TL−OSE)) (Filter 47)
The above two Filters (Filters 46 and 47) determine the change in a ratio value from an end period in comparison to a beginning period, i.e., [Ratio]_{end} minus [Ratio]_{beginning}. Filter 46, for example, is calculated by determining
[Net Cash/OSE]_{end}−[Net Cash/OSE]_{beginning}
Examples of these calculated filter ratios for 28 Holdings of a portfolio are shown in the first two columns of FIG. 13. For both of these OSE Filters, Holdings having higher d ratios (i.e., net changes) will be ranked higher than those Holdings that have lower (or negative) d ratios.
The “TSE” (Total Shareholders Equity) Filter Ratios:

The following three TSE filter ratios reside within the cell of the Master Matrix that is defined by Time Class “Level” and Perspective “TSE”:
OSE/TSE (Filter 48)
Net Cash/TSE (Filter 49)
TSE/TL (Filter 50)
wherein all numerators and denominators are Balance Sheet figures of level for the time slice at the end of the time interval for which the analysis is being conducted. Examples of these calculated filter ratios for 28 Holdings of a portfolio are shown in the last three columns of FIG. 12. For each of these TSE Filters, Holdings having higher ratios will be ranked higher than those Holdings that have lower (or negative) ratios.

The following three TSE filter ratios reside within the cell of the Master Matrix that is defined by Time Class “Change” and Perspective “TSE”:
d ratio, OSE/TSE (Filter 51)
d ratio, Net Cash/TSE (Filter 52)
d ratio, TSE/TL (Filter 53)
The above three Filters (Filters 51, 52 and 53) determine the change in a ratio value from an end period in comparison to a beginning period, i.e., [Ratio]_{end} minus [Ratio]_{beginning}. Filter 51, for example, is calculated by determining
[OSE/TSE]_{end}−[OSE/TSE]_{beginning}
Examples of these calculated filter ratios for 28 Holdings of a portfolio are shown in the last three columns of FIG. 13. For each of these TSE Filters, Holdings having higher ratios will be ranked higher than those Holdings that have lower (or negative) ratios.
The Relative “Market Cap” (MC) Filters Ratios:

Most conventional valuation techniques calculate the ratio of stock price to reported earnings (“P/E”) or, less commonly, the ratio of a firm's valuation or Market Capitalization to its Book Value or TSE. Unfortunately, P/E ratios understate the implicitly-paid price premium/multiple in direct proportion to the extent that reported earnings (which OPERRA measures using Cum. RICO) overstate real earning power (OPERRA measures by Cum. ECOP). Market Cap/TSE ratios understate the implicitly-paid valuation (multiple) in direct proportion to the extent that TSE levels are inflated by poor Asset Quality as evidenced by Asset “water” such as Goodwill or a low content of OSE.

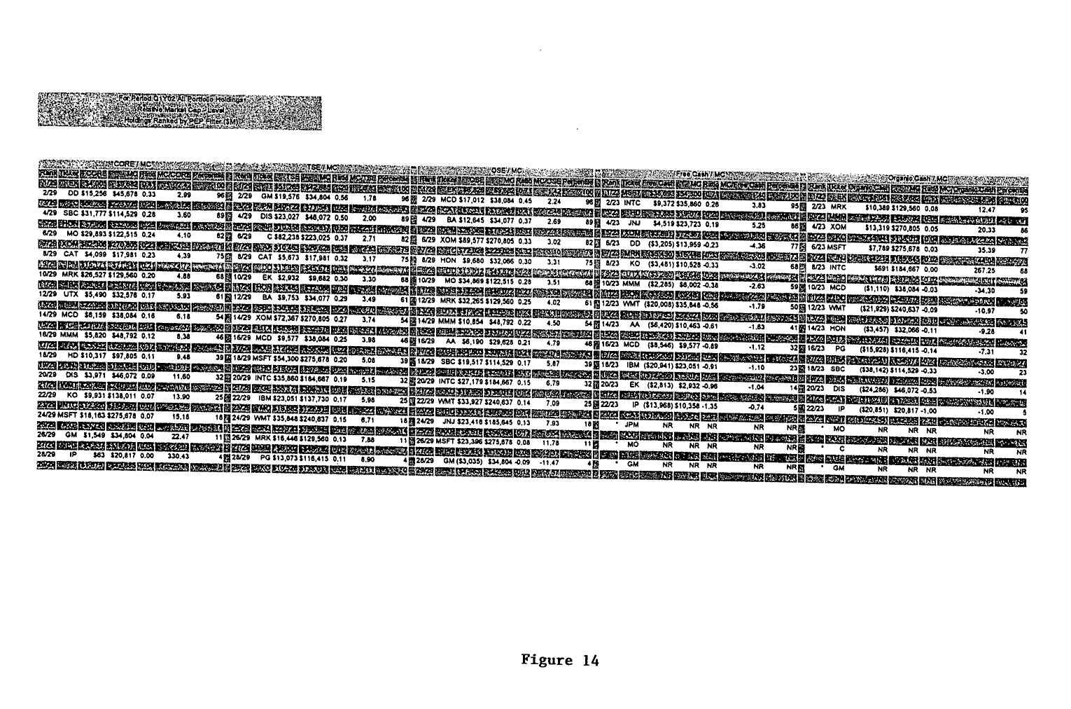

The following five Relative Market Cap filter ratios reside within the cell of the Master Matrix that is defined by Time Class “Level” and Perspective “Market Cap”:
Cum. ECOP/Market Cap (t) (Filter 54)
TSE/Market Cap (t) (Filter 55)
OSE/Market Cap (t) (Filter 56)
Free Cash/Market Cap (t) (Filter 57)
Organic Cash/Market Cap (t) (Filter 58)
wherein all numerators, except Cum. ECOP, are Balance Sheet figures for the time slice at the end of the time interval for which the analysis is being conducted and Cum. ECOP is a cumulative figure over the time interval. All denominators are Market Cap levels at the end of the time interval. Examples of these calculated filter ratios for 28 Holdings of a portfolio are shown in FIG. 14. For each of these MC Filters, Holdings having higher ratios will be ranked higher than those Holdings that have lower (or negative) ratios.

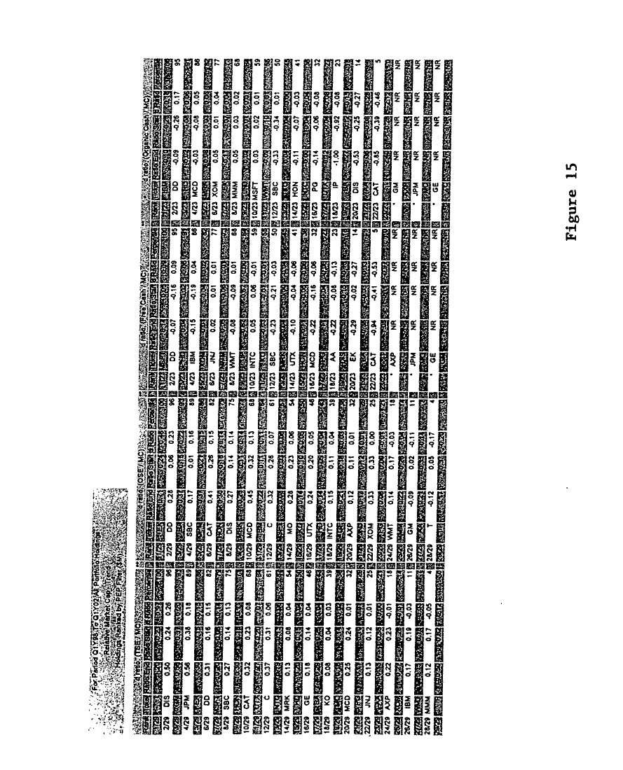

The following four Relative Market Cap filter ratios reside within the cell of the Master Matrix that is defined by Time Class “Change” and Perspective “Market Cap”:
d ratio, TSE/Market Cap (Filter 59)
d ratio, OSE/Market Cap (Filter 60)
d ratio, Free Cash/Market Cap (Filter 61)
d ratio, Organic Cash/Market Cap (Filter 62)
All numerators and denominators are dollar level amounts. The above Filters (Filters 59-62) determine the change in a ratio value from an end period in comparison to a beginning period, i.e., [Ratio]_{end} minus [Ratio]_{beginning}. Filter 59, for example, is calculated by determining
[TSE/Market Cap]_{end}−[TSE/Market Cap]_{beginning}
Examples of these calculated filter ratios for 28 Holdings of a portfolio are shown in FIG. 15. For these four MC Filters, Holdings having higher d ratios (i.e., net changes) will be ranked higher than those Holdings that have lower (or negative) d ratios.

Once the financial information for the period(s) that is to be evaluated has been obtained for all the Holdings and the OPPERA financial metrics of each Holding has be determined, the 62 Filters (values) for each Holding are then determined. Filter values may not be obtained in all cases. In other words, a Holding may have some Filters that are not viable. This can occur when the firm's financial information that comprises a numerator or a denominator of a Filter is not available or cannot be determined or the value of a denominator of a Filter is zero or a negative number (which could lead to an erroneous or misleading result). The filing statements of some Holdings, for example, may not break Assets into Current and Non Current line items which is needed to compute the Net Cash Vector that constitutes the numerator of the Net Cash/OSE Filter (Filter 44). In these cases (missing information and negative or zero denominator), OPERRA considers these to be non-viable Filters and ignores them when evaluating the firm. This also includes the situation where a time-slice of a d ratio is not measurable or has a zero or negative denominator. Another instance arises when a firm does not declare/pay any Dividends in the time interval that is being analyzed. In this case, OPERRA considers all of the Dividend Filters (Filters 6-15) to be non-viable for these firms and, thus, ignores them when evaluating these firms.

Ranking and Assigning Intra-Filter Percentile Scores

The Holdings are stack ranked for each Filter based upon the Holding's Filter values. Depending upon the particular Filter, higher or lower values may give rise to higher positional rankings. With the Cum. ECOP/Cum. RICO Filter (Filter 1), for example, OPERRA computes the Cum. ECOP premium (or discount) to Cum. RICO for each Holding for a selected time interval. Since a higher Cum. ECOP/Cum. RICO value reflects higher relative economic strength, Holdings having higher Cum. ECOP/Cum. RICO ratios will accordingly be assigned higher rankings. Holdings having non-viable Filters will not be ranked for those Filters. Accordingly, the Intra-Filter Positional Scores that are generated are automatically “corrected” to account for the number of Holdings that had viable Filters for that Intra-Filter Positional Score. For each of the Holdings, OPERRA then assigns an Intra-Filter Positional Score that correlates with the ranking that a Holding was assigned in regards to a particular Filter. Thus, assuming a Holding had 62 viable Filters and, therefore, was ranked in each of these Filters, the Holding will receive an Intra-Filter Positional Score for each of the 62 Filters.

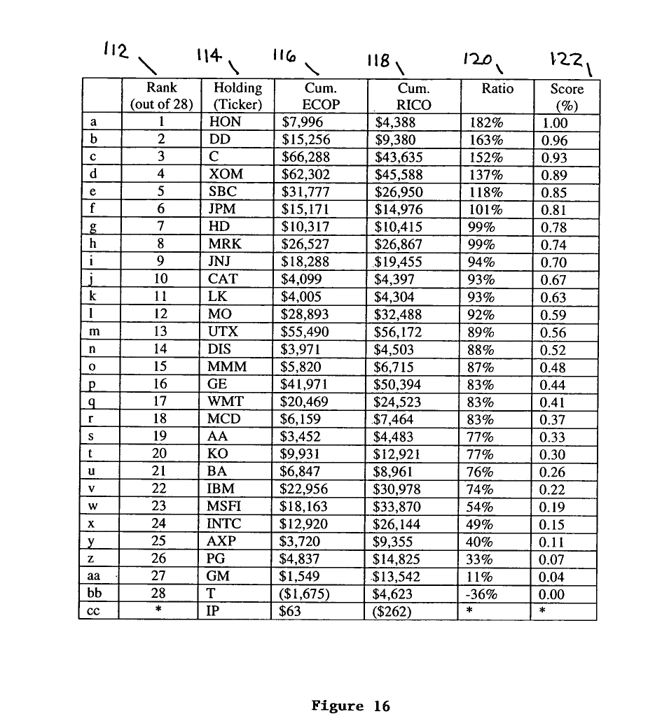

FIG. 16 illustrates a method in which 29 Holdings of a portfolio are ranked and assigned Intra-Filter Positional Scores for the Cum. ECOP/Cum. RICO. The Holdings are identified by their stock tickers, which are presented in column 114. Each row, rows a-cc, corresponds with a different Holding. The Cum. ECOP value for each Holding is presented in column 116 (of FIG. 16) and the Cum. RICO value for each Holding is presented in column 118. It can be seen that the “IP” Holdings located in row “cc” has a Cum. RICO value of negative $262. Since IP has a negative value in the denominator of this filter ratio, the Cum. ECOP/Cum. RICO Filter is not a viable Filter for this Holding. (However, there are other Filters that use Cum. ECOP in the numerator which are likely to be viable.) The IP Holding, therefore, will not be ranked in this Filter and, accordingly, will not be assigned an Intra-Filter Positional Score for the Cum. ECOP/Cum. RICO Filter.

The ratios (values) of the remaining 28 Holdings for this Filter are presented in column 120. As previously discussed, Holdings having higher ratios are assigned higher rankings for this Filter. Thus, the “HON” Holding is ranked first since it has highest ratio (1.82, or 182%) and the “T” Holding is ranked last (i.e., 28 out of 28) since it has the lowest ratio (−0.36, or negative 36%). The rankings of all of the Holdings are presented in column 112. Since the IP Holding was not ranked, the rankings of the Filter only range from 1 to 28.

For each Holding that is ranked, OPERRA assigns an Intra-Filter Positional Score that is based upon the Holding's ranking within that Filter. In a preferred embodiment, OPERRA determines a Holding's Intra-Filter Positional Score based upon:
Intra-Filter Positional Score=(N−Rank)/(N−1)
wherein N is the number of Holdings that were ranked for the Filter and the “Rank” is the Holding's rank within that Filter.

Thus, Holdings ranked first receive an Intra-Filter Positional Score of 1.00 [since (N−1)/(N−1) is 1.00] and Holdings ranked last, i.e., N^{th} out of N, receive an Intra-Filter Positional Score of 0.00 [since (N−N)/(N−1) is zero]. The Holdings that are not ranked first or last will receive Intra-Filter Positional Scores that are evenly distributed between 0.00 and 1.00. The Intra-Filter Positional Scores for the Filter of FIG. 16 are shown in column 122. The “GE” Holding located in row p, for example, was ranked 16 out of 28. Accordingly, this Holding is assigned an Intra-Filter Positional Score of 0.44 [i.e., (28−16)/(28−1)]. The Intra-Filter Positional Scores of the other Holdings are assigned in the same manner.

With this approach to Intra-Filter Positional Scoring, two Holdings that place fifth on different Filters will receive the same Intra-Filter Positional Score for their fifth place finishes regardless of how far behind the two Holdings may have been from the Holdings that placed first in their respective Filters (assuming that an equal number of Holdings are viable for the two different Filters). In other words, the Intra-Filter Positional Score is based upon the Holding's rank in a Filter and not upon the Holding's filter ratio value per se. Thus, a Holding's Intra-Filter Positional Score is an indication of how high a Holding ranked in a Filter in comparison to the other Holdings of the portfolio.

Moreover, the Intra-Filter Positional Score for any Filter for a given Holding, will vary according to the Holding's financial strengths-weaknesses (in regards to that Filter) relative to the particular Holdings that constitute the remainder of the portfolio. Hence, the Intra-Filter Positional Score for a given Holding and a given Filter is unique to the portfolio that is being evaluated. If Holding A is included in two different portfolios, for example, it would not be unusual for Holding A to receive different Positional Scores in the Cum. ECOP/Cum. RICO Filter for the two portfolios despite the fact that Holding' Cum. ECOP/Cum. RICO filter ratio value is the same in both cases.

Alternative intra-Filter positional scoring methodologies can also be used. For example, in one embodiment, OPERRA assigns an Intra-Filter Positional Score based upon the range of values that exist from all the Holdings of a portfolio for a particular filter ratio and the amount that a Holding's filter ratio value penetrates that range. Thus, Holding A's Intra-Filter Positional Score for a particular Filter could be determined as follows:
(Holding A's Filter value−Lowest Filter value in portfolio) divided by (Highest Filter value in portfolio−Lowest Filter value in portfolio)
(assuming that a higher Filter value is indicative of higher financial strength).

Using such a percent penetration (in comparison to the range) Intra-Filter Positional Score methodology can have advantageous when the portfolio is comprised of industry-specific firms, for example.

For a given Holding, any Intra-Filter Positional Scores that are 0.15 (15%) or less are labeled as “at-risk Filters” (for that Holding). The at-risk Filters can be presented to the user to assist in any Drill Down analysis that may be performed.

Average Intra-Filter Positional Scores to Establish a Holding's Fundamental Strength Scores

Each Holding in the portfolio is assigned an Overall Fundamental Strength Score that is relative to the portfolio. Assuming that the Filters are weighted equally, to generate a Holding's Overall Fundamental Strength Score, OPERRA determines the average of the Intra-Filter Positional Scores that the Holding was assigned and then multiplies this number by 100. This can be presented as:
Holding's Overall Fundamental Strength (FS) Score=Σ[Intra-Filter Positional Scores/No. of Viable Filters]×100
For example, if Holding A had 58 viable Filters and the 58 individual Intra-Filter Positional Scores that correspond to those 58 viable filters added-up to 42.47, then Holding A's Overall FS Score would be:
[42.47/58]×100=73.2, or about 73.
Thus, Holding A would have an Overall FS Score of 73. This score is considered to be an “overall” score since it took into consideration of all Holding A's viable Filters. Being directly based upon the values that are obtained from the OPERRA Filters—which place such an emphasis on the Holding's organic, fundamental strengths (or weaknesses)—this score, accordingly, is indicative of the Holding's fundamental financial strength.

In some embodiments, OPERRA may consider some Filters to better indicators of a Holding's financial strength than some others Filters. In such cases, OPERRA may weigh these “better” indicative Filters more heavily than the others. When certain Filters are to be afforded more weight than others, a Holding's (Weighted) Overall FS Score is determined as:
Σ[(Filter Weight)₁×(Intra-Filter Positional Score)₁+ . . . (Filter Weight)_{N}×(Intra-Filter Positional Score)_{N}]/No. of Viable Filters (N)]×100

Regardless of whether the Filters are weighed evenly or not, the Intra-Filter Positional Score that a Holding is assigned for a particular Filter only provides a small contribution to the Holding's Overall FS Score. The OPERRA strength scoring methodology, therefore, is based on the Holding's Intra-Filter Positional Scores (within the portfolio) and not upon the Holding's raw value filter ratios. Thus, the Overall FS Score will not be unduly biased when a Holding has a few extremely high or low raw value filter ratios. Moreover, since the Overall FS Score is based upon a Holding's Intra-Filter Positional Scores—scores which do not unfairly penalize a Holding for having non-viable Filters—the strength scoring is not adversely affected when certain Holdings have Filters that are non-viable.

While a Holding's Overall FS Score is indicative of the Holding's fundamental financial strength and, thus, coveys important information to the user, the score does not necessarily inform the user as to how well a Holding's Overall FS Score ranks in comparison to the other Holdings of the portfolio. Therefore, to provide a score that immediately demonstrates how a Holding's Overall FS Score compares with the Overall FS Scores of the other Holdings (of the portfolio), the Holdings' Overall FS Scores can be ranked and assigned an Overall Fundamental Strength (FS) Positional Score in a manner that is similar to way in which the Holdings' intra-Filter Positional Scores were generated. Namely, the Holdings of the portfolio are first ranked according to their Overall FS Scores, wherein the Holding having the highest Overall FS Score is ranked first, etc. A Holding's Overall FS Positional Score is then determined in the following manner:
Holding's Overall FS Positional Score=[(P−Rank)/(P−1)]×100
wherein P is the number of Holdings that are in the portfolio and the “Rank” is the Holding's Overall FS Score ranking. Thus, the Holding having the highest Overall FS Score would be assigned an Overall FS Positional Score of 100, the Holding having the highest Overall FS Score would be assigned an Overall FS Positional Score of 0.00, and the remaining Holdings would be evenly distributed between 0-100 according to their rankings.

OPERRA generates a chart that display each Holding's Overall FS Positional Score (or Overall FS Score) in a single format so that the user can quickly appreciate the Holding's relative strengths/weaknesses.

In addition to generating Overall FS Scores and Overall FS Positional Scores, OPERRA can also generate fundamental strength scores and fundamental strength positional scores based upon any combination of the 62 Filters. Fundamental strength scores and fundamental strength positional scores, for example, can be generated to measure how the Holdings of a portfolio compare to each other in regards to the Filters that resides within a particular (active) Cell of the Master Matrix or in regards to the Filters that resides within a particular Perspective or Class of the Master Matrix. As previously discussed, the 62 Filters are disposed within the 13 active cells Master Matrix By Holding as shown below:

| | OPERRA Perspectives: | | | | | | | | |
|---|---|---|---|---|---|---|---|---|---|
| | Economic | Dividend | Cash | Asset | Debt | | | Market | Sub |
| Classes: | Profit | Strength | Flow | Quality | Load | OSE | TSE | Cap | Total |
| Level | — | — | — | 6 | 5 | 2 | 3 | 5 | 21 |
| Flow | 5 | 10 | 6 | — | — | — | — | — | 21 |
| Change | — | — | — | 6 | 5 | 2 | 3 | 4 | 20 |
| SubTotal | 5 | 10 | 6 | 12 | 10 | 4 | 6 | 9 | |

To generate an “Level-Asset Quality” FS Score for a particular Holding, for example, OPERRA sum-ups and averages the Intra-Filter Positional Scores that the Holding was assigned for the six Filters (i.e., Filters 22-27) that reside in the Level Class/Asset Quality Perspective cell and then the average number is multiplied by 100. Thus, similar to the Overall FS Scores, a Holding's “Level-Asset Quality” FS Score can be calculated as:
Σ[Intra-Filter Positional Score for Filter 22+Intra-Filter Positional Score for Filter 23+ . . . Intra-Filter Positional Score for Filter 27]/No. of Viable Filters for Filters 22-27]×100
Thus, if Filters 22-26 are viable for Holding A but Filter 27 is not, Holding A's “Level-Asset Quality” FS Score is determined by adding-up the Intra-Positional Scores that Holding A was assigned for Filters 22-26, dividing this number by five and then multiplying by 100.

A Holding's “Level-Asset Quality” FS Positional Score can also be determined similarly to the Holding's Overall FS Positional Score. Namely, after each Holdings' “Level-Asset Quality” FS Score has been determined, the Holdings are ranked based upon their “Level-Asset Quality” FS Scores (highest being best), and the a Holding's “Level-Asset Quality” FS Positional Score is then simply determined as:
[(P−Rank)/(P−1)]×100
wherein P is the number of Holdings that are in the portfolio and the “Rank” is the Holding's “Level-Asset Quality” FS Score ranking.

Thresholds can be set for the Cell FS Score (or Cell FS Positional Score), i.e., Cell Scores, so that Cell Scores of a Holding that fall below the threshold are labeled as “Low Cell Score.” The “low Cell Score” cells can be presented to a user to facilitate Drill Down analysis. A threshold of 35 might be set when the intra-filter positional scoring system is established on a 0-100 scale.

In additional to generating FS Scores and FS Positional Scores that evaluate a particular cell of the Master Matrix, strength scores and strength positional scores can also be generated based upon the Filters that reside within the cells of a particular Class or Perspective. For example, Level Class FS Scores (and Level Class FS Positional Scores) can be generated by evaluating the 21 Filters that reside within the Level Class cells. Strength scores and strength positional scores can also be generated based on any combination of Filters, regardless of which cells the Filters may reside in.

After the Holdings' Intra-Filter Position Scores have been determined, in a preferred embodiment OPERRA determines the following for each Holding of the portfolio:
Overall FS Positional Score
“Level” Class FS Positional Score
“Flow” Class FS Positional Score
“Change” Class FS Positional Score
Cell FS Positional Scores (for each of the 13 active cells).

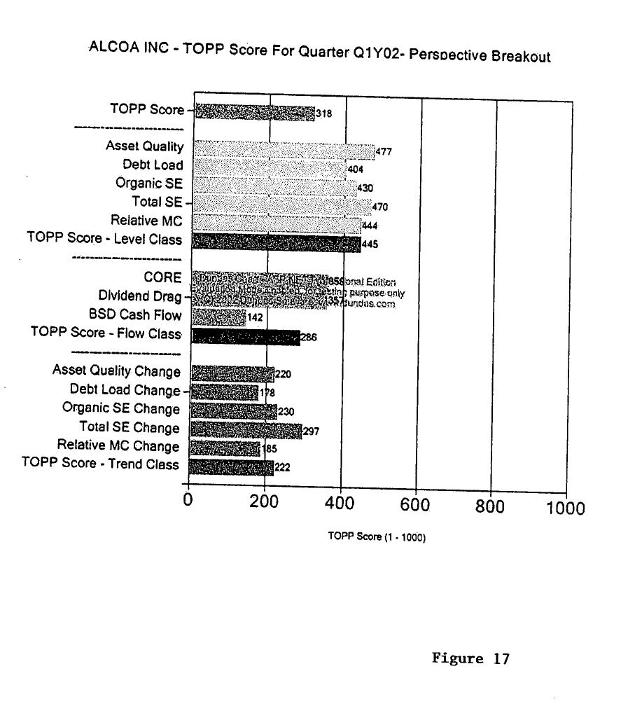

FIG. 17 illustrates how the Overall FS Score, “Level” Class FS Positional Score, Flow” Class FS Positional Score “Change” (Trend) Class FS Positional Score Cell FS Positional Scores of a particular Holding (Alcoa) are displayed to a user in a single Bar Chart format. A similar Bar Chart is generated for each Holding of the portfolio.

As FIG. 17 demonstrates, by disposing the 62 Filters across multiple Time Classes and multiple Perspectives and then generating FS Scores for the different Perspectives, Classes and the 13 active cells, OPERRA advantageously (1) makes it highly unlikely that, for a given Holding, an extreme trend, outlier position or pattern disruption would not be identified, (2) assures that an overall ranking will not be swapped by a strength or weakness from a single Class or Perspective, and (3) allows for an evaluation that is based upon many areas of financial position/performance, independent of a Holding's overall position with respect to Flag Count (discussed below) or Overall FS Score (or Overall FS Positional Score).

Flag Counts

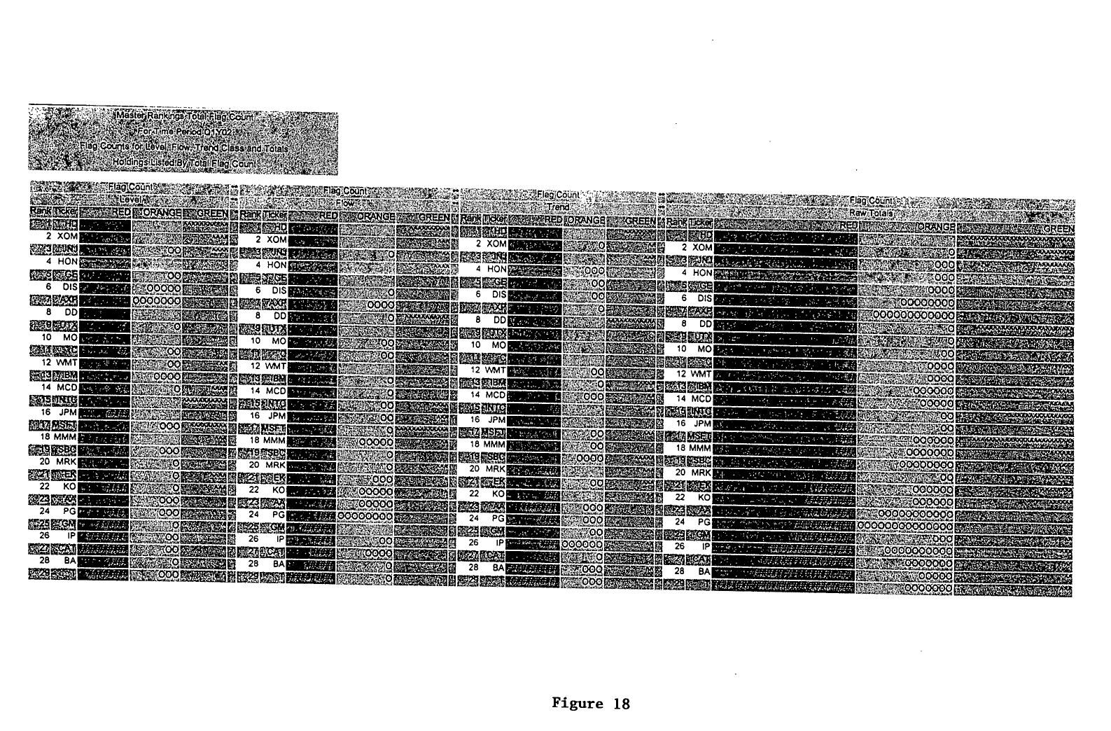

OPERRA assigns different colored Flags to each of the Holdings based upon their Intra-Filter Positional Scores. The different Flags can be identified with different positional scoring thresholds. In a preferred embodiment, OPPERA generates four differently colored Flags, a RED Flag, an ORANGE Flag, a BLUE Flag and a GREEN Flag. OPERRA awards these Flags based upon the following positioning scoring thresholds:
a RED Flag is awarded for each Intra-Positional Score that lies within the bottom 10th percentile (i.e., scores of 0.00-0.10);
an ORANGE Flag is awarded for each Intra-Positional Score that lies within the next-to-bottom 10th percentile (i.e., scores of 0.11-0.20);
a BLUE Flag is awarded for each Intra-Positional Score that lies within the next-to-top 10th percentile (i.e., scores of 0.80-0.89); and
a GREEN Flag is awarded for each Intra-Positional Score that lies within the top 10th percentile (i.e., scores of 0.90-1.00).
   After the Flags have been assigned to the Holdings of the portfolio, Raw Flag Counts are then generated for each Holding. A Raw Flag Count identifies how many Flags of each color were assigned to the Holding. Raw Flag Counts can be arranged by a Total Raw Flag Count, a Class Raw Flag Count, a Perspective Raw Flag Count or an active Cell Raw Flag Count. The Total Raw Flag Count identifies (by color) all of the Flags that were assigned in regards to the 62 Filters (for that Holding), the Class Raw Flag Count identifies all of the Flags that were assigned in regards to the Filters that comprise the identified Class, the Perspective Raw Flag Count identifies all of the Flags that were assigned in regards to the Filters that comprise the identified Perspective, while the active Cell Raw Flag Count identifies all of the Flags that were assigned in regards to the Filters that comprise the identified active cell. FIG. 18 illustrates a portfolio-wide, Holding-by-Holding Raw Flag Count Table that has the three Class Raw Flag Counts, one for each Class, and a Total Raw Flag Count. The Raw Flag Counts are generated regardless of whether the underlying Filters were viable for all Holdings. The Flag Counts in FIG. 18 are ranked based upon the Holdings that have the least RED Flags.

Recognizing that not all Filters may be viable for each Holding and, thus a Holding's Raw Flag Count (either as a Total or by a Class or Perspective, etc.) could be skewed lower if a Holding has had several Filters that were not viable, OPERRA also generates a Weighted Flag Count that accounts for the situations when a Holding has some non-viable Filters. The Weight Flag Count is determined by:
[No. of Filters Used in Raw Flag Count/No. of these Filters that were Viable]×(Raw Flag Count)
Thus, if a Holding has a “Change” Class Raw Flag Count of 4 RED Flags, 2 ORANGE Flags, 1 BLUE Flag and zero GREEN Flags, and of the 20 Filters that comprise this Class, the Holding only had 10 Filters that were viable, then the “Change” Class Weighted Flag Count would be 8 RED Flags, 4 ORANGE Flags, 2 BLUE Flag and zero GREEN Flags.

OPERRA generates a Cell RED Flag Count Table for each Holding that identifies which of the 13 active cells contributed to the Holding's Total RED Flag Count (either Raw or Weighted). The Cell RED Flag Count Table is useful for identifying those Filters where the Holding was financially weak. Cells having a number of RED Flags that exceed a set threshold (e.g., 2) can be labeled as “High Count Cells,” which require further Drill Down analysis.

Since the RED, ORANGE, BLUE and GREEN Flag Counts are derived from of each Holdings unique intra-Filter Positional Scores, the Flag Counts awarded a given Holding, therefore, are a function of its relative strength or weakness in comparison to the Holdings that comprise the portfolio.

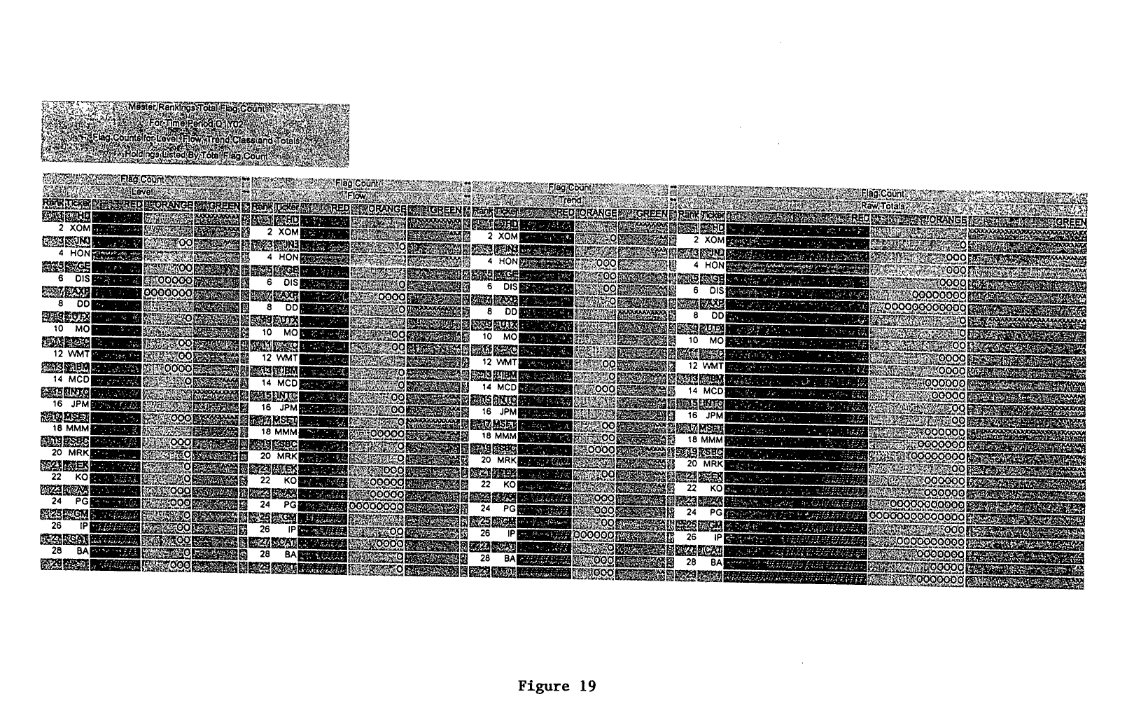

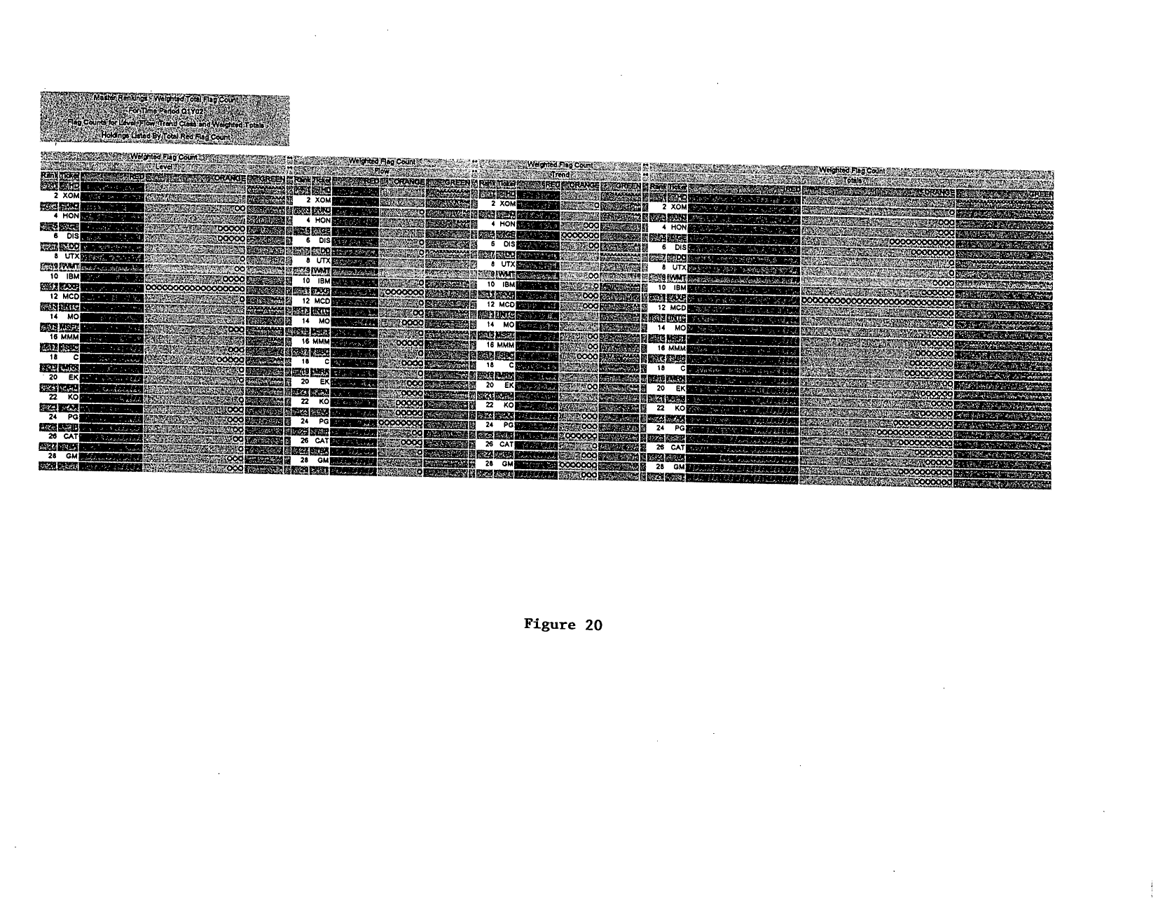

For a given portfolio, OPPERA generates a “Portfolio Flag Sheet” that lists the Holdings that have the highest 10% (in relation to the portfolio) of RED Flags, ORANGE Flags, BLUE Flags, and GREEN Flags (by each Flag). Thus, the Portfolio Flag Sheet lists all Holdings with the maximum number of extremely weak or strong Filters as reflected by the Intra-Filter Positional Scores. OPERRA also generates a Display that lists all of the Holdings and shows for each Holding by Holding Flag Count in Aggregate (all active Cells) as well as by Time Class, Perspective and Cell for all viable active Filters, as shown in FIG. 19 for a raw Flag Count, and in FIG. 20 for a weighted Flag Count.

Drill Down

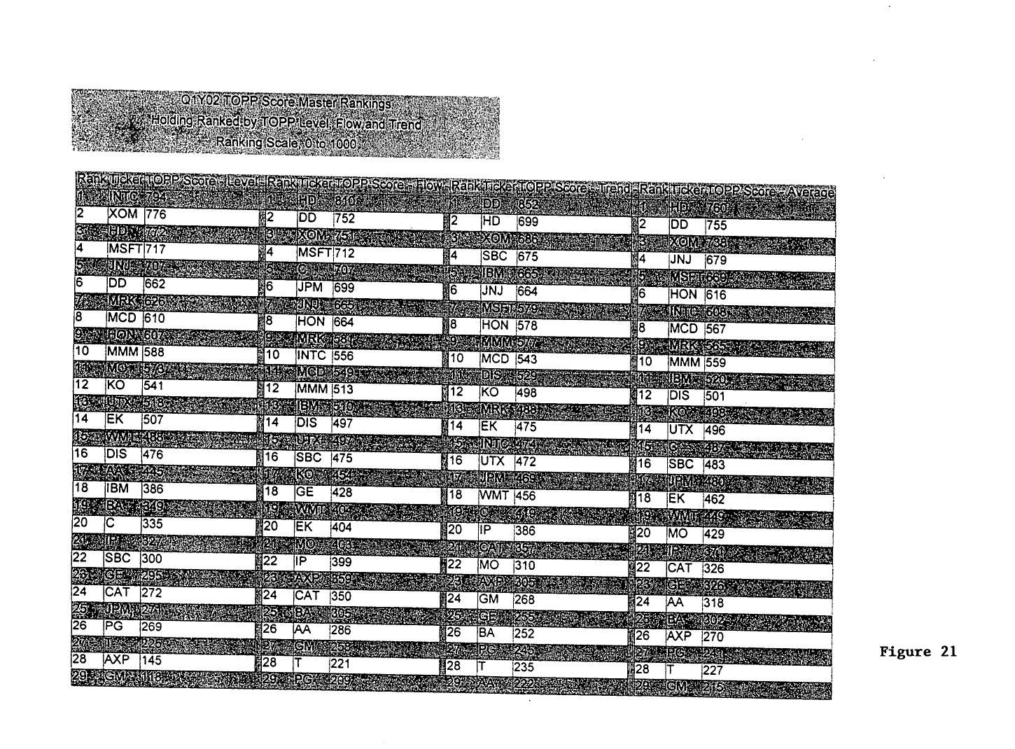

To assist the user in identifying, visualizing and understanding the root causes of a particular Holding's Fundamental Strength/Risk, OPPERA provides Drill-Down guides that can be used to drill down from the Overall FS Score or Overall FS Positional Score (these two types of scores are interchangeable for these purposes and, thus, the term “Overall FS Score” as used herein embraces both types of scores) down into the actual Filters. OPERRA initially presents the Holding's Overall FS Score to the user. This can be provided in a portfolio-wide Score Table, such as the one that is shown in FIG. 21 (in the example depicted in FIG. 21, the Overall FS Scores are based on 1-1000 scale). From this Score, a key-stroke-driven Drill-Down starts that allows the user to identify, visualize and understand the root causes of a particular Firm's fundamental strength or weakness. The Drill-Down process helps guide the user through sub-Scores to the display of specific Filters. The user may then see the both numerator and denominator of the Firm's filter ratio and that filter ratios ratio rank in comparison against the other firms of the portfolio (or even against firms that are not include in the portfolio).

The Drill Down process will now be discussed in greater detail. For the selected time interval, OPERRA automatically ranks the Holdings of the portfolio by both the Overall FS Score and by the RED Flag Count. From the Holdings having the lowest Scores and Counts, the user can Drill Down to visualize the Root Causes of the weak relative position of a Holdings via the following evaluation flow sequence:
Rank or Count>>Time Class>>Perspective>>Cell>>Filter>>Root Cause Display
The Root Cause Display graphically shows extreme trends, Outlier and /or pattern disruptions plaguing the firm. FIG. 17 shows, by Holding, how the Overall FS Score is “broken-out” by the Time Classes and by the Perspective within the Classes, i.e., the 13 active cells. The user can drill down into each of the 13 active cells to a cell display. The cell display shows the numerator and denominator scores for each Holding, the rankings of the Holdings, and the Intra-Filter Positional Scores for the Filters that reside in that cell. FIG. 8, for example, is a cell display for the cell of the Master Matrix that is defined by the “Level” Time Class and “Asset Quality” Perspective.

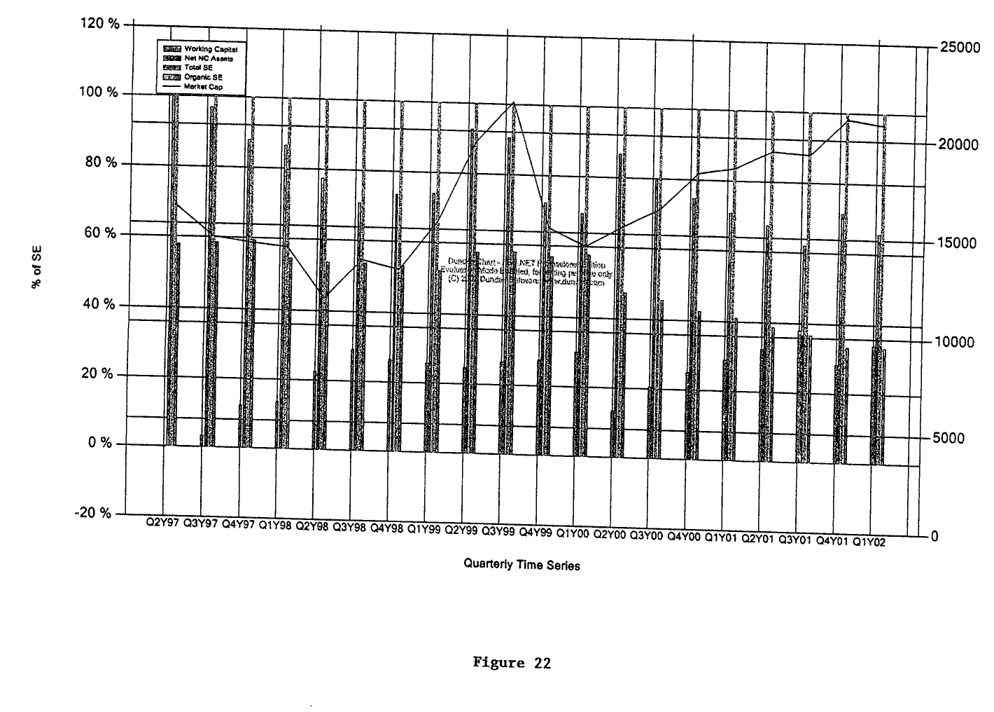

Based on each Filter position, the user can also select A, B C and/or O series Displays to show Root Cause, wherein:
A-Series Displays are by Holding across time showing levels and changes for Vectors and TSE Components. FIG. 22 illustrates an example of an A-Series Display.
B-Series Displays present Scatter Diagrams across Holdings and compare Vectors in dollar levels relative to TSE. FIG. 3 illustrates an example of an A-Series Display.
C-Series Displays present Scatter Diagrams across Holdings and compare Vectors in dollar levels relative to OSE.
O-Series Displays present Scatter Diagrams across Holdings and compare organic Pay Outs and Dividend stress. FIG. 6 illustrates an example of an O-Series Display.

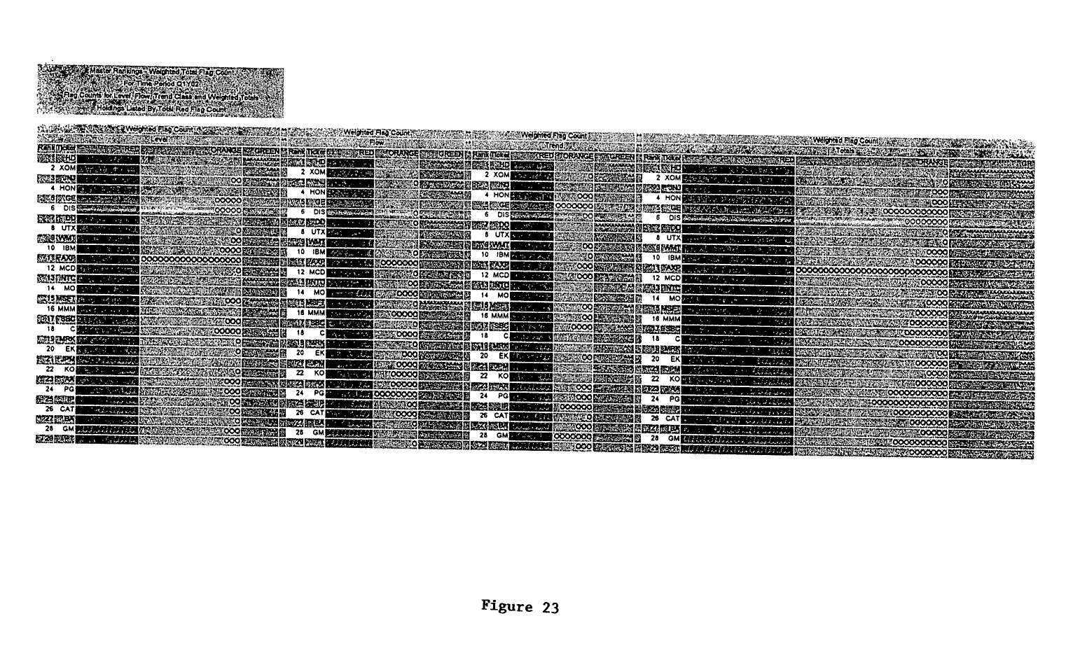

In additional to providing the portfolio-wide Score Table, OPERRA automatically ranks all Portfolio Holdings by total Red-flag Count and displays the results in Total Flag Raw Count Table (FIG. 18) and a Total Flag Weighted Count Table (FIG. 23). Starting with one of these Tables (Score or Flag Count), one can reverse the data layers and calculations to visualize the analytical process from which the Intra-Filter Positional Scores were derived. For example, this will enable the analyst to detect the root cause of a high Red-flag Count.

### EXAMPLES

GM Drill Down

As shown in FIG. 23, GM has a very high Count, ranked 28 of 29 portfolio Holdings, with a weighted REDS Flag Count of 28 (plus nine ORANGE Flags Count and only six GREEN Flags). As can be seen in FIG. 23, GM's 28 RED Flags are split as such: 16 for Level with four at-risk Cells and 12 for Flow with two at-risk Cells. For example, the first low-Count Cell is Level AQ which has two at-risk Filters: TSE/TA and OSE/TA. With respect to the first at-risk Filter, reference to FIG. 8 shows that GM's TSE ($19.6B) is only 6% of TA for an Intra-Filter Positional Score of 0.04 (4%). For example, the GM's second low-Count Cell is Level OSE with one at-risk Filter: OSE/(TL+USE). Reference to FIG. 12 shows that GM's OSE is minus 1% of TL+USE ($382.2B) for an Intra-Filter Positional Score of 0.04 (4%). For example, the GM's fifth low-Count Cell is Flow ECOP with three at-risk Filters: Cum. ECOP/Cum. RICO; Cum. ECOP/(TA-TSE) and Cum. ECOP/(TA-OSE). With respect to the first Filter, reference to FIG. 5 shows that GM's Cum. ECOP (identified as CORE) of $1.5B is only 11% of Cum. RICO (identified as RICCO) for an Intra-Filter Positional Score of 0.04 (04%).

IP Drill Down

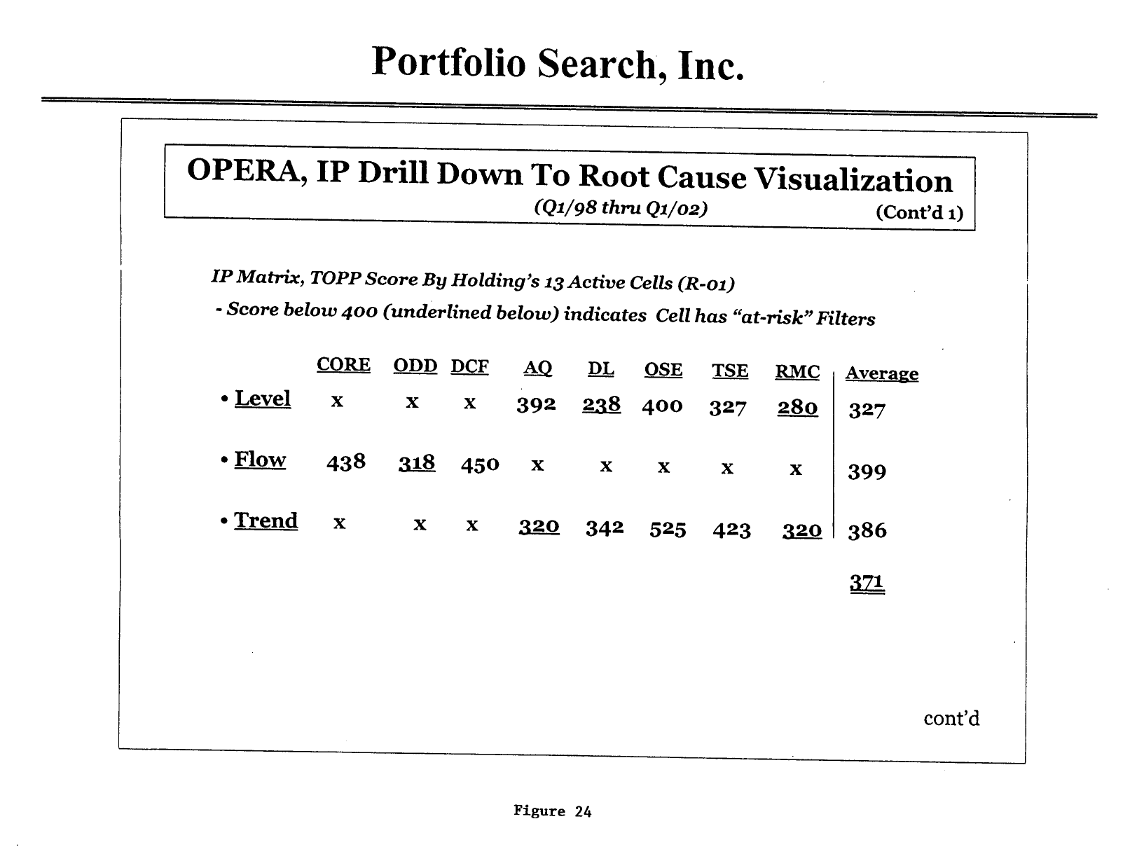

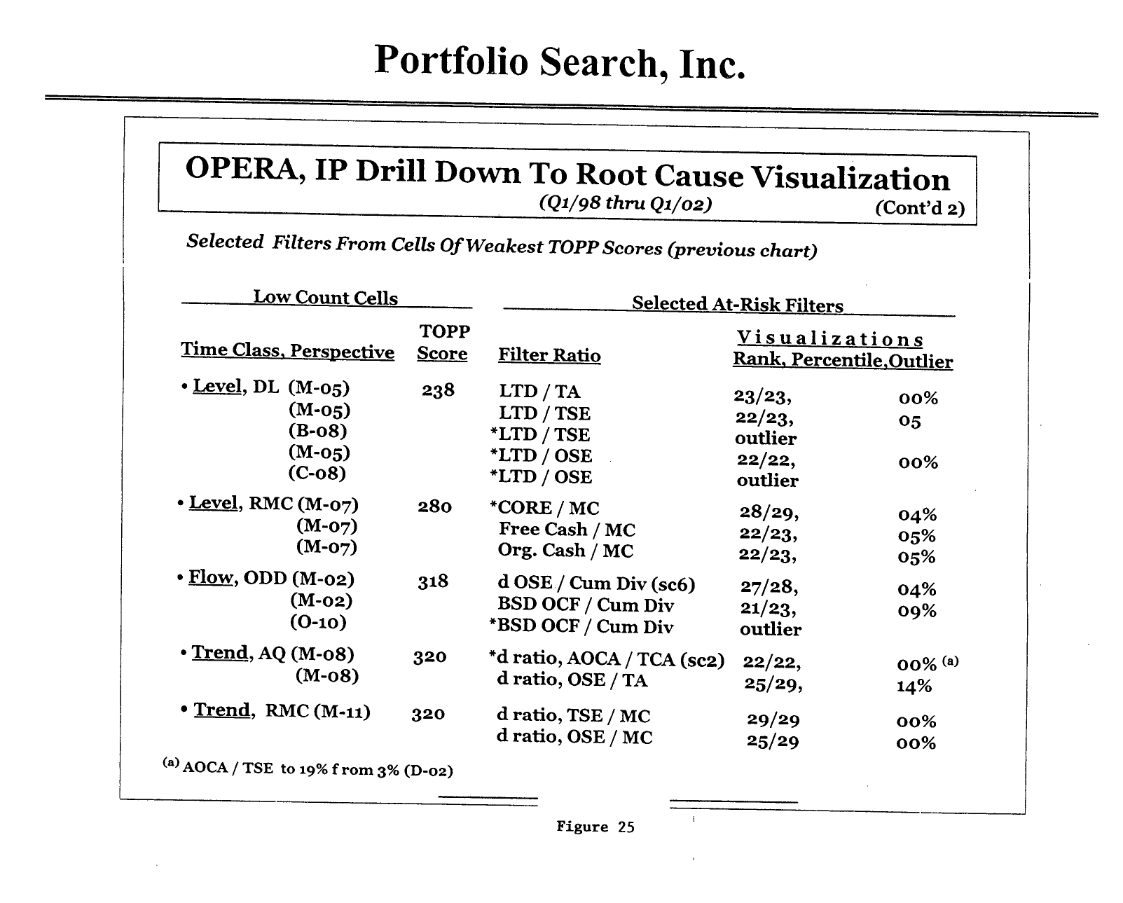

As shown in the fourth column of FIG. 21, IP's Overall FS Score (identified as TOPP) of 371 (out of 1000) ranked 21 of 29. OPERRA defines a Cell Score below 350 (or 35 when used on a 1-100 scale) as a “Low Score.” As can be seen in the IP Drill Down Chart in FIG. 24, IP had five “Low Scores” that constituted numerous At-Risk Filters, as shown in FIG. 25.

For example, the first low-Score Cell is Level Debt Load at 238 which has three at-risk Filters: LTD/TA, LTD/TSE, and LTD/OSE. With respect to the first at-risk Filter, reference to FIG. 10 shows that IP's LTD of $14.2B is minus 39% (expressing Vector LTD with a negative sign) of $36.9M in TA for a Intra-Filter Positional Score of 0.00 (0%). For example, as can be seen in FIG. 25, IP's fifth low-Score Cell is Trend RMC with a score of 320 and two at-risk Filters identified: d ratio, TSE/MC and d ratio, OSE/MC. Reference to FIG. 15 shows that IP has a 29/29 rank (last place) and 0.00 Intra-Filter Positional Score for both Filters, which clearly demonstrates an excessive valuation relative to other “Holdings” of the portion (in this case the Dow Industrial 30).

Once the Drill Down and Master Matrix have identified a particular Filter, a user (investor) with knowledge of financial statements can often infer from a Filter's numerator and/or denominator definitions which type of financial statement (P&L, Balance Sheet or Funs/Cash Flow) and the portion of that statement from which the numerator and/or denominator value is derived. With the name of the firm, time period and portion of the relevant financial statement known, the user can then quickly access the relevant area of the particular financial report (as issued or filed by the firm) in order to, for example, get a further break out of the line item in question or check for an associated footnote.

Visualization:

OPERRA generates three basic types of displays: Holding-specific, time series Bar Charts, Portfolio-wide, point-time-time Scatter Diagrams, and Numeric Tables. All three types are designed to render extreme trends, outlier positions and pattern disruptions visually obvious and eliminate the need to perform gather and perform calculations. The following are some examples of these.

FIG. 22 illustrates a Bar Chart that tracks, for IP, WC, Net Non-Current Assets, TSE, OSE and Market Cap quarterly from Q2/97 through Q1/02.

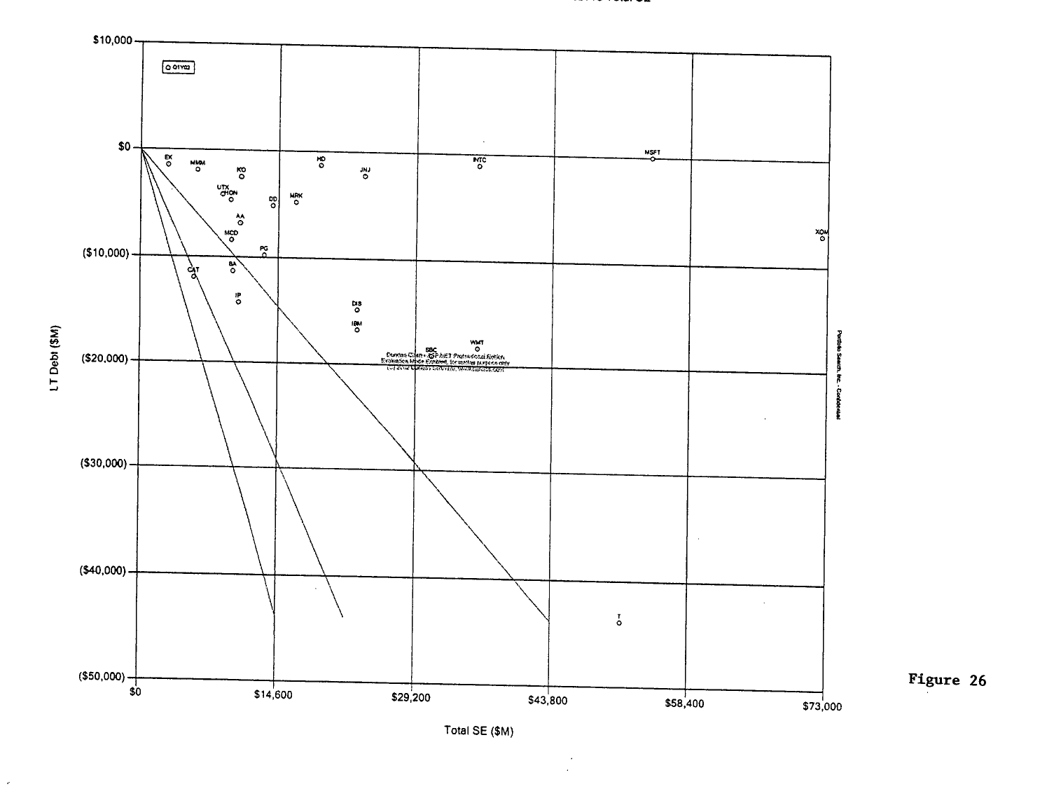

FIG. 26 is a Scatter Diagram that shows how the Holdings of a portfolio compare to each other when their “LTD” values (y-axis) is plotted against their “TSE” values. Outliers can clearly be seen in FIG. 26.

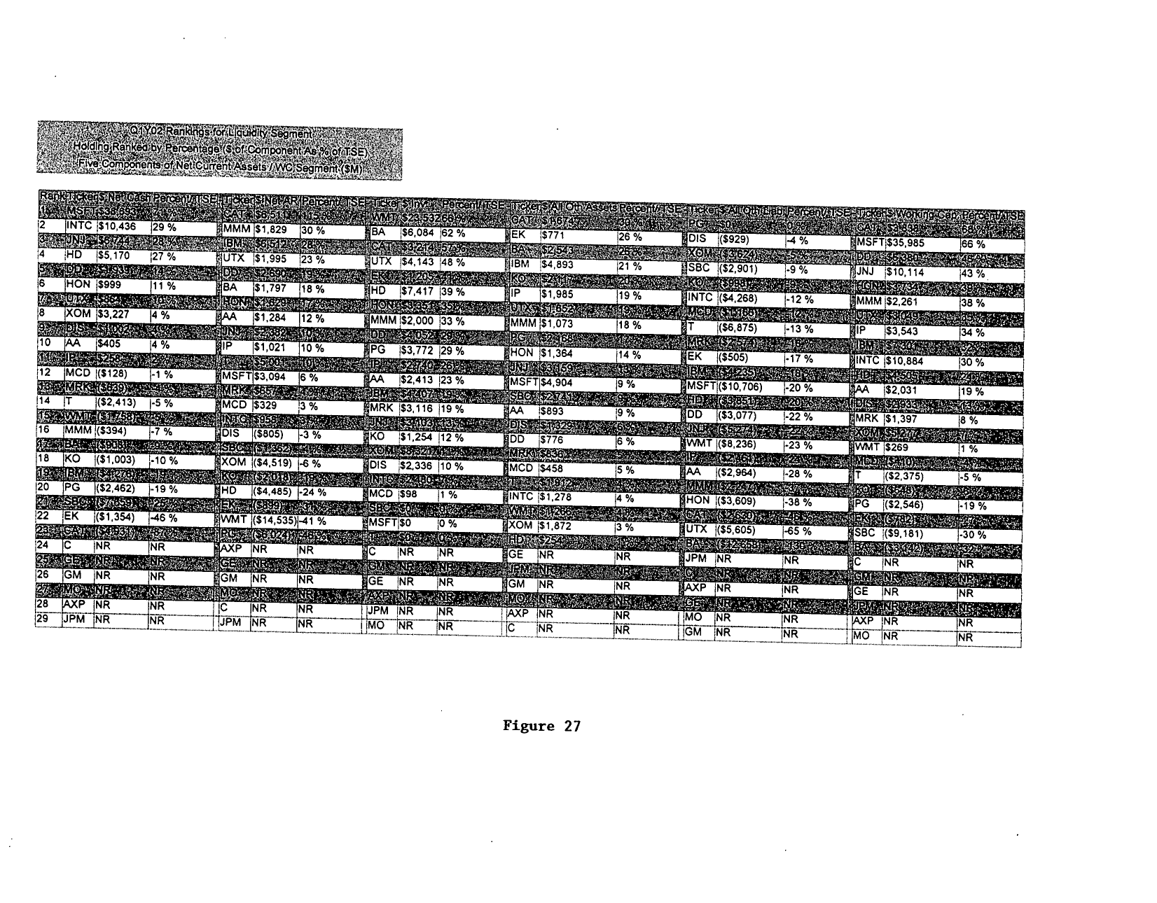

FIG. 27 is a Numeric Table that shows Holdings ranked by percent contribution of Current Vectors to TSE.

Visualization Via Bar Chart:

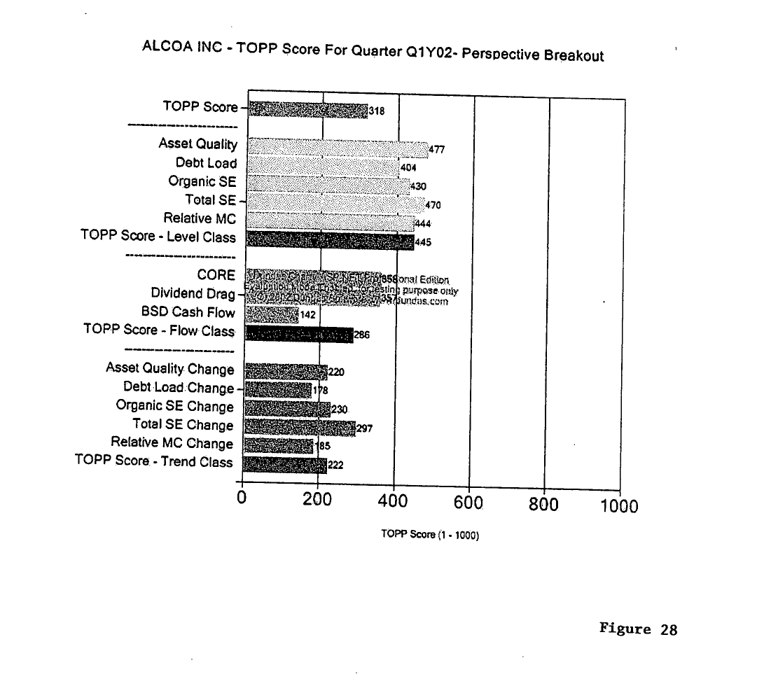

For each Holding, OPERRA generates a FS Score Bar Chart covering the selected time interval where the Bar Chart is arranged, from top to bottom, by the Overall FS Score, the Level FS Score, Flow FS Score and Change (Trend) FS Score. Within each Class section, are horizontal bars representing the Perspectives associated with the particular Class, as is shown in FIG. 28 for Alcoa (ticker AA). Across the bottom of each Chart is a 0 to 1000 vertical scale (or 0-100 scale) with designated increments of 100. Above this scale are color-coded, horizontal bars referenced above. The bars are vertical aligned on the left side of the Table. To the left of each bar is a label that identifies the corresponding Perspective. Each bar extends to the right in accordance with its “Perspective” FS Score (or FS Positional Score). Horizontal bars for the Overall FS Score and each of Class FS Scores are also provided. The FS Scores are indicated to the right of their corresponding bars. FIG. 28, thus, provides for rapid visualization of a Holding's FS Scores for each of the three Filter Classes and for the Perspectives FS Scores that are relevant to the particular Classes.

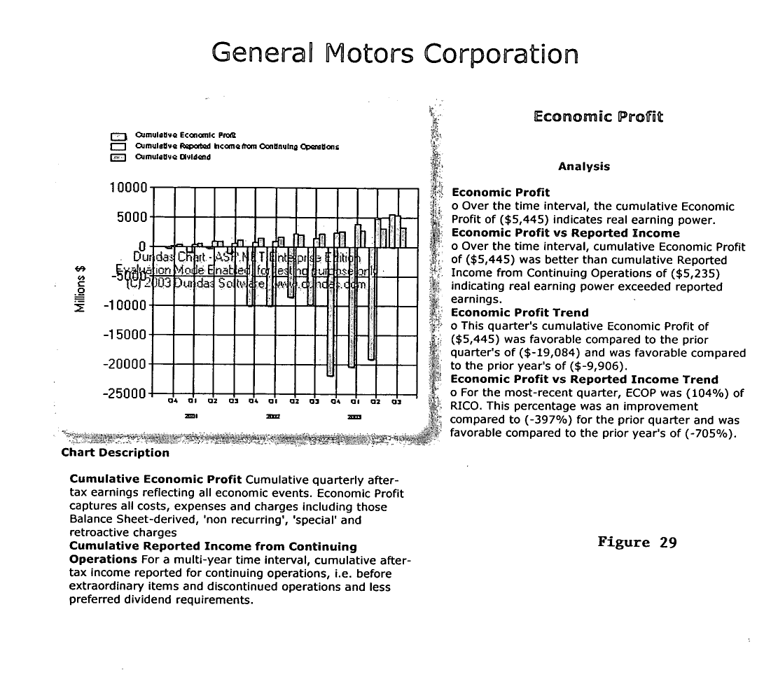

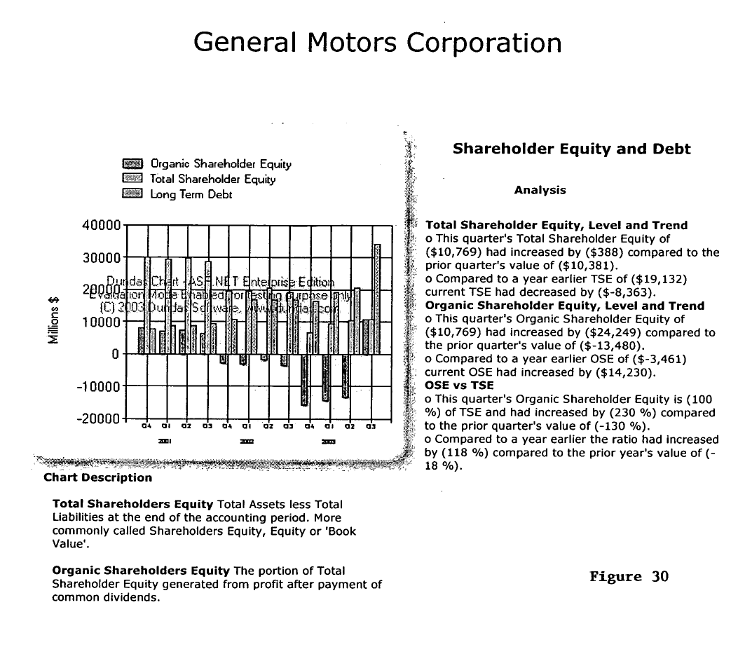

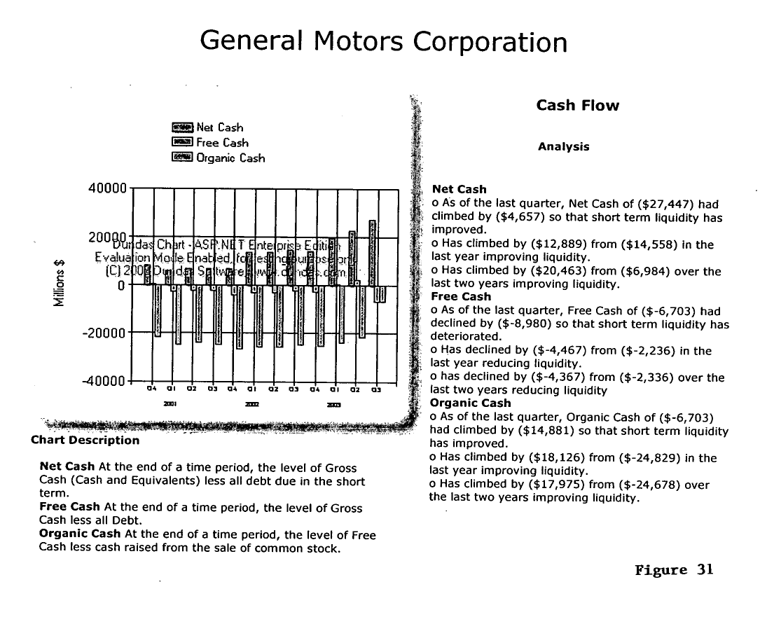

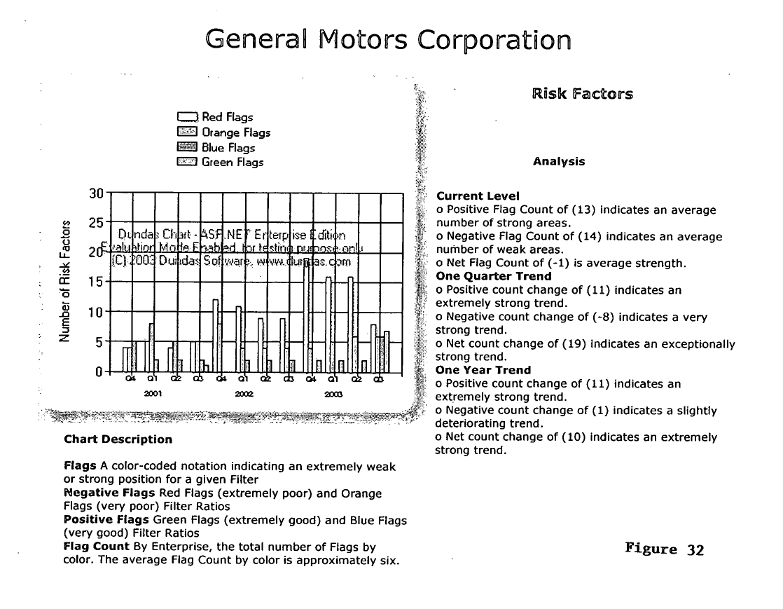

For each Holding, OPERRA can also generate Bar Charts that illustrate how certain financial metrics changed in relations to other financial metrics. FIGS. 29, 30, 31 and 32 are examples of these. FIG. 29 depicts an “Economic Profit” Bar Chart for GM that tracks Cum. ECOP, Cum RICO and cum. Dividends over an interval of time. An advantage of the financial metrics Bar Charts is that the relationship of the displayed financial metrics can be depicted over a time interval even if some of the Filters that utilize these financial metrics were not viable for the Holding (e.g., the financial metrics that is used in of the denominator of a Filter may have been negative). FIG. 30 depicts a “Shareholder Equity and Debt” Bar Chart for GM that tracks OSE, TSE and LTD over an interval of time. FIG. 31 depicts a “Cash Flow” Bar Chart for GM that tracks Net Cash, Free Cash and Organic Cash over an interval of time. FIG. 32 depicts a “Risk Factors” Bar Chart for GM that tracks the RED, ORANGE, BLUE and GREEN Flag Counts over an interval of time.

Financial Structure Across Holdings:

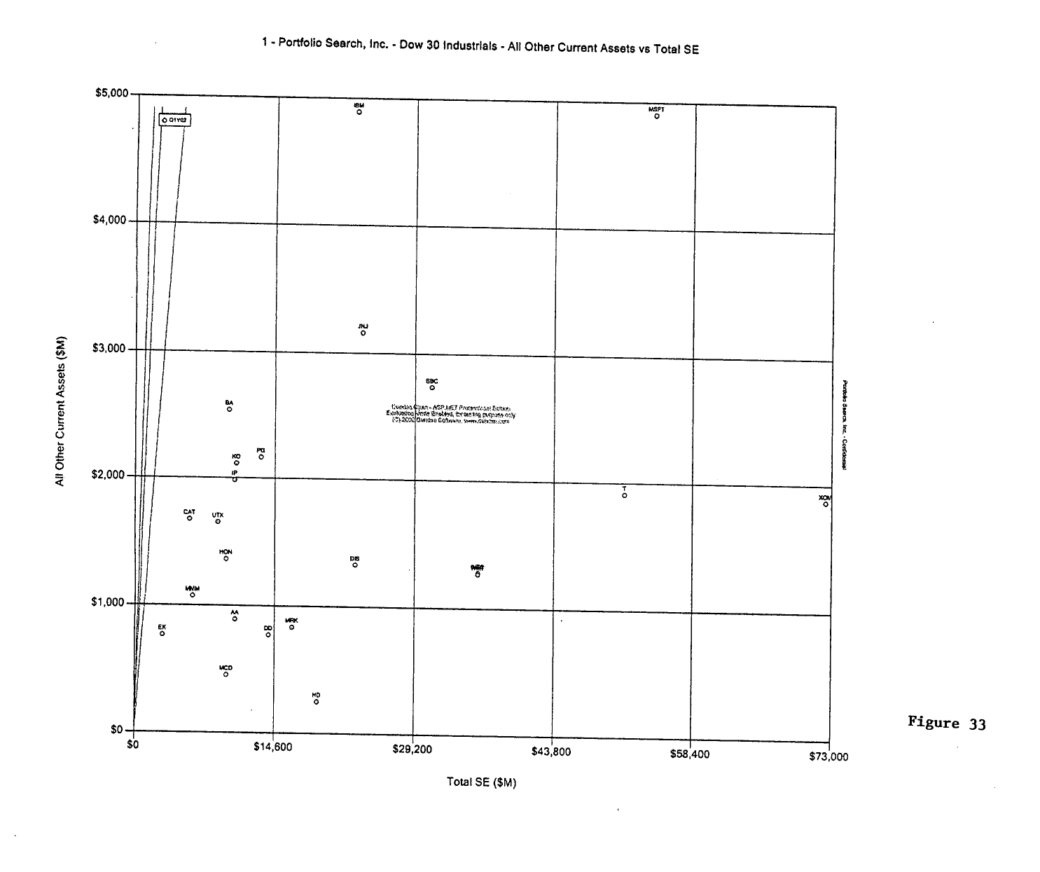

To compare financial structures across portfolio Holdings at a given point in time, OPERRA generates a Scatter Diagram for each Vector. Each Diagram has many coordinate points, each point representing one Holding. For each coordinate point, the value (level) of the particular Vector is read off the y-axis and that of TSE (or OSE) off the x-axis, as shown in FIG. 33. If the two axes were extended to their zero value, they would intersect so that each Diagram would have four quadrants. Within a quadrant, each Diagram has three straight lines that slope at different angles such that they intersect (or would intersect, if extended) at the Diagram's zero coordinate point.

For Asset Vectors, the lowest line, the middle line and the upper-most lines are the loci of Vector amounts which are 100%, 200% and 300% of TSE (or OSE), respectively. For Liability Vectors, the highest line, the middle line and the lower-most lines are the loci of Vector amounts that are 100%, 200% and 300% of TSE, respectively. The vertical distance between any two sloped lines is linear to these TSE-related percentages. For example, the user may enter the Scatter Diagram for the Net AR Vector to examine “CAT” (the ticker symbol for the Caterpillar, Inc.) for 1999. Under the words “Exclude Checked Years,” the user would click all white boxes except the one marked “1999” and view the position of the coordinate point labeled CAT. For example, the position of the CAT x-axis coordinate point could makes it visually obvious that CAT's TSE is slightly less than $5,400M, that CAT's Net AR about $5,500M and that its coordinate point is above the bottom slopping line representing 100% of TSE. Hence, without referencing any financial data or performing any calculations, the investor can visualize CAT's:
Net AR and TSE absolute dollar levels,
Net AR percentage contribution to TSE,
Net AR dollar level contribution to TSE as compared with the other portfolio Holdings,
   and
Net AR percent contribution to TSE as compared with the other portfolio Holdings.
   OPERRA defines “outliers” as extreme levels and/or positions for a Holding's particular financial variable relative variable positions of the majority of Holdings. OPERRA displays are designed to render outliers visually obvious.
   TSE Expansion/Compression (“TSE-E/C”) Factor:

For each and every Holding at any end-of-quarter point in time, OPERRA Scatter Diagrams allow the visualization of any Vector as a percent of that Holding's TSE. This percentage expressed as an integer is, by definition, the TSE-E/C Factor for the given Holding, Vector and time slice. For any assumed percentage increase in the value of a given Vector, dividing the TSE-E/C Factor into that assumed percentage shows the percent increase in the value of TSE that would be induced. Conversely, for any assumed percentage impairment in the value of a given Vector, dividing the TSE-E/C Factor into that assumed percentage shows the percent compression to the value of TSE that would be induced.

For example, assume the Scatter Diagram for the NBV PP&E Vector shows Holding A's PP&E is 300% of its TSE (as read off the Diagram's upper-most slopping straight line) so the TSE-E/C Factor is 3.0. Thus, an assumed or expected impairment charge that reduce NBV PP&E by 10% would reduce TSE by 30% (10.0% ×3.0).

For example, assume the Scatter Diagram for the Net AR Vector showing Holding A's Net AR is roughly 350% of its TSE as interpolated from its coordinate point's vertical between the middle and upper-most slopping straight line. Thus, the TSE-E/C Factor is 3.5 so that an assumed or expected write-off of 5% of Net AR would reduce TSE by 17.5% (5.0% ×3.5).

Vector Wipeout Percentage For TSE (“TSE W/O Percent”):

For a given Vector, the reciprocal of TSE-E/C Factor is the TSE W/O Percentage; this percentage shows the percent impairment for a given Vector that would reduce a given Holding's TSE to zero. For example, assume a Scatter Diagram enables one to visualize that Holding A's NBV PP&E Vector is about 300% of TSE for a TSE-E/C Factor of 3.0. Thus, the TSE W/O Percent for this Vector is 33% (1 divided by 3) and a 33% reduction in Holding A's NBV PP&E would reduce its TSE to zero. Also, for example, assume a Scatter Diagram enables one to visualize that Holding A's Net AR Vector is about 200% of TSE so its TSE-E/C Factor is 2.0. Thus, the TSE W/O Percentage for this Vector is 50% (1 divided by 2.0) so that a 50% reduction in the value of Holding A's Net Receivables would reduce its TSE to zero. Importantly, the user instantaneously sees the percentage reduction in Vector that would wipe out TSE for any Holding without performing any calculations.

Evaluation Flow In General:

With OPERRA, the user controls a portfolio-wide Evaluation Flow that has three phases:
I—Data on each Holding through Master Matrix to generate ranking by Maximum Total RED Flag Count (either Raw or Weighted) and by Minimum Overall FS Score (or Overall FS Positional Score);
II—From Holdings with Max Red Flag Count, Drill Down to High Count Cells, At-Risk Filters And Root Cause Displays; and
III—From Holdings with Min Overall FS Score (or Overall FS Positional Score), Drill Down to cells that have Low Cell Scores, At-Risk Filters and Root Cause displays.

The first step (after the financial information for the Holdings of the portfolio have been loaded into OPERRA) is to review the Numeric Table displaying Holdings ranked by weighted RED Flag Count as shown in FIG. 23. Another Display lists the 10% of Holdings with the max number of RED Flags. FIG. 23 also displays Holdings ranked by weighted RED Flag Counts as group by the three different Time Classes. For any Time Class with a weighted RED Flag Count above six, for example, OPPERA can identify those Cells with RED Flags and directs the user (via links) to the appropriate ranked Positional Scores by Class, Perspective and Filter Charts, e.g., FIGS. 7-15, and the ranked weighted RED Flag Count by Total and Time Classes, e.g., FIG. 20, to identify a Holding's At-Risk Filters (defined as those with a Intra-Filter Positional Scores of 15% or less). Reference to the Tables that house the At-Risk Filters allows the user to visualize extreme trends, outlier positions and patterns disruptions as well as the ranks and Intra-Filter Positional Scores that are responsible for the Holding's high RED Flag Count.

Evaluation Flow:

Portfolio-wide Overall FS Score Drill Down And Visualization

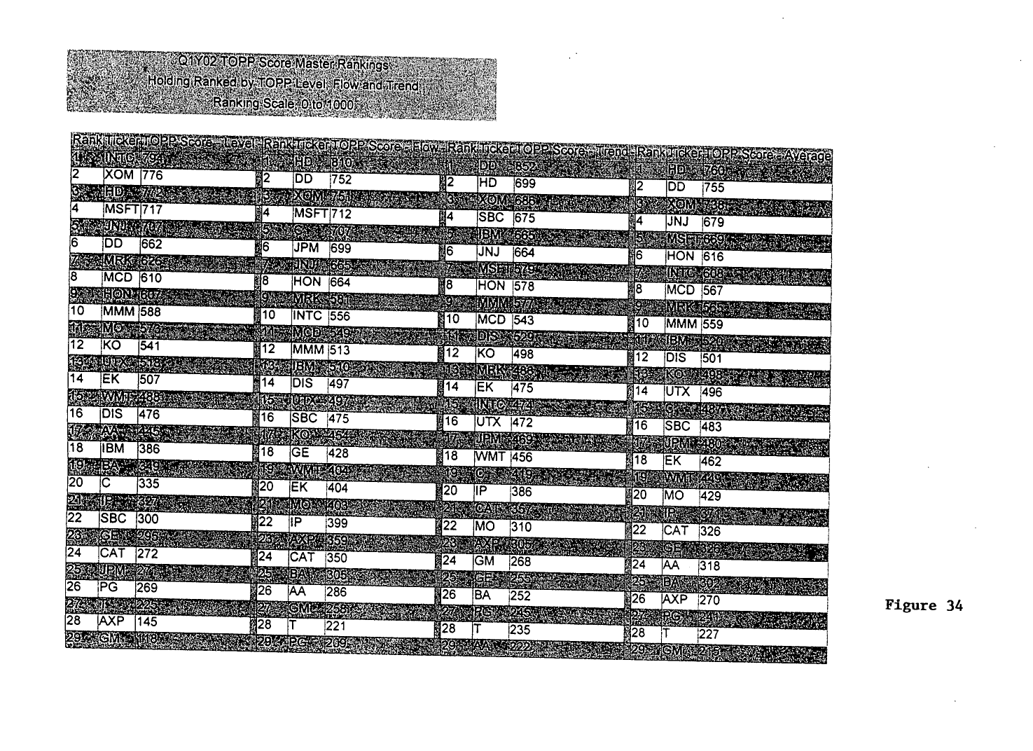

It is possible that a Holding not on the RED Flag Sheet may be At-Risk. Despite the absence of an exceptionally high weighted RED Flag Count, a Holding's overall Performance/Position could be weak with several cells having low Cell FS Positional Scores. Accordingly, OPERRA does a portfolio-wide Overall FS Score Drill Down by generating a Table that shows (1) the Holdings ranked by FS Score By Time Class (Level, Flow and Change) and (2) the Holdings ranked by Overall FS Score, as shown in FIG. 34. OPERRA also generates a “Portfolio Overall FS Score Sheet” that lists those Holdings that are in the bottom 10% of the portfolio as measured by Overall FS Score.

OPPERA identifies (underline, thereby signifying that a Drill Down link is provided) any Time Class FS Score that has a weighted Score under 400 (on a scale of 1000), and the user can then Drill Down to the appropriate Intra-Filter Positional Score Numeric Table Displays such as those shown in FIGS. 7-15 to identify the at-risk Filters (which are generally defined as those Filters that have a Intra-Filter Positional Score of 15% or less). To visualize (analyze), the Root Cause that put the Holding At-Risk, the user is directed to the appropriate display as previously discussed.

Modularity:

By providing a system that utilizes positional-based scoring contributions that are aggregated from independent Filters, the OPERRA architecture is modular down to each and every individual Filter of the system. The fully-modular aspect of the OPPERA Filters provides the user with a tremendous amount of flexibility in tailoring the level and nature of the OPERRA analysis. Different Filters, for example, may be added or eliminated as desired. Thus, while the embodiments described herein include 62 Filters, the user is able to chose any sub-set of these Filters to be utilized in their analysis or, alternatively, can also request that additional Filters (beyond the 62 discussed herein) be utilized. The OPERRA methodology, therefore, can be used with any number of Filters. OPERRA, for example, can run an evaluation using only those Filters that are contained with the Dividend Strength Perspective if an investor wanted to expunge his portfolio of Firms with minimum Dividend Strength FS Scores. In this case, OPERRA would run an analysis based upon the 10 Filters that reside in the Dividend Strength Perspective and generate the appropriate intra-Filter Positional Scores and the aggregate Dividend Strength FS Score (there would be no separate cell FS Scores in this example since all ten Filters reside in the same cell).

The modular aspect of the OPERRA methodology also allows one or more of the Filters to be independently modified. Thus, a Filter's numerator or denominator can be altered or replaced to fit the particular desires of the user.

OPERRA, moreover, can be applied to a wide variety of time intervals, such as quarterly, semi-annually, annually or multi-years periods, for example. European firms, for instance, only issue financial statements every six months. When analyzing European firms, OPERRA therefore can treat the single reporting period to be six months and can analyzing the firms of a portfolio for a single reporting period and against a time interval that extends over several reporting periods (e.g., years). Thus, the universe of firms that can be evaluated include firms with time intervals (for reporting financial results) of different lengths. The user, for example, simply identifies the time period approach (quarterly or semi-annually) that is to be utilized for a given portfolio evaluation (the evaluation itself will generally comprise several of these time) periods).

In short, the modular aspect of the OPERRA architecture means that changes the durations of the time intervals and in Filter count, definitions and/or weightings,—criteria and aspects that may be important to a particular user—are easily implemented in the OPERRA system sand methodology. This flexibility does not violate OPERRA's basic logic flow, scoring methodologies or Drill-Down processes.

One-off Methodology

For OPERRA to evaluate and rank a very large portfolio, such as the 500 Enterprises (i.e., firms) in the S&P 500 index, requires a very large number of calculations. To provide an on-demand service to subscribers desiring a Risk Ranking of a single Enterprise could require designating a portfolio (against which Risk is to measured) and a very high-performance computer system and very rapid data transfer rates. As previously discussed, many commercially-available databases are updated daily with line item figures from the P&L, Funds Flow (or Cash Flow) and Balance Sheet Statements that are contained in 10Q and 10K SEC filings made by public firms. This financial data for the universe of Enterprises is keyed into the vendor's database for electronic distribution to subscribers that form the vendor's customer base. The vendor's raw financial data, electronically distributed for its universe of public firms, may cover more than 10,000 Enterprises (which may also include non-U.S. Enterprises). From this universe of Enterprises, any one or more non-index Enterprises would be selected by the subscriber to be Risk-evaluated by OPERRA on “one-off’ basis. OPERRA performs the one-off evaluation against a pre-selected portfolio such as Enterprises comprising the S&P 500 index, Enterprises grouped by various standard industry or sub-industry classifications, etc. This contrasts with a “custom portfolio” evaluation. In the latter case, a subscriber requests an entire set of Enterprises—a portfolio for which the user has designated all the holdings—be evaluated against each other.

For the one-off evaluation, the subscriber keys in only the ticker symbols for the one or more selected Enterprises where each is to be evaluated on a individual basis against a specific index portfolio (i.e., a benchmark portfolio). This “index” or “background” portfolio serves as the fundamental strength standard for one-off evaluations. For each one-off evaluation of a subscriber-selected Enterprise, the OPERRA financial logic and structure eliminates the need to run a separate portfolio evaluation to generate Rankings for the selected Enterprise. For example, OPERRA can evaluate non-S&P Enterprise “ABC” by determining ABC's Intra-Filter Positional Scores (for each of the 62 Filters) and FS Positional Scores in isolation, i.e., without the need to run intra-Filter Positional Scores and FS positional Scores for a new portfolio comprised of both the 500 Enterprises and the one non-500 Enterprise. Thus, in this example, the subscriber to an on-demand OPERRA evaluation service keys in the ticker symbol ”ABC” and OPERRA immediately displays Intra-Filter Positional Scores and FS Positional Scores (or FS Scores) for this Enterprise. ABC's Intra-Filter Positional Scores and FS Positional Scores (including Overall, Classes, Perspective and Cells) are calculated against all the Enterprises comprising the S&P 500 index although the full rankings/scores for each of the Enterprises comprising the index portfolio need not be displayed.

OPERRA On-Demand Service With Pre-Calculating:

Well before a given trading day opens (e.g., the night before), OPERRA electronically acquires raw financial data from an aforementioned commercial database and, in batch mode, “pre-calculates” Filter values, rankings, Intra-Filter Positional Scores, FS Positional Scores and Counts as follows:
(1) The latest Filter values, rankings, Intra-Filter Positional Scores, FS Positional Scores for each and every Enterprise comprising the index portfolio, i.e., background portfolio (such as a selected index or industry portfolio, such as the S&P 500,a GICS classification or other standardized group of enterprises), are determined.
(2) The filter ratios values for each and every one of the many-thousand non-index portfolio Enterprises in the given commercial database.
(3) The rankings (for each Filter) for each and every non-index portfolio Enterprise with each Enterprise run individually against the index portfolio, i.e. each non-index portfolio Enterprise is individually compared against the index portfolio Enterprises without rerunning the index portfolio (or any portfolio) each time a one-off Enterprise is evaluated.
   OPERRA “Slotting” Allows For Extrapolating Rankings For One-Off Evaluations:

For the selected non-index portfolio Enterprise “ABC”, OPERRA calculates ABC's filter ratio values for each of the Filters. Importantly, OPERRA then “slots” ABC's filter ratio values against the corresponding filter ratio values of the index portfolio Enterprises. For example, assume OPERRA calculated ABC's “Net Cash/TSE” filter ratio value to be 1.00, and assume that the pre-calculations on the S&P 500 index portfolio showed that:
The value of the “Net Cash/TSE” Filter closest to but higher than 1.00 was 1.10 (for Enterprise XYZ, part of the S&P 500) and Enterprise XYZ's Positional Score for this Filter was 59.2;
The value of the “Net Cash/TSE” Filter closest to but lower than 1.00 is 0.90 (for Enterprise EFG, part of the S&P 500) and EFG's Positional Score for this Filter was 57.2.
   OPERRA analyzes the relationship (distance) between ABC's filter ratio value (1.00) and these upper (1.10) and lower (0.90) data points to interpolate ABC's Positional Score for the “Net Cash/TSE” Filter. Based upon these numbers, ABC's “Net Cash/TSE” Positional Score, therefore, is 58.2.

Thus, the slotting process simply places the value calculated for a given “ABC” Filter between the next-highest and next-lowest Filter value within the index portfolio (for which Filter Ratios and Rankings as been pre-calculated). Since each of the next-highest and next-lowest Filter values have known Positional Scores, the Positional Score of this “ABC” Filter (relative to the index portfolio) can be interpolated virtually instantly with very high accuracy. ABC's Intra-Filter Positional Scores for the other 61 Filters are determined in the same manner.

From the interpolated Intra-Filter Positional Scores, ABC's Overall FS Positional Score, Class FS Positional Scores, Perspective FS Positional Scores, Cell FS Positional Scores and Flag Counts, which are relative to the index, are rapidly derived with very high accuracy without the need to run an addition portfolio evaluation (beyond that originally done for the index portfolio).

Thus, the systems and methods described herein do not require that OPERRA run a separate portfolio Risk evaluation for each one-off Enterprise analysis.

Database Initialization

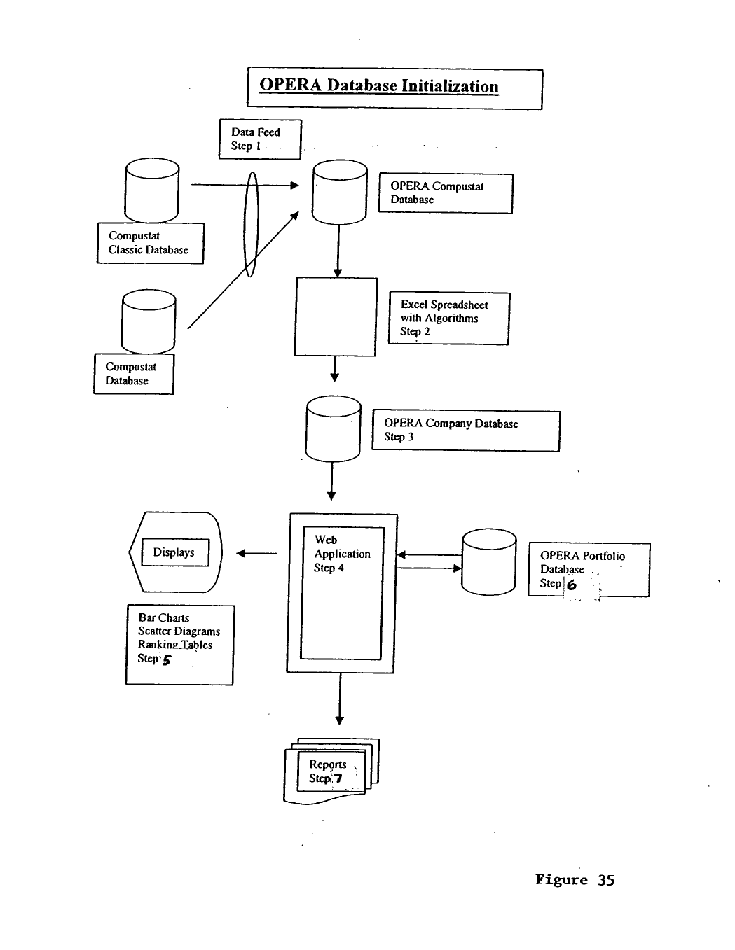

In one embodiment, OPERRA obtains “raw” financial information pertaining the Holdings of a portfolio (the number and nature of the Holdings are unlimited) from a commercially-available database. OPERRA defines a data feed that extracts a specified subset of data from the database and feeds this subset data to the OPERRA Compustat (relational) Database as shown in Step 1 of FIG. 35. OPERRA accesses this Database and loads it into an OPERRA Microsoft Excel Application that contains a proprietary OPERRA format and proprietary algorithms, as shown in Step 2 of FIG. 35. This application (format) environment allows OPERRA to perform many thousands of calculations to derive proprietary organic metrics such as Cum. ECOP, OSE and certain Vectors, for example. Both standard and unique data types generated from the OPERRA Excel Application are, then, loaded into the OPERRA Company Database which consists of a class of data tables that are company centric, shown in Step 3 of FIG. 35. The tables contain each Holding's financial track across a time interval. The OPERRA Company Database is the starting point for the OPERRA portfolio-based analysis. As new reporting data becomes available, this data is downloaded, run through the OPERRA Excel Application and, then, added to the OPERRA Company Database. An OPERRA web application performs calculations (step 4) on a subset of information contained in the OPERRA Company Database to derive filter ratios, rankings and other measures in order to rapidly generate web displays, including CDTs, step 5. These calculations and displays are unique to the OPERRA application. All calculations, charts, graphs and rankings are unit-Holding-based, meaning that they are unweighted by the number of shares a portfolio owns with respect to any Holding.

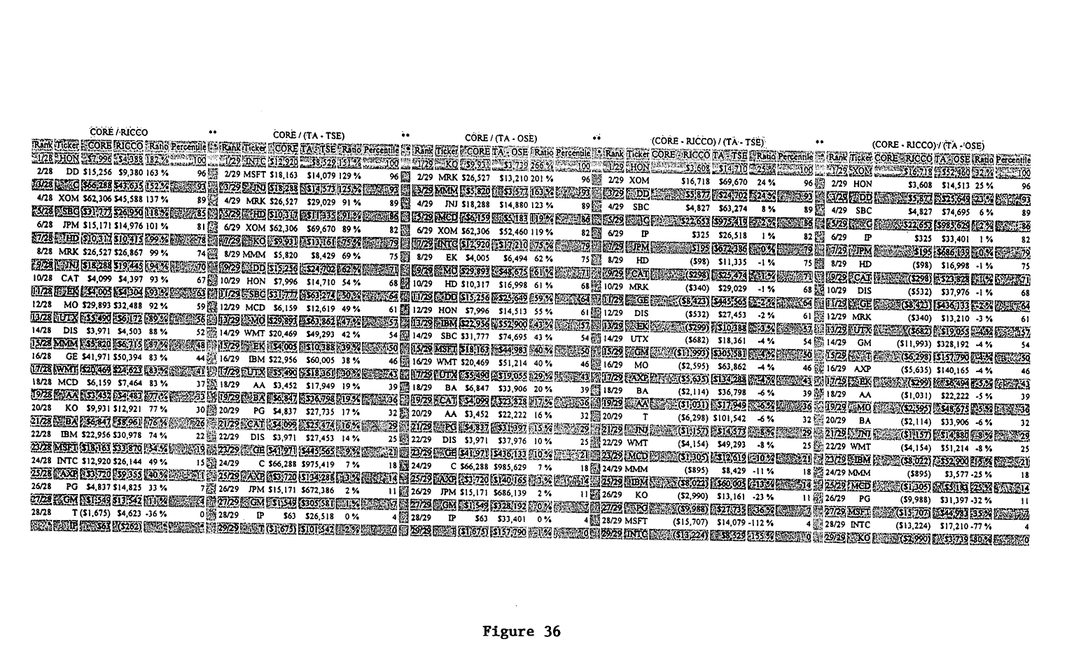

Many of the OPERRA measures are portfolio (as opposed to company) based. This means that a) the exact value assigned any Holding will depend on its financial performance/position relative to all other Holdings comprising the particular portfolio being evaluated. Hence, with a change in number of Holdings and/or particular firms comprising a portfolio, the rankings values assigned all Holdings are in the underlying change base data. A subset of information generated by the OPERRA web application is stored in the OPERRA Portfolio Database, step 6 of FIG. 35. OPERRA portfolio-based ratios, rankings and other measures are stored in this subset and a time stamp is attached. This allows the rapid generation of another class of web displays (step 5) and reports (step 7) that includes Scatter Diagrams and Ranking Tables. This class of display is portfolio-based in that each display shows the financials performance/position of all portfolio Holdings for a given point in time and/or a given time interval. Storing the display-class information in the Archival Database allows for “portfolio to portfolio” and for “portfolio across time” comparisons. The OPERRA Web Application also performs portfolio maintenance functions such as updating portfolio Holdings, customer information, user information and access privileges. For a specific quarterly time period or interval, OPERRA automatically (no key stroking) calculates Filter values and Positional Scores for portfolio Holdings and stores the results in the OPERRA Archive Database with a time stamp (part of step 6). An example of a portfolio-wide ranking for the ECOP Filters is shown in FIG. 36. The stored (time-stamped) data is displayed, by Holding, in the active cells of OPERRA Master Matrix.

Special Metric: Ranking Holdings By “Required Cum. ECOP Percent Growth”

For a future portfolio-wide time interval, OPERRA calculates, by Holding, the Required Cum. ECOP Percent Growth to justify a portfolio-wide Target Total Percent Return (“Target TPR”). Target TPR is defined as the combined return (to the investor) from Market Cap appreciation plus future Dividends. Target TPR is expressed as a total percent return over an entire future time interval (not as an annualized rate of return). Required Cum. ECOP Percent Growth is the percent premium (or discount) of future Cum. ECOP over the actual Cum. ECOP that each Holding must generate over (a portfolio-wide future) time interval of the same duration as the past portfolio-wide interval for actual Cum. ECOP.

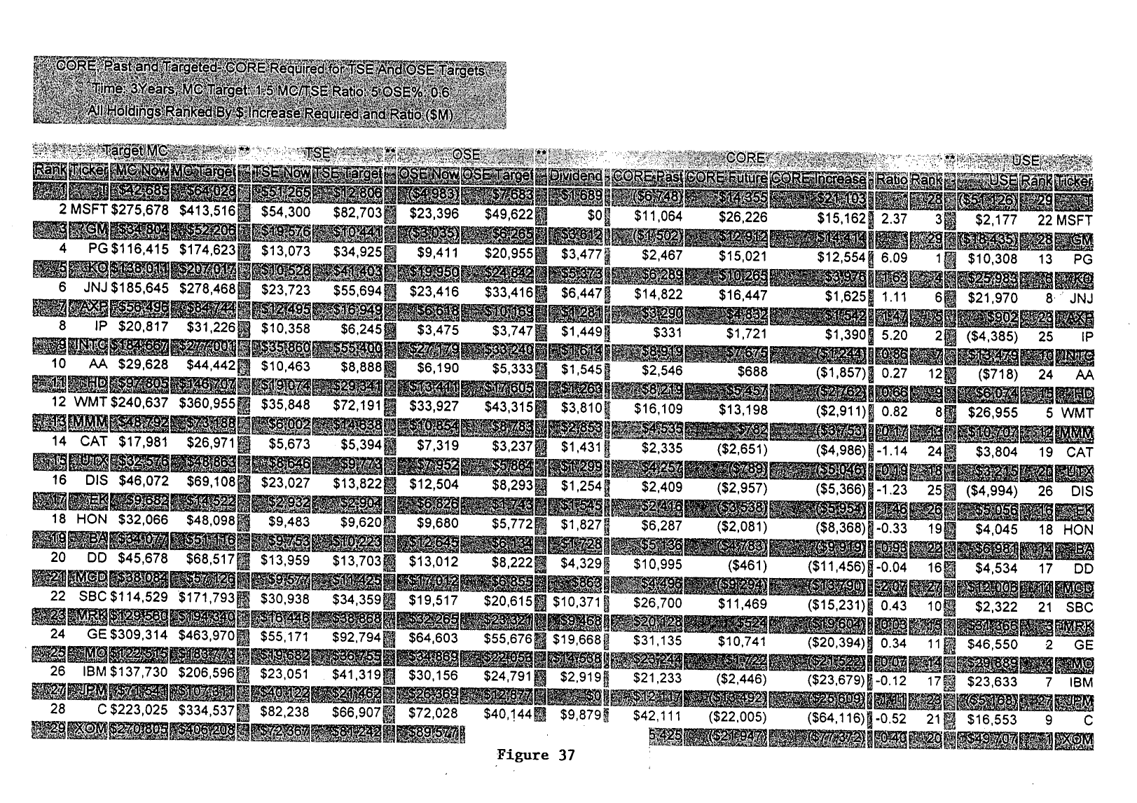

An Implicit Market Capitalization (IMC) rate is that which discounts a past level of flow extended to perpetuity to the Holding's Market Cap that is prevailing at the end of the last time that is being evaluated. To initiate the Target TPR analysis, the user specifies a portfolio-wide IMC ratio (for TSE) expected to prevail at the end of the future time interval. For all portfolio Holdings, OPERRA incorporates, calculates or assumes:
(a) Portfolio-wide Target TPR of 30%—unless overridden by the user.
(b) Past and future time frame of 30 months—unless overridden by the user.
(c) Past interval ended at the start of the future interval (“time zero”).
(d) Each Holdings future Dividend payments are annualized at the Holding's level which prevailed for the last four quarters of the past time interval—unless overridden by the user
(e) At the end of the future time interval, OSE is 50% of TSE—unless overridden by the user.
(f) Over the future time interval, no issuance or repurchase of common shares.
   OPERRA ranks and positions each Holding by Required Cum. ECOP Growth needed to support the Target TPR as shown in FIG. 37 (future Dividends are excluded for the Target TPR in this example).

To derive Required Cum. ECOP Percent Growth, OPERRA calculates the following (on all Holdings):
ECOP for the past time interval.
Target Market Cap, multiplies time-zero Market Cap by 1.0+Target TPR and, from this product, subtracts future Dividends.
Target TSE, divides target Market Cap by the user-projected, end-of-interval IMC Rate.
Target OSE, multiplies target TSE by 50%.
Required dollar level change in OSE (over the future interval), subtracts time-zero OSE from target OSE.
Required Dollar Cum. ECOP, adds future Dividend payments to required dollar-level change in OSE.
Required Cum. ECOP Percent Growth (for Target TPR), divides Required Dollar Cum. ECOP by Past Dollar Cum. ECOP.
   OPERRA, then, generates a “Required Cum. ECOP Percent Growth” Numeric Table wherein all Holdings are ranked as to: (1) Largest negative percentage (highest rank) through largest positive percentage (lowest rank)—From this ranking, each Holding is assigned its Positional Score; and, (2) OSE as percent of TSE at end future time interval.

Although various embodiments that incorporate the teachings of the present invention have been shown and described in detail herein, those skilled in the art can readily devise many other varied embodiments that incorporate these teachings.

1. A method of evaluating holdings of a portfolio, the method comprising:
identifying the holdings that comprise the portfolio;
obtaining financial information for each of the holdings;
identifying financial metrics that are to be used in evaluating the holdings;
determining the values of the financial metrics for each of the holdings;
identifying a set of evaluation metrics that that are to be used in evaluating the holdings, wherein the evaluation metrics are comprised of the financial information and the financial metrics;
determining for each holding the value of at least some of the evaluation metrics;
ranking the holdings of the portfolio for each evaluation metric, wherein an evaluation metric ranking is based upon the holdings' values that have been determined for that evaluation metric;
assigning an evaluation metric positional score to each holding that has received an evaluation metric ranking, wherein each evaluation metric positional score is based upon a holding's ranking in an evaluation metric; and
generating an overall score for each holding of the portfolio, wherein the overall score for a holding is based upon the evaluation metric positional scores that are assigned to that holding.

2. The method of claim 1, wherein the step of generating an overall score for a holding comprises determining an average of the evaluation metric positional scores that are assigned to that holding.

3. The method of claim 1, wherein the evaluation metric positional scores that are assigned to a holding are weighted differently and wherein the step of generating an overall score for a holding comprises determining a weighted average of the evaluation metric positional scores that are assigned to that holding.

4. The method of claim 1, further comprising:
ranking the holdings of the portfolio based upon the overall scores that were assigned to each holdings; and
generating an overall positional score for each holding, wherein a holding's overall positional score is based upon that holding's overall score ranking.

5. The method of claim 4, further comprising:
establishing an overall positional score threshold; and
identifying each holding that has an overall positional score that falls below the overall positional score threshold.

6. The method of claim 1, wherein each evaluation metric is characterized by a time domain aspect and a financial attribute aspect.

7. The method of claim 1, wherein at least some of the evaluation metrics evaluate a change in an evaluation metric that occurs from a first interval to a second interval.

8. The method of claim 1, further comprising:
identifying a group of evaluation metrics from the set of evaluation metrics;
generating a group score for each holding of the portfolio, wherein the group score for a holding is based upon the evaluation metric positional scores that are assigned to that holding for the group of evaluation metrics that are identified.

9. The method of claim 8, wherein the step of generating a group score for a holding comprises determining an average of the evaluation metric positional scores that are assigned to that holding for the group of identified evaluation metrics.

10. The method of claim 8, wherein the evaluation metric positional scores that are assigned to a holding are weighted differently and wherein the step of generating a group score for a holding comprises determining a weighted average of the evaluation metric positional scores that are assigned to that holding for the group of identified evaluation metrics.

11. The method of claim 8, wherein each evaluation metric is characterized by a time domain aspect and a financial attribute aspect and wherein the group is identified based upon a time domain aspect, a financial attribute aspect or both.

12. The method of claim 8, further comprising:
ranking the holdings of the portfolio based upon the group scores that were assigned to each holdings; and
generating a group positional score for each holding, wherein a holding's group positional score is based upon that holding's group score ranking.

13. The method of claim 1, further comprising:
establishing an evaluation metric positional score threshold; and
identifying for each holding the evaluation metrics that are assigned a positional score that falls below the evaluation metric positional score threshold.

14. The method of claim 1, further comprising:
establishing an overall score threshold; and
identifying each holding that has an overall score that falls below the overall score threshold.

15. The method of claim 1, wherein one financial metric is indicative of a holding's cumulative economic profit over a given period of time.

16. The method of claim 15, wherein the cumulative economic profit financial metric accounts for any special charges that a holding may have taken during the given period of time.

17. The method of claim 1, wherein the financial metrics include a series of financial metrics that when aggregated together are equal to a holding's total shareholders equity at a given point in time.

18. The method of claim 17, the method for comprising presenting a chart that displays at least one of the series of financial metrics for a holding in comparison to the holding's total shareholders equity.

19. The method of claim 1, wherein the financial metrics include a plurality of financial metrics that dissect a holding's total shareholders equity at a given point in time into an organic shareholders equity financial metric and an unearned shareholders equity financial metric.

20. The method of claim 19, wherein the organic shareholders equity financial metric reflects all of the business activities of the holding less cumulative dividends declared over the holding's life less net capital raised from a sale or redemption of the holding's stock.

21. The method of claim 1, wherein one financial metric is capable of determining an amount of cash that a holding would have had available at an end of a time interval had the holding had no change in a level of total debt and had received no net cash from a sale or redemption of the holding's stock.

22. A method of evaluating a holding against holdings of a background portfolio, the method comprising:
identifying the holdings that comprise the background portfolio;
obtaining financial information for each of the background portfolio holdings;
identifying financial metrics that are to be used in evaluating the holding and the background portfolio holdings;
determining the values of the financial metrics for each of the background holdings;
identifying a set of evaluation metrics that that are to be used in evaluating the holding and the background portfolio holdings, wherein the evaluation metrics are comprised of the financial information and the financial metrics;
determining for each of the background portfolio holdings the value of at least some of the evaluation metrics;
ranking the background portfolio holdings for each evaluation metric, wherein an evaluation metric ranking is based upon the background portfolio holdings' values that have been determined for that evaluation metric;
assigning an evaluation metric positional score to each background portfolio holding that has received an evaluation metric ranking, wherein each evaluation metric positional score is based upon a background portfolio holding's ranking in an evaluation metric;
generating an overall score for each of the background portfolio holdings, wherein the overall score for a background portfolio holding is based upon the evaluation metric positional scores that are assigned to that background portfolio holding;
determining the values of the financial metrics for the holding that is to be evaluated against the background portfolio holdings;
determining for the holding that is to be evaluated the value of at least some of the evaluation metrics;
determining an evaluation metric positional score for each evaluation metric value that is determined for the holding that is to be evaluated, wherein an evaluation metric positional score for that holding is determined by comparing that holding's evaluation metric value against the evaluation metric values that were determined for the background portfolio holdings for that evaluation metric; and
generating an overall score for that holding based upon the evaluation metric positional scores that are assigned to that holding.

23. The method of claim 22, wherein an evaluation metric positional score of the holding that is to be evaluated is determined by comparing that holding's evaluation metric value for a particular evaluation metric against the next highest evaluation metric value that was determined for the background portfolio holdings and the next lowest evaluation metric value that was determined for the background portfolio holdings.

24. The method of claim 22, wherein the step of generating an overall score for the holding that is being evaluated comprises determining an average of the evaluation metric positional scores that are assigned to that holding.

25. The method of claim 22, wherein the evaluation metric positional scores that are assigned to a holding are weighted differently and wherein the step of generating an overall score for a holding comprises determining a weighted average of the evaluation metric positional scores that are assigned to that holding.

26. The method of claim 22, further comprising:
ranking the holdings of the background portfolio and the holding that is to be evaluated based upon the overall scores that were assigned to each holdings; and
generating an overall positional score for each holding, wherein a holding's overall positional score is based upon that holding's overall score ranking.

27. The method of claim 26, further comprising:
establishing an overall positional score threshold; and
identifying whether the holding that is to be evaluated has an overall positional score that falls below the overall positional score threshold.

28. The method of claim 22, further comprising:
identifying a group of evaluation metrics from the set of evaluation metrics;
generating a group score for each holding of the background portfolio and the holding that is to be evaluated, wherein the group score for a holding is based upon the evaluation metric positional scores that are assigned to that holding for the group of evaluation metrics that are identified.

29. The method of claim 28, wherein the step of generating a group score for a holding comprises determining an average of the evaluation metric positional scores that are assigned to that holding for the group of identified evaluation metrics.

30. The method of claim 28, wherein the evaluation metric positional scores that are assigned to a holding are weighted differently and wherein the step of generating a group score for a holding comprises determining a weighted average of the evaluation metric positional scores that are assigned to that holding for the group of identified evaluation metrics.

31. The method of claim 28, wherein each evaluation metric is characterized by a time domain aspect and a financial attribute aspect and wherein the group is identified based upon a time domain aspect, a financial attribute aspect or both.

32. The method of claim 28, further comprising:
ranking the holdings of the background portfolio and the holding that is to be evaluated based upon the group scores that were assigned to each holdings; and
generating a group positional score for each holding, wherein a holding's group positional score is based upon that holding's group score ranking.

33. The method of claim 22, further comprising:
establishing an evaluation metric positional score threshold; and
identifying whether the holding that is to be evaluated has an evaluation metric positional score that falls below the evaluation metric positional score threshold.

34. The method of claim 22, further comprising:
establishing an overall score threshold; and
identifying whether the holding that is to be evaluated has an overall score that falls below the overall score threshold.

35. The method of claim 22, wherein one financial metric is indicative of a holding's cumulative economic profit over a given period of time.

36. The method of claim 35, wherein the cumulative economic profit financial metric accounts for any special charges that a holding may have taken during the given period of time.

37. The method of claim 22, wherein the financial metrics include a series of financial metrics that when aggregated together are equal to a holding's total shareholders equity at a given point in time.

38. The method of claim 37, the method for comprising presenting a chart that displays at least one of the series of financial metrics for a holding in comparison to the holding's total shareholders equity.

39. The method of claim 22, wherein the financial metrics include a plurality of financial metrics that dissect a holding's total shareholders equity at a given point in time into an organic shareholders equity financial metric and an unearned shareholders equity financial metric.

40. The method of claim 39, wherein the organic shareholders equity financial metric reflects all of the business activities of the holding less cumulative dividends declared over the holding's life less net capital raised from a sale or redemption of the holding's stock.

41. The method of claim 22, wherein one financial metric is capable of determining an amount of cash that a holding would have had available at an end of a time interval had the holding had no change in a level of total debt and had received no net cash from a sale or redemption of the holding's stock.
